(19) United States
(12) Patent Application Publication
(10) Pub. No.: US 2022/0199079 A1
(43) Pub. Date: Jun. 23, 2022

(54) Systems and Methods for Providing User Experiences on Smart Assistant Systems

(71) Applicant: Meta Platforms, Inc., Menlo Park, CA (US)

(72) Inventors: Michael Robert Hanson, Los Altos, CA (US); Swati Goel, Austin, TX (US); Leif Haven Martinson, Oakland, CA (US); Megha Tiwari, Seattle, WA (US); Megha Jhunjhunwala, Mountain View, CA (US); Ilana Orly Shalowitz, Oakland, CA (US); Nicholas Jorge Flores, Redwood City, CA (US); Kyle Archie, San Francisco, CA (US); Piyush Khemka, Sunnyvale, CA (US); Seungwhan Moon, Seattle, WA (US); Kai Sun, Ithaca, NY (US); Mark Parent, Toronto (CA); Michael Glueck, Toronto (CA); Jackson Rushing, Toronto (CA); Daniel John Wigdor, Toronto (CA); Stephanie Santosa, Toronto (CA); Christopher De Paoli, Oakville (CA)

(21) Appl. No.: 17/524,598

(22) Filed: Nov. 11, 2021

Related U.S. Application Data
(60) Provisional application No. 63/129,456, filed on Dec. 22, 2020.
(60) Provisional application No. 63/158,808, filed on Mar. 9, 2021.
(60) Provisional application No. 63/165,622, filed on Mar. 24, 2021.
(60) Provisional application No. 63/168,188, filed on Mar. 30, 2021.
(60) Provisional application No. 63/173,147, filed on Apr. 9, 2021.

(51) Int. Cl. G10L 15/22; H04L 12/58; H04W 12/02

(52) U.S. Cl. CPC G10L 15/22; H04W 12/02; H04L 51/22

(57) ABSTRACT

In one embodiment, a system includes an automatic speech recognition (ASR) module, a natural-language understanding (NLU) module, a dialog manager, one or more agents, an arbitrator, a delivery system, one or more processors, and a non-transitory memory coupled to the processors comprising instructions executable by the processors, the processors operable when executing the instructions to receive a user input, process the user input using the ASR module, the NLU module, the dialog manager, one or more of the agents, the arbitrator, and the delivery system, and provide a response to the user input.

### PRIORITY

This application claims the benefit under 35 U.S.C. § 119(e) of U.S. Provisional Patent Application No. 63/129,456, filed 22 Dec. 2020, U.S. Provisional Patent Application No. 63/158,808, filed 9 Mar. 2021, U.S. Provisional Patent Application No. 63/165,622, filed 24 Mar. 2021, U.S. Provisional Patent Application No. 63/168,188, filed 30 Mar. 2021, and U.S. Provisional Patent Application No. 63/173,147, filed 9 Apr. 2021, each of which is incorporated herein by reference.

### TECHNICAL FIELD

This disclosure generally relates to databases and file management within network environments, and in particular relates to hardware and software for smart assistant systems.

### BACKGROUND

An assistant system can provide information or services on behalf of a user based on a combination of user input, location awareness, and the ability to access information from a variety of online sources (such as weather conditions, traffic congestion, news, stock prices, user schedules, retail prices, etc.). The user input may include text (e.g., online chat), especially in an instant messaging application or other applications, voice, images, motion, or a combination of them. The assistant system may perform concierge-type services (e.g., making dinner reservations, purchasing event tickets, making travel arrangements) or provide information based on the user input. The assistant system may also perform management or data-handling tasks based on online information and events without user initiation or interaction. Examples of those tasks that may be performed by an assistant system may include schedule management (e.g., sending an alert to a dinner date that a user is running late due to traffic conditions, update schedules for both parties, and change the restaurant reservation time). The assistant system may be enabled by the combination of computing devices, application programming interfaces (APIs), and the proliferation of applications on user devices.

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. profile/news feed posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

In particular embodiments, the assistant system may assist a user to obtain information or services. The assistant system may enable the user to interact with the assistant system via user inputs of various modalities (e.g., audio, voice, text, image, video, gesture, motion, location, orientation) in stateful and multi-turn conversations to receive assistance from the assistant system. As an example and not by way of limitation, the assistant system may support mono-modal inputs (e.g., only voice inputs), multi-modal inputs (e.g., voice inputs and text inputs), hybrid/multi-modal inputs, or any combination thereof. User inputs provided by a user may be associated with particular assistant-related tasks, and may include, for example, user requests (e.g., verbal requests for information or performance of an action), user interactions with an assistant application associated with the assistant system (e.g., selection of UI elements via touch or gesture), or any other type of suitable user input that may be detected and understood by the assistant system (e.g., user movements detected by the client device of the user). The assistant system may create and store a user profile comprising both personal and contextual information associated with the user. In particular embodiments, the assistant system may analyze the user input using natural-language understanding (NLU). The analysis may be based on the user profile of the user for more personalized and context-aware understanding. The assistant system may resolve entities associated with the user input based on the analysis. In particular embodiments, the assistant system may interact with different agents to obtain information or services that are associated with the resolved entities. The assistant system may generate a response for the user regarding the information or services by using natural-language generation (NLG). Through the interaction with the user, the assistant system may use dialog-management techniques to manage and advance the conversation flow with the user. In particular embodiments, the assistant system may further assist the user to effectively and efficiently digest the obtained information by summarizing the information. The assistant system may also assist the user to be more engaging with an online social network by providing tools that help the user interact with the online social network (e.g., creating posts, comments, messages). The assistant system may additionally assist the user to manage different tasks such as keeping track of events. In particular embodiments, the assistant system may proactively execute, without a user input, tasks that are relevant to user interests and preferences based on the user profile, at a time relevant for the user. In particular embodiments, the assistant system may check privacy settings to ensure that accessing a user's profile or other user information and executing different tasks are permitted subject to the user's privacy settings.

In particular embodiments, the assistant system may assist the user via a hybrid architecture built upon both client-side processes and server-side processes. The client-side processes and the server-side processes may be two parallel workflows for processing a user input and providing assistance to the user. In particular embodiments, the client-side processes may be performed locally on a client system associated with a user. By contrast, the server-side processes may be performed remotely on one or more computing systems. In particular embodiments, an arbitrator on the client system may coordinate receiving user input (e.g., an audio signal), determine whether to use a client-side process, a server-side process, or both, to respond to the user input, and analyze the processing results from each process. The arbitrator may instruct agents on the client-side or server-side to execute tasks associated with the user input based on the aforementioned analyses. The execution results may be further rendered as output to the client system. By leveraging both client-side and server-side processes, the assistant system can effectively assist a user with optimal usage of computing resources while at the same time protecting user privacy and enhancing security.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with an assistant system.

FIG. 2 illustrates an example architecture of the assistant system.

FIG. 3 illustrates an example flow diagram of the assistant system.

FIG. 4 illustrates an example task-centric flow diagram of processing a user input.

FIG. 5 illustrates an example social graph.

FIG. 6 illustrates an example view of an embedding space.

FIG. 7 illustrates an example artificial neural network.

FIG. 8 illustrates an example computer system.

FIG. 9 illustrates an example method for managing audio processing during multi-party calls.

FIGS. 10A, 10B, and 10C illustrate example framework for hands-free multi-platform inbox management.

FIG. 11 illustrates an example method for hands-free multi-platform inbox management.

FIG. 12 illustrates an example method for proactively informing users when their accounts or information has been compromised.

FIG. 13 illustrates an example interaction between a user and the assistant system with chit-chat abilities.

FIG. 14 illustrates an example overview of the data construction.

FIG. 15 illustrates an example workflow diagram for generating responses with chit-chat abilities.

FIG. 16 illustrates example comparisons between SGD and ACCENTOR-SGD with different injection frequencies at the dataset level using ACUTE-Eval.

FIG. 17 illustrates example comparisons between MultiWOZ 2.1 and ACCENTOR-MultiWOZ at the dataset level using ACUTE-Eval.

FIG. 18 illustrates example human evaluation results on the test set of ACCENTOR-SGD using ACUTE-Eval.

FIG. 19 illustrates example human evaluation results on dialogues that involve seen, unseen, or mixed services using ACUTE-Eval.

FIG. 20 illustrates example human evaluation results of the modified Arranger with controlled injection frequency.

FIG. 21A illustrates an example visual search assistance with visual cues.

FIG. 21B illustrates another example visual search assistance with visual cues.

FIG. 22 illustrates an example user interface with visual cues parameterized by spatial properties.

FIG. 23 illustrates an example user interface with visual cues parameterized by temporal properties.

FIG. 24 illustrates an example user interface with visual cues parameterized by color and shape properties.

FIG. 25 illustrates an example user interface with multiple visual cues.

FIG. 26 illustrates an example user interface with visual cues indicating object categories.

### DESCRIPTION OF EXAMPLE EMBODIMENTS

### System Overview

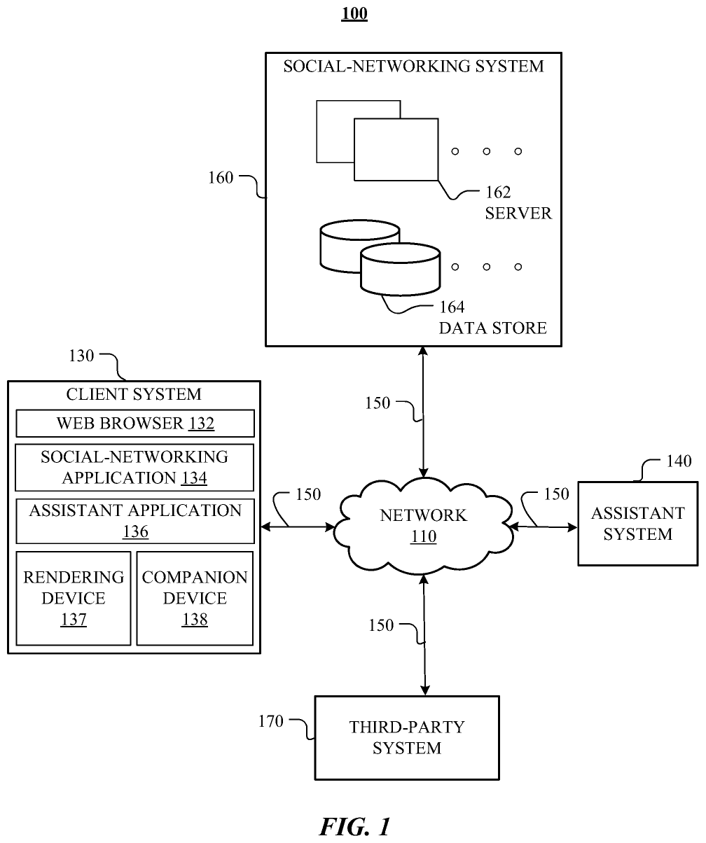

FIG. 1 illustrates an example network environment 100 associated with an assistant system. Network environment 100 includes a client system 130, an assistant system 140, a social-networking system 160, and a third-party system 170 connected to each other by a network 110. Although FIG. 1 illustrates a particular arrangement of a client system 130, an assistant system 140, a social-networking system 160, a third-party system 170, and a network 110, this disclosure contemplates any suitable arrangement of a client system 130, an assistant system 140, a social-networking system 160, a third-party system 170, and a network 110. As an example and not by way of limitation, two or more of a client system 130, a social-networking system 160, an assistant system 140, and a third-party system 170 may be connected to each other directly, bypassing a network 110. As another example, two or more of a client system 130, an assistant system 140, a social-networking system 160, and a third-party system 170 may be physically or logically co-located with each other in whole or in part. Moreover, although FIG. 1 illustrates a particular number of client systems 130, assistant systems 140, social-networking systems 160, third-party systems 170, and networks 110, this disclosure contemplates any suitable number of client systems 130, assistant systems 140, social-networking systems 160, third-party systems 170, and networks 110. As an example and not by way of limitation, network environment 100 may include multiple client systems 130, assistant systems 140, social-networking systems 160, third-party systems 170, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular technology-based network, a satellite communications technology-based network, another network 110, or a combination of two or more such networks 110.

Links 150 may connect a client system 130, an assistant system 140, a social-networking system 160, and a third-party system 170 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, a client system 130 may be any suitable electronic device including hardware, software, or embedded logic components, or a combination of two or more such components, and may be capable of carrying out the functionalities implemented or supported by a client system 130. As an example and not by way of limitation, the client system 130 may include a computer system such as a desktop computer, notebook or laptop computer, netbook, a tablet computer, e-book reader, GPS device, camera, personal digital assistant (PDA), handheld electronic device, cellular telephone, smartphone, smart speaker, smart watch, smart glasses, augmented-reality (AR) smart glasses, virtual reality (VR) headset, other suitable electronic device, or any suitable combination thereof. In particular embodiments, the client system 130 may be a smart assistant device. More information on smart assistant devices may be found in U.S. patent application Ser. No. 15/949,011, filed 9 Apr. 2018, U.S. patent application Ser. No. 16/153,574, filed 5 Oct. 2018, U.S. Design patent application No. 29/631910, filed 3 Jan. 2018, U.S. Design patent application No. 29/631747, filed 2 Jan. 2018, U.S. Design patent application No. 29/631913, filed 3 Jan. 2018, and U.S. Design patent application No. 29/631914, filed 3 Jan. 2018, each of which is incorporated by reference. This disclosure contemplates any suitable client systems 130. In particular embodiments, a client system 130 may enable a network user at a client system 130 to access a network 110. The client system 130 may also enable the user to communicate with other users at other client systems 130.

In particular embodiments, a client system 130 may include a web browser 132, and may have one or more add-ons, plug-ins, or other extensions. A user at a client system 130 may enter a Uniform Resource Locator (URL) or other address directing a web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to a client system 130 one or more Hyper Text Markup Language (HTML) files responsive to the HTTP request. The client system 130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts, combinations of markup language and scripts, and the like. Herein, reference to a web interface encompasses one or more corresponding source files (which a browser may use to render the web interface) and vice versa, where appropriate.

In particular embodiments, a client system 130 may include a social-networking application 134 installed on the client system 130. A user at a client system 130 may use the social-networking application 134 to access on online social network. The user at the client system 130 may use the social-networking application 134 to communicate with the user's social connections (e.g., friends, followers, followed accounts, contacts, etc.). The user at the client system 130 may also use the social-networking application 134 to interact with a plurality of content objects (e.g., posts, news articles, ephemeral content, etc.) on the online social network. As an example and not by way of limitation, the user may browse trending topics and breaking news using the social-networking application 134.

In particular embodiments, a client system 130 may include an assistant application 136. A user at a client system 130 may use the assistant application 136 to interact with the assistant system 140. In particular embodiments, the assistant application 136 may include an assistant xbot functionality as a front-end interface for interacting with the user of the client system 130, including receiving user inputs and presenting outputs. In particular embodiments, the assistant application 136 may comprise a stand-alone application. In particular embodiments, the assistant application 136 may be integrated into the social-networking application 134 or another suitable application (e.g., a messaging application). In particular embodiments, the assistant application 136 may be also integrated into the client system 130, an assistant hardware device, or any other suitable hardware devices. In particular embodiments, the assistant application 136 may be also part of the assistant system 140. In particular embodiments, the assistant application 136 may be accessed via the web browser 132. In particular embodiments, the user may interact with the assistant system 140 by providing user input to the assistant application 136 via various modalities (e.g., audio, voice, text, vision, image, video, gesture, motion, activity, location, orientation). The assistant application 136 may communicate the user input to the assistant system 140 (e.g., via the assistant xbot). Based on the user input, the assistant system 140 may generate responses. The assistant system 140 may send the generated responses to the assistant application 136. The assistant application 136 may then present the responses to the user at the client system 130 via various modalities (e.g., audio, text, image, and video). As an example and not by way of limitation, the user may interact with the assistant system 140 by providing a user input (e.g., a verbal request for information regarding a current status of nearby vehicle traffic) to the assistant xbot via a microphone of the client system 130. The assistant application 136 may then communicate the user input to the assistant system 140 over network 110. The assistant system 140 may accordingly analyze the user input, generate a response based on the analysis of the user input (e.g., vehicle traffic information obtained from a third-party source), and communicate the generated response back to the assistant application 136. The assistant application 136 may then present the generated response to the user in any suitable manner (e.g., displaying a text-based push notification and/or image(s) illustrating a local map of nearby vehicle traffic on a display of the client system 130).

In particular embodiments, a client system 130 may implement wake-word detection techniques to allow users to conveniently activate the assistant system 140 using one or more wake-words associated with assistant system 140. As an example and not by way of limitation, the system audio API on client system 130 may continuously monitor user input comprising audio data (e.g., frames of voice data) received at the client system 130. In this example, a wake-word associated with the assistant system 140 may be the voice phrase “hey assistant.” In this example, when the system audio API on client system 130 detects the voice phrase “hey assistant” in the monitored audio data, the assistant system 140 may be activated for subsequent interaction with the user. In alternative embodiments, similar detection techniques may be implemented to activate the assistant system 140 using particular non-audio user inputs associated with the assistant system 140. For example, the non-audio user inputs may be specific visual signals detected by a low-power sensor (e.g., camera) of client system 130. As an example and not by way of limitation, the visual signals may be a static image (e.g., barcode, QR code, universal product code (UPC)), a position of the user (e.g., the user's gaze towards client system 130), a user motion (e.g., the user pointing at an object), or any other suitable visual signal.

In particular embodiments, a client system 130 may include a rendering device 137 and, optionally, a companion device 138. The rendering device 137 may be configured to render outputs generated by the assistant system 140 to the user. The companion device 138 may be configured to perform computations associated with particular tasks (e.g., communications with the assistant system 140) locally (i.e., on-device) on the companion device 138 in particular circumstances (e.g., when the rendering device 137 is unable to perform said computations). In particular embodiments, the client system 130, the rendering device 137, and/or the companion device 138 may each be a suitable electronic device including hardware, software, or embedded logic components, or a combination of two or more such components, and may be capable of carrying out, individually or cooperatively, the functionalities implemented or supported by the client system 130 described herein. As an example and not by way of limitation, the client system 130, the rendering device 137, and/or the companion device 138 may each include a computer system such as a desktop computer, notebook or laptop computer, netbook, a tablet computer, e-book reader, GPS device, camera, personal digital assistant (PDA), handheld electronic device, cellular telephone, smartphone, smart speaker, virtual reality (VR) headset, augmented-reality (AR) smart glasses, other suitable electronic device, or any suitable combination thereof. In particular embodiments, one or more of the client system 130, the rendering device 137, and the companion device 138 may operate as a smart assistant device. As an example and not by way of limitation, the rendering device 137 may comprise smart glasses and the companion device 138 may comprise a smart phone. As another example and not by way of limitation, the rendering device 137 may comprise a smart watch and the companion device 138 may comprise a smart phone. As yet another example and not by way of limitation, the rendering device 137 may comprise smart glasses and the companion device 138 may comprise a smart remote for the smart glasses. As yet another example and not by way of limitation, the rendering device 137 may comprise a VR/AR headset and the companion device 138 may comprise a smart phone.

In particular embodiments, a user may interact with the assistant system 140 using the rendering device 137 or the companion device 138, individually or in combination. In particular embodiments, one or more of the client system 130, the rendering device 137, and the companion device 138 may implement a multi-stage wake-word detection model to enable users to conveniently activate the assistant system 140 by continuously monitoring for one or more wake-words associated with assistant system 140. At a first stage of the wake-word detection model, the rendering device 137 may receive audio user input (e.g., frames of voice data). If a wireless connection between the rendering device 137 and the companion device 138 is available, the application on the rendering device 137 may communicate the received audio user input to the companion application on the companion device 138 via the wireless connection. At a second stage of the wake-word detection model, the companion application on the companion device 138 may process the received audio user input to detect a wake-word associated with the assistant system 140. The companion application on the companion device 138 may then communicate the detected wake-word to a server associated with the assistant system 140 via wireless network 110. At a third stage of the wake-word detection model, the server associated with the assistant system 140 may perform a keyword verification on the detected wake-word to verify whether the user intended to activate and receive assistance from the assistant system 140. In alternative embodiments, any of the processing, detection, or keyword verification may be performed by the rendering device 137 and/or the companion device 138. In particular embodiments, when the assistant system 140 has been activated by the user, an application on the rendering device 137 may be configured to receive user input from the user, and a companion application on the companion device 138 may be configured to handle user inputs (e.g., user requests) received by the application on the rendering device 137. In particular embodiments, the rendering device 137 and the companion device 138 may be associated with each other (i.e., paired) via one or more wireless communication protocols (e.g., Bluetooth).

The following example workflow illustrates how a rendering device 137 and a companion device 138 may handle a user input provided by a user. In this example, an application on the rendering device 137 may receive a user input comprising a user request directed to the rendering device 137. The application on the rendering device 137 may then determine a status of a wireless connection (i.e., tethering status) between the rendering device 137 and the companion device 138. If a wireless connection between the rendering device 137 and the companion device 138 is not available, the application on the rendering device 137 may communicate the user request (optionally including additional data and/or contextual information available to the rendering device 137) to the assistant system 140 via the network 110. The assistant system 140 may then generate a response to the user request and communicate the generated response back to the rendering device 137. The rendering device 137 may then present the response to the user in any suitable manner. Alternatively, if a wireless connection between the rendering device 137 and the companion device 138 is available, the application on the rendering device 137 may communicate the user request (optionally including additional data and/or contextual information available to the rendering device 137) to the companion application on the companion device 138 via the wireless connection. The companion application on the companion device 138 may then communicate the user request (optionally including additional data and/or contextual information available to the companion device 138) to the assistant system 140 via the network 110. The assistant system 140 may then generate a response to the user request and communicate the generated response back to the companion device 138. The companion application on the companion device 138 may then communicate the generated response to the application on the rendering device 137. The rendering device 137 may then present the response to the user in any suitable manner. In the preceding example workflow, the rendering device 137 and the companion device 138 may each perform one or more computations and/or processes at each respective step of the workflow. In particular embodiments, performance of the computations and/or processes disclosed herein may be adaptively switched between the rendering device 137 and the companion device 138 based at least in part on a device state of the rendering device 137 and/or the companion device 138, a task associated with the user input, and/or one or more additional factors. As an example and not by way of limitation, one factor may be signal strength of the wireless connection between the rendering device 137 and the companion device 138. For example, if the signal strength of the wireless connection between the rendering device 137 and the companion device 138 is strong, the computations and processes may be adaptively switched to be substantially performed by the companion device 138 in order to, for example, benefit from the greater processing power of the CPU of the companion device 138. Alternatively, if the signal strength of the wireless connection between the rendering device 137 and the companion device 138 is weak, the computations and processes may be adaptively switched to be substantially performed by the rendering device 137 in a standalone manner. In particular embodiments, if the client system 130 does not comprise a companion device 138, the aforementioned computations and processes may be performed solely by the rendering device 137 in a standalone manner.

In particular embodiments, an assistant system 140 may assist users with various assistant-related tasks. The assistant system 140 may interact with the social-networking system 160 and/or the third-party system 170 when executing these assistant-related tasks.

In particular embodiments, the social-networking system 160 may be a network-addressable computing system that can host an online social network. The social-networking system 160 may generate, store, receive, and send social-networking data, such as, for example, user profile data, concept-profile data, social-graph information, or other suitable data related to the online social network. The social-networking system 160 may be accessed by the other components of network environment 100 either directly or via a network 110. As an example and not by way of limitation, a client system 130 may access the social-networking system 160 using a web browser 132 or a native application associated with the social-networking system 160 (e.g., a mobile social-networking application, a messaging application, another suitable application, or any combination thereof) either directly or via a network 110. In particular embodiments, the social-networking system 160 may include one or more servers 162. Each server 162 may be a unitary server or a distributed server spanning multiple computers or multiple datacenters. As an example and not by way of limitation, each server 162 may be a web server, a news server, a mail server, a message server, an advertising server, a file server, an application server, an exchange server, a database server, a proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, the social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, an assistant system 140, or a third-party system 170 to manage, retrieve, modify, add, or delete, the information stored in data store 164.

In particular embodiments, the social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the social-networking system 160. In particular embodiments, however, the social-networking system 160 and third-party systems 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects. In particular embodiments, a third-party content provider may use one or more third-party agents to provide content objects and/or services. A third-party agent may be an implementation that is hosted and executing on the third-party system 170.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from a client system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof. In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 160 to one or more client systems 130 or one or more third-party systems 170 via a network 110. The web server may include a mail server or other messaging functionality for receiving and routing messages between the social-networking system 160 and one or more client systems 130. An API-request server may allow, for example, an assistant system 140 or a third-party system 170 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from a client system 130 responsive to a user input comprising a user request received from a client system 130. Authorization servers may be used to enforce one or more privacy settings of the users of the social-networking system 160. A privacy setting of a user may determine how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

### Assistant Systems

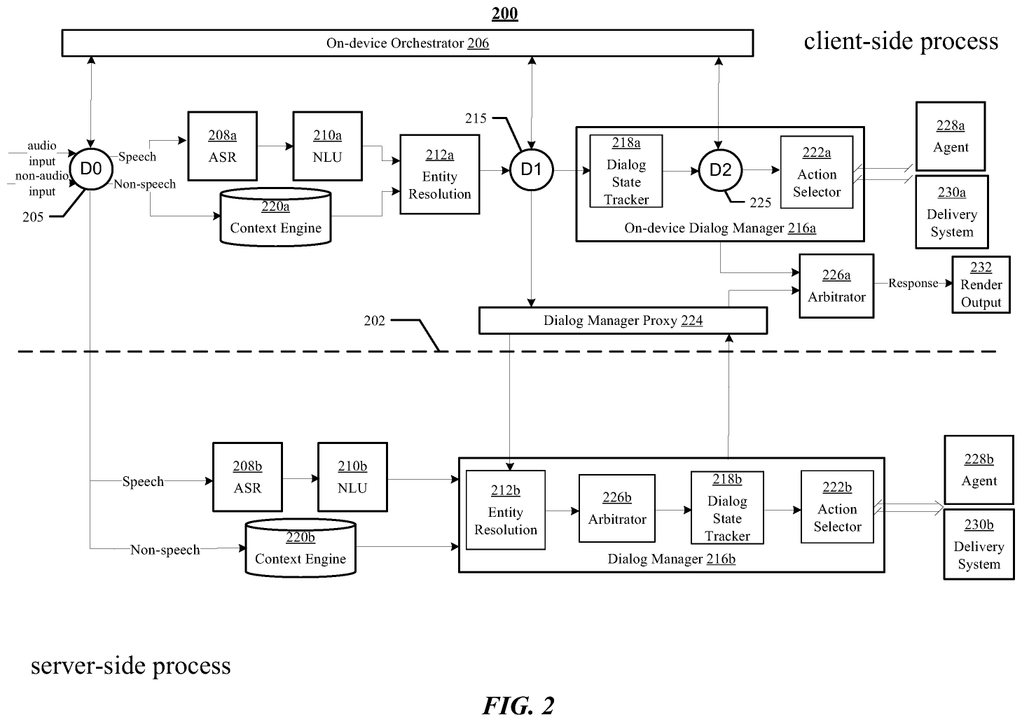

FIG. 2 illustrates an example architecture 200 of the assistant system 140. In particular embodiments, the assistant system 140 may assist a user to obtain information or services. The assistant system 140 may enable the user to interact with the assistant system 140 via user inputs of various modalities (e.g., audio, voice, text, vision, image, video, gesture, motion, activity, location, orientation) in stateful and multi-turn conversations to receive assistance from the assistant system 140. As an example and not by way of limitation, a user input may comprise an audio input based on the user's voice (e.g., a verbal command), which may be processed by a system audio API (application programming interface) on client system 130. The system audio API may perform techniques including echo cancellation, noise removal, beam forming, self-user voice activation, speaker identification, voice activity detection (VAD), and/or any other suitable acoustic technique in order to generate audio data that is readily processable by the assistant system 140. In particular embodiments, the assistant system 140 may support mono-modal inputs (e.g., only voice inputs), multi-modal inputs (e.g., voice inputs and text inputs), hybrid/multi-modal inputs, or any combination thereof. In particular embodiments, a user input may be a user-generated input that is sent to the assistant system 140 in a single turn. User inputs provided by a user may be associated with particular assistant-related tasks, and may include, for example, user requests (e.g., verbal requests for information or performance of an action), user interactions with the assistant application 136 associated with the assistant system 140 (e.g., selection of UI elements via touch or gesture), or any other type of suitable user input that may be detected and understood by the assistant system 140 (e.g., user movements detected by the client device 130 of the user).

In particular embodiments, the assistant system 140 may create and store a user profile comprising both personal and contextual information associated with the user. In particular embodiments, the assistant system 140 may analyze the user input using natural-language understanding (NLU) techniques. The analysis may be based at least in part on the user profile of the user for more personalized and context-aware understanding. The assistant system 140 may resolve entities associated with the user input based on the analysis. In particular embodiments, the assistant system 140 may interact with different agents to obtain information or services that are associated with the resolved entities. The assistant system 140 may generate a response for the user regarding the information or services by using natural-language generation (NLG). Through the interaction with the user, the assistant system 140 may use dialog management techniques to manage and forward the conversation flow with the user. In particular embodiments, the assistant system 140 may further assist the user to effectively and efficiently digest the obtained information by summarizing the information. The assistant system 140 may also assist the user to be more engaging with an online social network by providing tools that help the user interact with the online social network (e.g., creating posts, comments, messages). The assistant system 140 may additionally assist the user to manage different tasks such as keeping track of events. In particular embodiments, the assistant system 140 may proactively execute, without a user input, pre-authorized tasks that are relevant to user interests and preferences based on the user profile, at a time relevant for the user. In particular embodiments, the assistant system 140 may check privacy settings to ensure that accessing a user's profile or other user information and executing different tasks are permitted subject to the user's privacy settings. More information on assisting users subject to privacy settings may be found in U.S. patent application Ser. No. 16/182,542, filed 6 Nov. 2018, which is incorporated by reference.

In particular embodiments, the assistant system 140 may assist a user via an architecture built upon client-side processes and server-side processes which may operate in various operational modes. In FIG. 2, the client-side process is illustrated above the dashed line 202 whereas the server-side process is illustrated below the dashed line 202. A first operational mode (i.e., on-device mode) may be a workflow in which the assistant system 140 processes a user input and provides assistance to the user by primarily or exclusively performing client-side processes locally on the client system 130. For example, if the client system 130 is not connected to a network 110 (i.e., when client system 130 is offline), the assistant system 140 may handle a user input in the first operational mode utilizing only client-side processes. A second operational mode (i.e., cloud mode) may be a workflow in which the assistant system 140 processes a user input and provides assistance to the user by primarily or exclusively performing server-side processes on one or more remote servers (e.g., a server associated with assistant system 140). As illustrated in FIG. 2, a third operational mode (i.e., blended mode) may be a parallel workflow in which the assistant system 140 processes a user input and provides assistance to the user by performing client-side processes locally on the client system 130 in conjunction with server-side processes on one or more remote servers (e.g., a server associated with assistant system 140). For example, the client system 130 and the server associated with assistant system 140 may both perform automatic speech recognition (ASR) and natural-language understanding (NLU) processes, but the client system 130 may delegate dialog, agent, and natural-language generation (NLG) processes to be performed by the server associated with assistant system 140.

In particular embodiments, selection of an operational mode may be based at least in part on a device state, a task associated with a user input, and/or one or more additional factors. As an example and not by way of limitation, as described above, one factor may be a network connectivity status for client system 130. For example, if the client system 130 is not connected to a network 110 (i.e., when client system 130 is offline), the assistant system 140 may handle a user input in the first operational mode (i.e., on-device mode). As another example and not by way of limitation, another factor may be based on a measure of available battery power (i.e., battery status) for the client system 130. For example, if there is a need for client system 130 to conserve battery power (e.g., when client system 130 has minimal available battery power or the user has indicated a desire to conserve the battery power of the client system 130), the assistant system 140 may handle a user input in the second operational mode (i.e., cloud mode) or the third operational mode (i.e., blended mode) in order to perform fewer power-intensive operations on the client system 130. As yet another example and not by way of limitation, another factor may be one or more privacy constraints (e.g., specified privacy settings, applicable privacy policies). For example, if one or more privacy constraints limits or precludes particular data from being transmitted to a remote server (e.g., a server associated with the assistant system 140), the assistant system 140 may handle a user input in the first operational mode (i.e., on-device mode) in order to protect user privacy. As yet another example and not by way of limitation, another factor may be desynchronized context data between the client system 130 and a remote server (e.g., the server associated with assistant system 140). For example, the client system 130 and the server associated with assistant system 140 may be determined to have inconsistent, missing, and/or unreconciled context data, the assistant system 140 may handle a user input in the third operational mode (i.e., blended mode) to reduce the likelihood of an inadequate analysis associated with the user input. As yet another example and not by way of limitation, another factor may be a measure of latency for the connection between client system 130 and a remote server (e.g., the server associated with assistant system 140). For example, if a task associated with a user input may significantly benefit from and/or require prompt or immediate execution (e.g., photo capturing tasks), the assistant system 140 may handle the user input in the first operational mode (i.e., on-device mode) to ensure the task is performed in a timely manner. As yet another example and not by way of limitation, another factor may be, for a feature relevant to a task associated with a user input, whether the feature is only supported by a remote server (e.g., the server associated with assistant system 140). For example, if the relevant feature requires advanced technical functionality (e.g., high-powered processing capabilities, rapid update cycles) that is only supported by the server associated with assistant system 140 and is not supported by client system 130 at the time of the user input, the assistant system 140 may handle the user input in the second operational mode (i.e., cloud mode) or the third operational mode (i.e., blended mode) in order to benefit from the relevant feature.

In particular embodiments, an on-device orchestrator 206 on the client system 130 may coordinate receiving a user input and may determine, at one or more decision points in an example workflow, which of the operational modes described above should be used to process or continue processing the user input. As discussed above, selection of an operational mode may be based at least in part on a device state, a task associated with a user input, and/or one or more additional factors. As an example and not by way of limitation, with reference to the workflow architecture illustrated in FIG. 2, after a user input is received from a user, the on-device orchestrator 206 may determine, at decision point (D0) 205, whether to begin processing the user input in the first operational mode (i.e., on-device mode), the second operational mode (i.e., cloud mode), or the third operational mode (i.e., blended mode). For example, at decision point (D0) 205, the on-device orchestrator 206 may select the first operational mode (i.e., on-device mode) if the client system 130 is not connected to network 110 (i.e., when client system 130 is offline), if one or more privacy constraints expressly require on-device processing (e.g., adding or removing another person to a private call between users), or if the user input is associated with a task which does not require or benefit from server-side processing (e.g., setting an alarm or calling another user). As another example, at decision point (D0) 205, the on-device orchestrator 206 may select the second operational mode (i.e., cloud mode) or the third operational mode (i.e., blended mode) if the client system 130 has a need to conserve battery power (e.g., when client system 130 has minimal available battery power or the user has indicated a desire to conserve the battery power of the client system 130) or has a need to limit additional utilization of computing resources (e.g., when other processes operating on client device 130 require high CPU utilization (e.g., SMS messaging applications)).

In particular embodiments, if the on-device orchestrator 206 determines at decision point (D0) 205 that the user input should be processed using the first operational mode (i.e., on-device mode) or the third operational mode (i.e., blended mode), the client-side process may continue as illustrated in FIG. 2. As an example and not by way of limitation, if the user input comprises speech data, the speech data may be received at a local automatic speech recognition (ASR) module 208a on the client system 130. The ASR module 208a may allow a user to dictate and have speech transcribed as written text, have a document synthesized as an audio stream, or issue commands that are recognized as such by the system.

In particular embodiments, the output of the ASR module 208a may be sent to a local natural-language understanding (NLU) module 210a. The NLU module 210a may perform named entity resolution (NER), or named entity resolution may be performed by the entity resolution module 212a, as described below. In particular embodiments, one or more of an intent, a slot, or a domain may be an output of the NLU module 210a.

In particular embodiments, the user input may comprise non-speech data, which may be received at a local context engine 220a. As an example and not by way of limitation, the non-speech data may comprise locations, visuals, touch, gestures, world updates, social updates, contextual information, information related to people, activity data, and/or any other suitable type of non-speech data. The non-speech data may further comprise sensory data received by client system 130 sensors (e.g., microphone, camera), which may be accessed subject to privacy constraints and further analyzed by computer vision technologies. In particular embodiments, the computer vision technologies may comprise object detection, scene recognition, hand tracking, eye tracking, and/or any other suitable computer vision technologies. In particular embodiments, the non-speech data may be subject to geometric constructions, which may comprise constructing objects surrounding a user using any suitable type of data collected by a client system 130. As an example and not by way of limitation, a user may be wearing AR glasses, and geometric constructions may be utilized to determine spatial locations of surfaces and items (e.g., a floor, a wall, a user's hands). In particular embodiments, the non-speech data may be inertial data captured by AR glasses or a VR headset, and which may be data associated with linear and angular motions (e.g., measurements associated with a user's body movements). In particular embodiments, the context engine 220a may determine various types of events and context based on the non-speech data.

In particular embodiments, the outputs of the NLU module 210a and/or the context engine 220a may be sent to an entity resolution module 212a. The entity resolution module 212a may resolve entities associated with one or more slots output by NLU module 210a. In particular embodiments, each resolved entity may be associated with one or more entity identifiers. As an example and not by way of limitation, an identifier may comprise a unique user identifier (ID) corresponding to a particular user (e.g., a unique username or user ID number for the social-networking system 160). In particular embodiments, each resolved entity may also be associated with a confidence score. More information on resolving entities may be found in U.S. Pat. No. 10,803,050, filed 27 Jul. 2018, and U.S. patent application Ser. No. 16/048,072, filed 27 Jul. 2018, each of which is incorporated by reference.

In particular embodiments, at decision point (D0) 205, the on-device orchestrator 206 may determine that a user input should be handled in the second operational mode (i.e., cloud mode) or the third operational mode (i.e., blended mode). In these operational modes, the user input may be handled by certain server-side modules in a similar manner as the client-side process described above.

In particular embodiments, if the user input comprises speech data, the speech data of the user input may be received at a remote automatic speech recognition (ASR) module 208b on a remote server (e.g., the server associated with assistant system 140). The ASR module 208b may allow a user to dictate and have speech transcribed as written text, have a document synthesized as an audio stream, or issue commands that are recognized as such by the system.

In particular embodiments, the output of the ASR module 208b may be sent to a remote natural-language understanding (NLU) module 210b. In particular embodiments, the NLU module 210b may perform named entity resolution (NER) or named entity resolution may be performed by entity resolution module 212b of dialog manager module 216b as described below. In particular embodiments, one or more of an intent, a slot, or a domain may be an output of the NLU module 210b.

In particular embodiments, the user input may comprise non-speech data, which may be received at a remote context engine 220b. In particular embodiments, the remote context engine 220b may determine various types of events and context based on the non-speech data. In particular embodiments, the output of the NLU module 210b and/or the context engine 220b may be sent to a remote dialog manager 216b.

In particular embodiments, as discussed above, an on-device orchestrator 206 on the client system 130 may coordinate receiving a user input and may determine, at one or more decision points in an example workflow, which of the operational modes described above should be used to process or continue processing the user input. As further discussed above, selection of an operational mode may be based at least in part on a device state, a task associated with a user input, and/or one or more additional factors. As an example and not by way of limitation, with continued reference to the workflow architecture illustrated in FIG. 2, after the entity resolution module 212a generates an output or a null output, the on-device orchestrator 206 may determine, at decision point (D1) 215, whether to continue processing the user input in the first operational mode (i.e., on-device mode), the second operational mode (i.e., cloud mode), or the third operational mode (i.e., blended mode). For example, at decision point (D1) 215, the on-device orchestrator 206 may select the first operational mode (i.e., on-device mode) if an identified intent is associated with a latency sensitive processing task (e.g., taking a photo, pausing a stopwatch). As another example and not by way of limitation, if a messaging task is not supported by on-device processing on the client system 130, the on-device orchestrator 206 may select the third operational mode (i.e., blended mode) to process the user input associated with a messaging request. As yet another example, at decision point (D1) 215, the on-device orchestrator 206 may select the second operational mode (i.e., cloud mode) or the third operational mode (i.e., blended mode) if the task being processed requires access to a social graph, a knowledge graph, or a concept graph not stored on the client system 130. Alternatively, the on-device orchestrator 206 may instead select the first operational mode (i.e., on-device mode) if a sufficient version of an informational graph including requisite information for the task exists on the client system 130 (e.g., a smaller and/or bootstrapped version of a knowledge graph).

In particular embodiments, if the on-device orchestrator 206 determines at decision point (D1) 215 that processing should continue using the first operational mode (i.e., on-device mode) or the third operational mode (i.e., blended mode), the client-side process may continue as illustrated in FIG. 2. As an example and not by way of limitation, the output from the entity resolution module 212a may be sent to an on-device dialog manager 216a. In particular embodiments, the on-device dialog manager 216a may comprise a dialog state tracker 218a and an action selector 222a. The on-device dialog manager 216a may have complex dialog logic and product-related business logic to manage the dialog state and flow of the conversation between the user and the assistant system 140. The on-device dialog manager 216a may include full functionality for end-to-end integration and multi-turn support (e.g., confirmation, disambiguation). The on-device dialog manager 216a may also be lightweight with respect to computing limitations and resources including memory, computation (CPU), and binary size constraints. The on-device dialog manager 216a may also be scalable to improve developer experience. In particular embodiments, the on-device dialog manager 216a may benefit the assistant system 140, for example, by providing offline support to alleviate network connectivity issues (e.g., unstable or unavailable network connections), by using client-side processes to prevent privacy-sensitive information from being transmitted off of client system 130, and by providing a stable user experience in high-latency sensitive scenarios.

In particular embodiments, the on-device dialog manager 216a may further conduct false trigger mitigation. Implementation of false trigger mitigation may detect and prevent false triggers from user inputs which would otherwise invoke the assistant system 140 (e.g., an unintended wake-word) and may further prevent the assistant system 140 from generating data records based on the false trigger that may be inaccurate and/or subject to privacy constraints. As an example and not by way of limitation, if a user is in a voice call, the user's conversation during the voice call may be considered private, and the false trigger mitigation may limit detection of wake-words to audio user inputs received locally by the user's client system 130. In particular embodiments, the on-device dialog manager 216a may implement false trigger mitigation based on a nonsense detector. If the nonsense detector determines with a high confidence that a received wake-word is not logically and/or contextually sensible at the point in time at which it was received from the user, the on-device dialog manager 216a may determine that the user did not intend to invoke the assistant system 140.

In particular embodiments, due to a limited computing power of the client system 130, the on-device dialog manager 216a may conduct on-device learning based on learning algorithms particularly tailored for client system 130. As an example and not by way of limitation, federated learning techniques may be implemented by the on-device dialog manager 216a. Federated learning is a specific category of distributed machine learning techniques which may train machine-learning models using decentralized data stored on end devices (e.g., mobile phones). In particular embodiments, the on-device dialog manager 216a may use federated user representation learning model to extend existing neural-network personalization techniques to implementation of federated learning by the on-device dialog manager 216a. Federated user representation learning may personalize federated learning models by learning task-specific user representations (i.e., embeddings) and/or by personalizing model weights. Federated user representation learning is a simple, scalable, privacy-preserving, and resource-efficient. Federated user representation learning may divide model parameters into federated and private parameters. Private parameters, such as private user embeddings, may be trained locally on a client system 130 instead of being transferred to or averaged by a remote server (e.g., the server associated with assistant system 140). Federated parameters, by contrast, may be trained remotely on the server. In particular embodiments, the on-device dialog manager 216a may use an active federated learning model, which may transmit a global model trained on the remote server to client systems 130 and calculate gradients locally on the client systems 130. Active federated learning may enable the on-device dialog manager 216a to minimize the transmission costs associated with downloading models and uploading gradients. For active federated learning, in each round, client systems 130 may be selected in a semi-random manner based at least in part on a probability conditioned on the current model and the data on the client systems 130 in order to optimize efficiency for training the federated learning model.

In particular embodiments, the dialog state tracker 218a may track state changes over time as a user interacts with the world and the assistant system 140 interacts with the user. As an example and not by way of limitation, the dialog state tracker 218a may track, for example, what the user is talking about, whom the user is with, where the user is, what tasks are currently in progress, and where the user's gaze is at subject to applicable privacy policies.

In particular embodiments, at decision point (D1) 215, the on-device orchestrator 206 may determine to forward the user input to the server for either the second operational mode (i.e., cloud mode) or the third operational mode (i.e., blended mode). As an example and not by way of limitation, if particular functionalities or processes (e.g., messaging) are not supported by on the client system 130, the on-device orchestrator 206 may determine at decision point (D1) 215 to use the third operational mode (i.e., blended mode). In particular embodiments, the on-device orchestrator 206 may cause the outputs from the NLU module 210a, the context engine 220a, and the entity resolution module 212a, via a dialog manager proxy 224, to be forwarded to an entity resolution module 212b of the remote dialog manager 216b to continue the processing. The dialog manager proxy 224 may be a communication channel for information/events exchange between the client system 130 and the server. In particular embodiments, the dialog manager 216b may additionally comprise a remote arbitrator 226b, a remote dialog state tracker 218b, and a remote action selector 222b. In particular embodiments, the assistant system 140 may have started processing a user input with the second operational mode (i.e., cloud mode) at decision point (D0) 205 and the on-device orchestrator 206 may determine to continue processing the user input based on the second operational mode (i.e., cloud mode) at decision point (D1) 215. Accordingly, the output from the NLU module 210b and the context engine 220b may be received at the remote entity resolution module 212b. The remote entity resolution module 212b may have similar functionality as the local entity resolution module 212a, which may comprise resolving entities associated with the slots. In particular embodiments, the entity resolution module 212b may access one or more of the social graph, the knowledge graph, or the concept graph when resolving the entities. The output from the entity resolution module 212b may be received at the arbitrator 226b.

In particular embodiments, the remote arbitrator 226b may be responsible for choosing between client-side and server-side upstream results (e.g., results from the NLU module 210a/b, results from the entity resolution module 212a/b, and results from the context engine 220a/b). The arbitrator 226b may send the selected upstream results to the remote dialog state tracker 218b. In particular embodiments, similarly to the local dialog state tracker 218a, the remote dialog state tracker 218b may convert the upstream results into candidate tasks using task specifications and resolve arguments with entity resolution.

In particular embodiments, at decision point (D2) 225, the on-device orchestrator 206 may determine whether to continue processing the user input based on the first operational mode (i.e., on-device mode) or forward the user input to the server for the third operational mode (i.e., blended mode). The decision may depend on, for example, whether the client-side process is able to resolve the task and slots successfully, whether there is a valid task policy with a specific feature support, and/or the context differences between the client-side process and the server-side process. In particular embodiments, decisions made at decision point (D2) 225 may be for multi-turn scenarios. In particular embodiments, there may be at least two possible scenarios. In a first scenario, the assistant system 140 may have started processing a user input in the first operational mode (i.e., on-device mode) using client-side dialog state. If at some point the assistant system 140 decides to switch to having the remote server process the user input, the assistant system 140 may create a programmatic/predefined task with the current task state and forward it to the remote server. For subsequent turns, the assistant system 140 may continue processing in the third operational mode (i.e., blended mode) using the server-side dialog state. In another scenario, the assistant system 140 may have started processing the user input in either the second operational mode (i.e., cloud mode) or the third operational mode (i.e., blended mode) and may substantially rely on server-side dialog state for all subsequent turns. If the on-device orchestrator 206 determines to continue processing the user input based on the first operational mode (i.e., on-device mode), the output from the dialog state tracker 218a may be received at the action selector 222a.

In particular embodiments, at decision point (D2) 225, the on-device orchestrator 206 may determine to forward the user input to the remote server and continue processing the user input in either the second operational mode (i.e., cloud mode) or the third operational mode (i.e., blended mode). The assistant system 140 may create a programmatic/predefined task with the current task state and forward it to the server, which may be received at the action selector 222b. In particular embodiments, the assistant system 140 may have started processing the user input in the second operational mode (i.e., cloud mode), and the on-device orchestrator 206 may determine to continue processing the user input in the second operational mode (i.e., cloud mode) at decision point (D2) 225. Accordingly, the output from the dialog state tracker 218b may be received at the action selector 222b.

In particular embodiments, the action selector 222a/b may perform interaction management. The action selector 222a/b may determine and trigger a set of general executable actions. The actions may be executed either on the client system 130 or at the remote server. As an example and not by way of limitation, these actions may include providing information or suggestions to the user. In particular embodiments, the actions may interact with agents 228a/b, users, and/or the assistant system 140 itself. These actions may comprise actions including one or more of a slot request, a confirmation, a disambiguation, or an agent execution. The actions may be independent of the underlying implementation of the action selector 222a/b. For more complicated scenarios such as, for example, multi-turn tasks or tasks with complex business logic, the local action selector 222a may call one or more local agents 228a, and the remote action selector 222b may call one or more remote agents 228b to execute the actions. Agents 228a/b may be invoked via task ID, and any actions may be routed to the correct agent 228a/b using that task ID. In particular embodiments, an agent 228a/b may be configured to serve as a broker across a plurality of content providers for one domain. A content provider may be an entity responsible for carrying out an action associated with an intent or completing a task associated with the intent. In particular embodiments, agents 228a/b may provide several functionalities for the assistant system 140 including, for example, native template generation, task specific business logic, and querying external APIs. When executing actions for a task, agents 228a/b may use context from the dialog state tracker 218a/b, and may also update the dialog state tracker 218a/b. In particular embodiments, agents 228a/b may also generate partial payloads from a dialog act.

In particular embodiments, the local agents 228a may have different implementations to be compiled/registered for different platforms (e.g., smart glasses versus a VR headset). In particular embodiments, multiple device-specific implementations (e.g., real-time calls for a client system 130 or a messaging application on the client system 130) may be handled internally by a single agent 228a. Alternatively, device-specific implementations may be handled by multiple agents 228a associated with multiple domains. As an example and not by way of limitation, calling an agent 228a on smart glasses may be implemented in a different manner than calling an agent 228a on a smart phone. Different platforms may also utilize varying numbers of agents 228a. The agents 228a may also be cross-platform (i.e., different operating systems on the client system 130). In addition, the agents 228a may have minimized startup time or binary size impact. Local agents 228a may be suitable for particular use cases. As an example and not by way of limitation, one use case may be emergency calling on the client system 130. As another example and not by way of limitation, another use case may be responding to a user input without network connectivity. As yet another example and not by way of limitation, another use case may be that particular domains/tasks may be privacy sensitive and may prohibit user inputs being sent to the remote server.

In particular embodiments, the local action selector 222a may call a local delivery system 230a for executing the actions, and the remote action selector 222b may call a remote delivery system 230b for executing the actions. The delivery system 230a/b may deliver a predefined event upon receiving triggering signals from the dialog state tracker 218a/b by executing corresponding actions. The delivery system 230a/b may ensure that events get delivered to a host with a living connection. As an example and not by way of limitation, the delivery system 230a/b may broadcast to all online devices that belong to one user. As another example and not by way of limitation, the delivery system 230a/b may deliver events to target-specific devices. The delivery system 230a/b may further render a payload using up-to-date device context.

In particular embodiments, the on-device dialog manager 216a may additionally comprise a separate local action execution module, and the remote dialog manager 216b may additionally comprise a separate remote action execution module. The local execution module and the remote action execution module may have similar functionality. In particular embodiments, the action execution module may call the agents 228a/b to execute tasks. The action execution module may additionally perform a set of general executable actions determined by the action selector 222a/b. The set of executable actions may interact with agents 228a/b, users, and the assistant system 140 itself via the delivery system 230a/b.

In particular embodiments, if the user input is handled using the first operational mode (i.e., on-device mode), results from the agents 228a and/or the delivery system 230a may be returned to the on-device dialog manager 216a. The on-device dialog manager 216a may then instruct a local arbitrator 226a to generate a final response based on these results. The arbitrator 226a may aggregate the results and evaluate them. As an example and not by way of limitation, the arbitrator 226a may rank and select a best result for responding to the user input. If the user request is handled in the second operational mode (i.e., cloud mode), the results from the agents 228b and/or the delivery system 230b may be returned to the remote dialog manager 216b. The remote dialog manager 216b may instruct, via the dialog manager proxy 224, the arbitrator 226a to generate the final response based on these results. Similarly, the arbitrator 226a may analyze the results and select the best result to provide to the user. If the user input is handled based on the third operational mode (i.e., blended mode), the client-side results and server-side results (e.g., from agents 228a/b and/or delivery system 230a/b) may both be provided to the arbitrator 226a by the on-device dialog manager 216a and remote dialog manager 216b, respectively. The arbitrator 226 may then choose between the client-side and server-side side results to determine the final result to be presented to the user. In particular embodiments, the logic to decide between these results may depend on the specific use-case.

In particular embodiments, the local arbitrator 226a may generate a response based on the final result and send it to a render output module 232. The render output module 232 may determine how to render the output in a way that is suitable for the client system 130. As an example and not by way of limitation, for a VR headset or AR smart glasses, the render output module 232 may determine to render the output using a visual-based modality (e.g., an image or a video clip) that may be displayed via the VR headset or AR smart glasses. As another example, the response may be rendered as audio signals that may be played by the user via a VR headset or AR smart glasses. As yet another example, the response may be rendered as augmented-reality data for enhancing user experience.

In particular embodiments, in addition to determining an operational mode to process the user input, the on-device orchestrator 206 may also determine whether to process the user input on the rendering device 137, process the user input on the companion device 138, or process the user request on the remote server. The rendering device 137 and/or the companion device 138 may each use the assistant stack in a similar manner as disclosed above to process the user input. As an example and not by, the on-device orchestrator 206 may determine that part of the processing should be done on the rendering device 137, part of the processing should be done on the companion device 138, and the remaining processing should be done on the remote server.

In particular embodiments, the assistant system 140 may have a variety of capabilities including audio cognition, visual cognition, signals intelligence, reasoning, and memories. In particular embodiments, the capability of audio cognition may enable the assistant system 140 to, for example, understand a user's input associated with various domains in different languages, understand and summarize a conversation, perform on-device audio cognition for complex commands, identify a user by voice, extract topics from a conversation and auto-tag sections of the conversation, enable audio interaction without a wake-word, filter and amplify user voice from ambient noise and conversations, and/or understand which client system 130 a user is talking to if multiple client systems 130 are in vicinity.

In particular embodiments, the capability of visual cognition may enable the assistant system 140 to, for example, recognize interesting objects in the world through a combination of existing machine-learning models and one-shot learning, recognize an interesting moment and auto-capture it, achieve semantic understanding over multiple visual frames across different episodes of time, provide platform support for additional capabilities in places or objects recognition, recognize a full set of settings and micro-locations including personalized locations, recognize complex activities, recognize complex gestures to control a client system 130, handle images/videos from egocentric cameras (e.g., with motion, capture angles, resolution), accomplish similar levels of accuracy and speed regarding images with lower resolution, conduct one-shot registration and recognition of places and objects, and/or perform visual recognition on a client system 130.

In particular embodiments, the assistant system 140 may leverage computer vision techniques to achieve visual cognition. Besides computer vision techniques, the assistant system 140 may explore options that may supplement these techniques to scale up the recognition of objects. In particular embodiments, the assistant system 140 may use supplemental signals such as, for example, optical character recognition (OCR) of an object's labels, GPS signals for places recognition, and/or signals from a user's client system 130 to identify the user. In particular embodiments, the assistant system 140 may perform general scene recognition (e.g., home, work, public spaces) to set a context for the user and reduce the computer-vision search space to identify likely objects or people. In particular embodiments, the assistant system 140 may guide users to train the assistant system 140. For example, crowdsourcing may be used to get users to tag objects and help the assistant system 140 recognize more objects over time. As another example, users may register their personal objects as part of an initial setup when using the assistant system 140. The assistant system 140 may further allow users to provide positive/negative signals for objects they interact with to train and improve personalized models for them.

In particular embodiments, the capability of signals intelligence may enable the assistant system 140 to, for example, determine user location, understand date/time, determine family locations, understand users' calendars and future desired locations, integrate richer sound understanding to identify setting/context through sound alone, and/or build signals intelligence models at runtime which may be personalized to a user's individual routines.

In particular embodiments, the capability of reasoning may enable the assistant system 140 to, for example, pick up previous conversation threads at any point in the future, synthesize all signals to understand micro and personalized context, learn interaction patterns and preferences from users' historical behavior and accurately suggest interactions that they may value, generate highly predictive proactive suggestions based on micro-context understanding, understand what content a user may want to see at what time of a day, and/or understand the changes in a scene and how that may impact the user's desired content.

In particular embodiments, the capabilities of memories may enable the assistant system 140 to, for example, remember which social connections a user previously called or interacted with, write into memory and query memory at will (i.e., open dictation and auto tags), extract richer preferences based on prior interactions and long-term learning, remember a user's life history, extract rich information from egocentric streams of data and auto catalog, and/or write to memory in structured form to form rich short, episodic and long-term memories.

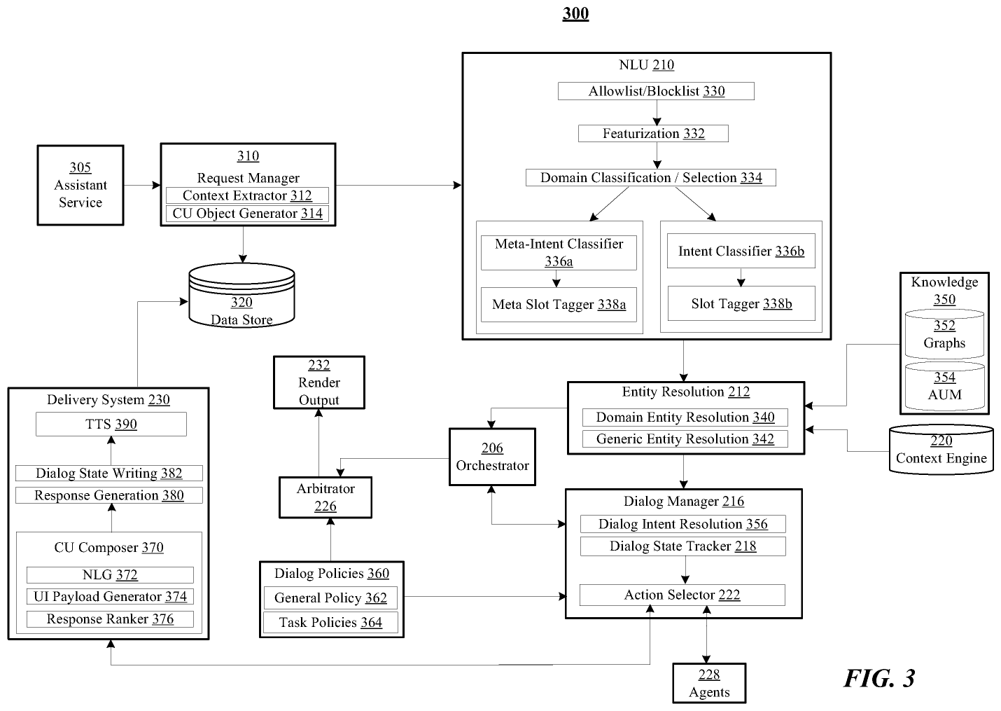

FIG. 3 illustrates an example flow diagram 300 of the assistant system 140. In particular embodiments, an assistant service module 305 may access a request manager 310 upon receiving a user input. In particular embodiments, the request manager 310 may comprise a context extractor 312 and a conversational understanding object generator (CU object generator) 314. The context extractor 312 may extract contextual information associated with the user input. The context extractor 312 may also update contextual information based on the assistant application 136 executing on the client system 130. As an example and not by way of limitation, the update of contextual information may comprise content items are displayed on the client system 130. As another example and not by way of limitation, the update of contextual information may comprise whether an alarm is set on the client system 130. As another example and not by way of limitation, the update of contextual information may comprise whether a song is playing on the client system 130. The CU object generator 314 may generate particular CU objects relevant to the user input. The CU objects may comprise dialog-session data and features associated with the user input, which may be shared with all the modules of the assistant system 140. In particular embodiments, the request manager 310 may store the contextual information and the generated CU objects in a data store 320 which is a particular data store implemented in the assistant system 140.

In particular embodiments, the request manger 310 may send the generated CU objects to the NLU module 210. The NLU module 210 may perform a plurality of steps to process the CU objects. The NLU module 210 may first run the CU objects through an allowlist/blocklist 330. In particular embodiments, the allowlist/blocklist 330 may comprise interpretation data matching the user input. The NLU module 210 may then perform a featurization 332 of the CU objects. The NLU module 210 may then perform domain classification/selection 334 on user input based on the features resulted from the featurization 332 to classify the user input into predefined domains. In particular embodiments, a domain may denote a social context of interaction (e.g., education), or a namespace for a set of intents (e.g., music). The domain classification/selection results may be further processed based on two related procedures. In one procedure, the NLU module 210 may process the domain classification/selection results using a meta-intent classifier 336a. The meta-intent classifier 336a may determine categories that describe the user's intent. An intent may be an element in a pre-defined taxonomy of semantic intentions, which may indicate a purpose of a user interaction with the assistant system 140. The NLU module 210a may classify a user input into a member of the pre-defined taxonomy. For example, the user input may be “Play Beethoven's 5th,” and the NLU module 210a may classify the input as having the intent [IN:play_music]. In particular embodiments, intents that are common to multiple domains may be processed by the meta-intent classifier 336a. As an example and not by way of limitation, the meta-intent classifier 336a may be based on a machine-learning model that may take the domain classification/selection results as input and calculate a probability of the input being associated with a particular predefined meta-intent. The NLU module 210 may then use a meta slot tagger 338a to annotate one or more meta slots for the classification result from the meta-intent classifier 336a. A slot may be a named sub-string corresponding to a character string within the user input representing a basic semantic entity. For example, a slot for “pizza” may be [SL:dish]. In particular embodiments, a set of valid or expected named slots may be conditioned on the classified intent. As an example and not by way of limitation, for the intent [IN:play_music], a valid slot may be [SL:song_name]. In particular embodiments, the meta slot tagger 338a may tag generic slots such as references to items (e.g., the first), the type of slot, the value of the slot, etc. In particular embodiments, the NLU module 210 may process the domain classification/selection results using an intent classifier 336b. The intent classifier 336b may determine the user's intent associated with the user input. In particular embodiments, there may be one intent classifier 336b for each domain to determine the most possible intents in a given domain. As an example and not by way of limitation, the intent classifier 336b may be based on a machine-learning model that may take the domain classification/selection results as input and calculate a probability of the input being associated with a particular predefined intent. The NLU module 210 may then use a slot tagger 338b to annotate one or more slots associated with the user input. In particular embodiments, the slot tagger 338b may annotate the one or more slots for the n-grams of the user input. As an example and not by way of limitation, a user input may comprise “change 500 dollars in my account to Japanese yen.” The intent classifier 336b may take the user input as input and formulate it into a vector. The intent classifier 336b may then calculate probabilities of the user input being associated with different predefined intents based on a vector comparison between the vector representing the user input and the vectors representing different predefined intents. In a similar manner, the slot tagger 338b may take the user input as input and formulate each word into a vector. The slot tagger 338b may then calculate probabilities of each word being associated with different predefined slots based on a vector comparison between the vector representing the word and the vectors representing different predefined slots. The intent of the user may be classified as “changing money”. The slots of the user input may comprise “500”, “dollars”, “account”, and “Japanese yen”. The meta-intent of the user may be classified as “financial service”. The meta slot may comprise “finance”.

In particular embodiments, the natural-language understanding (NLU) module 210 may additionally extract information from one or more of a social graph, a knowledge graph, or a concept graph, and may retrieve a user's profile stored locally on the client system 130. The NLU module 210 may additionally consider contextual information when analyzing the user input. The NLU module 210 may further process information from these different sources by identifying and aggregating information, annotating n-grams of the user input, ranking the n-grams with confidence scores based on the aggregated information, and formulating the ranked n-grams into features that may be used by the NLU module 210 for understanding the user input. In particular embodiments, the NLU module 210 may identify one or more of a domain, an intent, or a slot from the user input in a personalized and context-aware manner. As an example and not by way of limitation, a user input may comprise “show me how to get to the coffee shop.” The NLU module 210 may identify a particular coffee shop that the user wants to go to based on the user's personal information and the associated contextual information. In particular embodiments, the NLU module 210 may comprise a lexicon of a particular language, a parser, and grammar rules to partition sentences into an internal representation. The NLU module 210 may also comprise one or more programs that perform naive semantics or stochastic semantic analysis, and may further use pragmatics to understand a user input. In particular embodiments, the parser may be based on a deep learning architecture comprising multiple long-short term memory (LSTM) networks. As an example and not by way of limitation, the parser may be based on a recurrent neural network grammar (RNNG) model, which is a type of recurrent and recursive LSTM algorithm. More information on natural-language understanding (NLU) may be found in U.S. patent application Ser. No. 16/011,062, filed 18 Jun. 2018, U.S. patent application Ser. No. 16/025,317, filed 2 Jul. 2018, and U.S. patent application Ser. No. 16/038,120, filed 17 Jul. 2018, each of which is incorporated by reference.

In particular embodiments, the output of the NLU module 210 may be sent to the entity resolution module 212 to resolve relevant entities. Entities may include, for example, unique users or concepts, each of which may have a unique identifier (ID). The entities may include one or more of a real-world entity (from general knowledge base), a user entity (from user memory), a contextual entity (device context/dialog context), or a value resolution (numbers, datetime, etc.). In particular embodiments, the entity resolution module 212 may comprise domain entity resolution 340 and generic entity resolution 342. The entity resolution module 212 may execute generic and domain-specific entity resolution. The generic entity resolution 342 may resolve the entities by categorizing the slots and meta slots into different generic topics. The domain entity resolution 340 may resolve the entities by categorizing the slots and meta slots into different domains. As an example and not by way of limitation, in response to the input of an inquiry of the advantages of a particular brand of electric car, the generic entity resolution 342 may resolve the referenced brand of electric car as vehicle and the domain entity resolution 340 may resolve the referenced brand of electric car as electric car.

In particular embodiments, entities may be resolved based on knowledge 350 about the world and the user. The assistant system 140 may extract ontology data from the graphs 352. As an example and not by way of limitation, the graphs 352 may comprise one or more of a knowledge graph, a social graph, or a concept graph. The ontology data may comprise the structural relationship between different slots/meta-slots and domains. The ontology data may also comprise information of how the slots/meta-slots may be grouped, related within a hierarchy where the higher level comprises the domain, and subdivided according to similarities and differences. For example, the knowledge graph may comprise a plurality of entities. Each entity may comprise a single record associated with one or more attribute values. The particular record may be associated with a unique entity identifier. Each record may have diverse values for an attribute of the entity. Each attribute value may be associated with a confidence probability and/or a semantic weight. A confidence probability for an attribute value represents a probability that the value is accurate for the given attribute. A semantic weight for an attribute value may represent how the value semantically appropriate for the given attribute considering all the available information. For example, the knowledge graph may comprise an entity of a book titled “BookName”, which may include information extracted from multiple content sources (e.g., an online social network, online encyclopedias, book review sources, media databases, and entertainment content sources), which may be deduped, resolved, and fused to generate the single unique record for the knowledge graph. In this example, the entity titled “BookName” may be associated with a “fantasy” attribute value for a “genre” entity attribute. More information on the knowledge graph may be found in U.S. patent application Ser. No. 16/048,049, filed 27 Jul. 2018, and U.S. patent application Ser. No. 16/048,101, filed 27 Jul. 2018, each of which is incorporated by reference.

In particular embodiments, the assistant user memory (AUM) 354 may comprise user episodic memories which help determine how to assist a user more effectively. The AUM 354 may be the central place for storing, retrieving, indexing, and searching over user data. As an example and not by way of limitation, the AUM 354 may store information such as contacts, photos, reminders, etc. Additionally, the AUM 354 may automatically synchronize data to the server and other devices (only for non-sensitive data). As an example and not by way of limitation, if the user sets a nickname for a contact on one device, all devices may synchronize and get that nickname based on the AUM 354. In particular embodiments, the AUM 354 may first prepare events, user state, reminder, and trigger state for storing in a data store. Memory node identifiers (ID) may be created to store entry objects in the AUM 354, where an entry may be some piece of information about the user (e.g., photo, reminder, etc.) As an example and not by way of limitation, the first few bits of the memory node ID may indicate that this is a memory node ID type, the next bits may be the user ID, and the next bits may be the time of creation. The AUM 354 may then index these data for retrieval as needed. Index ID may be created for such purpose. In particular embodiments, given an “index key” (e.g., PHOTO_LOCATION) and “index value” (e.g., “San Francisco”), the AUM 354 may get a list of memory IDs that have that attribute (e.g., photos in San Francisco). As an example and not by way of limitation, the first few bits may indicate this is an index ID type, the next bits may be the user ID, and the next bits may encode an “index key” and “index value”. The AUM 354 may further conduct information retrieval with a flexible query language. Relation index ID may be created for such purpose. In particular embodiments, given a source memory node and an edge type, the AUM 354 may get memory IDs of all target nodes with that type of outgoing edge from the source. As an example and not by way of limitation, the first few bits may indicate this is a relation index ID type, the next bits may be the user ID, and the next bits may be a source node ID and edge type. In particular embodiments, the AUM 354 may help detect concurrent updates of different events. More information on episodic memories may be found in U.S. patent application Ser. No. 16/552,559, filed 27 Aug. 2019, which is incorporated by reference.

In particular embodiments, the entity resolution module 212 may use different techniques to resolve different types of entities. For real-world entities, the entity resolution module 212 may use a knowledge graph to resolve the span to the entities, such as “music track”, “movie”, etc. For user entities, the entity resolution module 212 may use user memory or some agents to resolve the span to user-specific entities, such as “contact”, “reminders”, or “relationship”. For contextual entities, the entity resolution module 212 may perform coreference based on information from the context engine 220 to resolve the references to entities in the context, such as “him”, “her”, “the first one”, or “the last one”. In particular embodiments, for coreference, the entity resolution module 212 may create references for entities determined by the NLU module 210. The entity resolution module 212 may then resolve these references accurately. As an example and not by way of limitation, a user input may comprise “find me the nearest grocery store and direct me there”. Based on coreference, the entity resolution module 212 may interpret “there” as “the nearest grocery store”. In particular embodiments, coreference may depend on the information from the context engine 220 and the dialog manager 216 so as to interpret references with improved accuracy. In particular embodiments, the entity resolution module 212 may additionally resolve an entity under the context (device context or dialog context), such as, for example, the entity shown on the screen or an entity from the last conversation history. For value resolutions, the entity resolution module 212 may resolve the mention to exact value in standardized form, such as numerical value, date time, address, etc.

In particular embodiments, the entity resolution module 212 may first perform a check on applicable privacy constraints in order to guarantee that performing entity resolution does not violate any applicable privacy policies. As an example and not by way of limitation, an entity to be resolved may be another user who specifies in their privacy settings that their identity should not be searchable on the online social network. In this case, the entity resolution module 212 may refrain from returning that user's entity identifier in response to a user input. By utilizing the described information obtained from the social graph, the knowledge graph, the concept graph, and the user profile, and by complying with any applicable privacy policies, the entity resolution module 212 may resolve entities associated with a user input in a personalized, context-aware, and privacy-protected manner.

In particular embodiments, the entity resolution module 212 may work with the ASR module 208 to perform entity resolution. The following example illustrates how the entity resolution module 212 may resolve an entity name. The entity resolution module 212 may first expand names associated with a user into their respective normalized text forms as phonetic consonant representations which may be phonetically transcribed using a double metaphone algorithm. The entity resolution module 212 may then determine an n-best set of candidate transcriptions and perform a parallel comprehension process on all of the phonetic transcriptions in the n-best set of candidate transcriptions. In particular embodiments, each transcription that resolves to the same intent may then be collapsed into a single intent. Each intent may then be assigned a score corresponding to the highest scoring candidate transcription for that intent. During the collapse, the entity resolution module 212 may identify various possible text transcriptions associated with each slot, correlated by boundary timing offsets associated with the slot's transcription. The entity resolution module 212 may then extract a subset of possible candidate transcriptions for each slot from a plurality (e.g., 1000) of candidate transcriptions, regardless of whether they are classified to the same intent. In this manner, the slots and intents may be scored lists of phrases. In particular embodiments, a new or running task capable of handling the intent may be identified and provided with the intent (e.g., a message composition task for an intent to send a message to another user). The identified task may then trigger the entity resolution module 212 by providing it with the scored lists of phrases associated with one of its slots and the categories against which it should be resolved. As an example and not by way of limitation, if an entity attribute is specified as “friend,” the entity resolution module 212 may run every candidate list of terms through the same expansion that may be run at matcher compilation time. Each candidate expansion of the terms may be matched in the precompiled trie matching structure. Matches may be scored using a function based at least in part on the transcribed input, matched form, and friend name. As another example and not by way of limitation, if an entity attribute is specified as “celebrity/notable person,” the entity resolution module 212 may perform parallel searches against the knowledge graph for each candidate set of terms for the slot output from the ASR module 208. The entity resolution module 212 may score matches based on matched person popularity and ASR-provided score signal. In particular embodiments, when the memory category is specified, the entity resolution module 212 may perform the same search against user memory. The entity resolution module 212 may crawl backward through user memory and attempt to match each memory (e.g., person recently mentioned in conversation, or seen and recognized via visual signals, etc.). For each entity, the entity resolution module 212 may employ matching similarly to how friends are matched (i.e., phonetic). In particular embodiments, scoring may comprise a temporal decay factor associated with a recency with which the name was previously mentioned. The entity resolution module 212 may further combine, sort, and dedupe all matches. In particular embodiments, the task may receive the set of candidates. When multiple high scoring candidates are present, the entity resolution module 212 may perform user-facilitated disambiguation (e.g., getting real-time user feedback from users on these candidates).

In particular embodiments, the context engine 220 may help the entity resolution module 212 improve entity resolution. The context engine 220 may comprise offline aggregators and an online inference service. The offline aggregators may process a plurality of data associated with the user that are collected from a prior time window. As an example and not by way of limitation, the data may include news feed posts/comments, interactions with news feed posts/comments, search history, etc., that are collected during a predetermined timeframe (e.g., from a prior 90-day window). The processing result may be stored in the context engine 220 as part of the user profile. The user profile of the user may comprise user profile data including demographic information, social information, and contextual information associated with the user. The user profile data may also include user interests and preferences on a plurality of topics, aggregated through conversations on news feed, search logs, messaging platforms, etc. The usage of a user profile may be subject to privacy constraints to ensure that a user's information can be used only for his/her benefit, and not shared with anyone else. More information on user profiles may be found in U.S. patent application Ser. No. 15/967,239, filed 30 Apr. 2018, which is incorporated by reference. In particular embodiments, the online inference service may analyze the conversational data associated with the user that are received by the assistant system 140 at a current time. The analysis result may be stored in the context engine 220 also as part of the user profile. In particular embodiments, both the offline aggregators and online inference service may extract personalization features from the plurality of data. The extracted personalization features may be used by other modules of the assistant system 140 to better understand user input. In particular embodiments, the entity resolution module 212 may process the information from the context engine 220 (e.g., a user profile) in the following steps based on natural-language processing (NLP). In particular embodiments, the entity resolution module 212 may tokenize text by text normalization, extract syntax features from text, and extract semantic features from text based on NLP. The entity resolution module 212 may additionally extract features from contextual information, which is accessed from dialog history between a user and the assistant system 140. The entity resolution module 212 may further conduct global word embedding, domain-specific embedding, and/or dynamic embedding based on the contextual information. The processing result may be annotated with entities by an entity tagger. Based on the annotations, the entity resolution module 212 may generate dictionaries. In particular embodiments, the dictionaries may comprise global dictionary features which can be updated dynamically offline. The entity resolution module 212 may rank the entities tagged by the entity tagger. In particular embodiments, the entity resolution module 212 may communicate with different graphs 352 including one or more of the social graph, the knowledge graph, or the concept graph to extract ontology data that is relevant to the retrieved information from the context engine 220. In particular embodiments, the entity resolution module 212 may further resolve entities based on the user profile, the ranked entities, and the information from the graphs 352.

In particular embodiments, the entity resolution module 212 may be driven by the task (corresponding to an agent 228). This inversion of processing order may make it possible for domain knowledge present in a task to be applied to pre-filter or bias the set of resolution targets when it is obvious and appropriate to do so. As an example and not by way of limitation, for the utterance “who is John?” no clear category is implied in the utterance. Therefore, the entity resolution module 212 may resolve “John” against everything. As another example and not by way of limitation, for the utterance “send a message to John”, the entity resolution module 212 may easily determine “John” refers to a person that one can message. As a result, the entity resolution module 212 may bias the resolution to a friend. As another example and not by way of limitation, for the utterance “what is John's most famous album?” To resolve “John”, the entity resolution module 212 may first determine the task corresponding to the utterance, which is finding a music album. The entity resolution module 212 may determine that entities related to music albums include singers, producers, and recording studios. Therefore, the entity resolution module 212 may search among these types of entities in a music domain to resolve “John.”

In particular embodiments, the output of the entity resolution module 212 may be sent to the dialog manager 216 to advance the flow of the conversation with the user. The dialog manager 216 may be an asynchronous state machine that repeatedly updates the state and selects actions based on the new state. The dialog manager 216 may additionally store previous conversations between the user and the assistant system 140. In particular embodiments, the dialog manager 216 may conduct dialog optimization. Dialog optimization relates to the challenge of understanding and identifying the most likely branching options in a dialog with a user. As an example and not by way of limitation, the assistant system 140 may implement dialog optimization techniques to obviate the need to confirm who a user wants to call because the assistant system 140 may determine a high confidence that a person inferred based on context and available data is the intended recipient. In particular embodiments, the dialog manager 216 may implement reinforcement learning frameworks to improve the dialog optimization. The dialog manager 216 may comprise dialog intent resolution 356, the dialog state tracker 218, and the action selector 222. In particular embodiments, the dialog manager 216 may execute the selected actions and then call the dialog state tracker 218 again until the action selected requires a user response, or there are no more actions to execute. Each action selected may depend on the execution result from previous actions. In particular embodiments, the dialog intent resolution 356 may resolve the user intent associated with the current dialog session based on dialog history between the user and the assistant system 140. The dialog intent resolution 356 may map intents determined by the NLU module 210 to different dialog intents. The dialog intent resolution 356 may further rank dialog intents based on signals from the NLU module 210, the entity resolution module 212, and dialog history between the user and the assistant system 140.

In particular embodiments, the dialog state tracker 218 may use a set of operators to track the dialog state. The operators may comprise necessary data and logic to update the dialog state. Each operator may act as delta of the dialog state after processing an incoming user input. In particular embodiments, the dialog state tracker 218 may a comprise a task tracker, which may be based on task specifications and different rules. The dialog state tracker 218 may also comprise a slot tracker and coreference component, which may be rule based and/or recency based. The coreference component may help the entity resolution module 212 to resolve entities. In alternative embodiments, with the coreference component, the dialog state tracker 218 may replace the entity resolution module 212 and may resolve any references/mentions and keep track of the state. In particular embodiments, the dialog state tracker 218 may convert the upstream results into candidate tasks using task specifications and resolve arguments with entity resolution. Both user state (e.g., user's current activity) and task state (e.g., triggering conditions) may be tracked. Given the current state, the dialog state tracker 218 may generate candidate tasks the assistant system 140 may process and perform for the user. As an example and not by way of limitation, candidate tasks may include “show suggestion,” “get weather information,” or “take photo.” In particular embodiments, the dialog state tracker 218 may generate candidate tasks based on available data from, for example, a knowledge graph, a user memory, and a user task history. In particular embodiments, the dialog state tracker 218 may then resolve the triggers object using the resolved arguments. As an example and not by way of limitation, a user input “remind me to call mom when she's online and I'm home tonight” may perform the conversion from the NLU output to the triggers representation by the dialog state tracker 218 as illustrated in Table 1 below:

TABLE 1
Example Conversion from NLU Output to Triggers Representation

| NLU Ontology Representation: | | Triggers Representation: |
|---|---|---|
| [ IN:CREATE_SMART_REMINDER | → | Triggers: { |
| Remind me to | | andTriggers: [ |
| [SL:TODO call mom] when | | condition: {ContextualEvent(mom is |
| [SL:TRIGGER_CONJUNCTION | | online)}, |
| [IN:GET_TRIGGER | | condition: {ContextualEvent(location |
| [SL:TRIGGER_SOCIAL_UPDATE | | is home)}, |
| she's online] and I'm | | condition: {ContextualEvent(time is |
| [SL:TRIGGER_LOCATION home] | | tonight)}]))]} |
| [SL:DATE_TIME tonight] | | |
| ] | | |
| ] | | |
| ] | | |

In the above example, “mom,” “home,” and “tonight” are represented by their respective entities: personEntity, locationEntity, datetimeEntity.

In particular embodiments, the dialog manager 216 may map events determined by the context engine 220 to actions. As an example and not by way of limitation, an action may be a natural-language generation (NLG) action, a display or overlay, a device action, or a retrieval action. The dialog manager 216 may also perform context tracking and interaction management. Context tracking may comprise aggregating real-time stream of events into a unified user state. Interaction management may comprise selecting optimal action in each state. In particular embodiments, the dialog state tracker 218 may perform context tracking (i.e., tracking events related to the user). To support processing of event streams, the dialog state tracker 218a may use an event handler (e.g., for disambiguation, confirmation, request) that may consume various types of events and update an internal assistant state. Each event type may have one or more handlers. Each event handler may be modifying a certain slice of the assistant state. In particular embodiments, the event handlers may be operating on disjoint subsets of the state (i.e., only one handler may have write-access to a particular field in the state). In particular embodiments, all event handlers may have an opportunity to process a given event. As an example and not by way of limitation, the dialog state tracker 218 may run all event handlers in parallel on every event, and then may merge the state updates proposed by each event handler (e.g., for each event, most handlers may return a NULL update).

In particular embodiments, the dialog state tracker 218 may work as any programmatic handler (logic) that requires versioning. In particular embodiments, instead of directly altering the dialog state, the dialog state tracker 218 may be a side-effect free component and generate n-best candidates of dialog state update operators that propose updates to the dialog state. The dialog state tracker 218 may comprise intent resolvers containing logic to handle different types of NLU intent based on the dialog state and generate the operators. In particular embodiments, the logic may be organized by intent handler, such as a disambiguation intent handler to handle the intents when the assistant system 140 asks for disambiguation, a confirmation intent handler that comprises the logic to handle confirmations, etc. Intent resolvers may combine the turn intent together with the dialog state to generate the contextual updates for a conversation with the user. A slot resolution component may then recursively resolve the slots in the update operators with resolution providers including the knowledge graph and domain agents. In particular embodiments, the dialog state tracker 218 may update/rank the dialog state of the current dialog session. As an example and not by way of limitation, the dialog state tracker 218 may update the dialog state as “completed” if the dialog session is over. As another example and not by way of limitation, the dialog state tracker 218 may rank the dialog state based on a priority associated with it.

In particular embodiments, the dialog state tracker 218 may communicate with the action selector 222 about the dialog intents and associated content objects. In particular embodiments, the action selector 222 may rank different dialog hypotheses for different dialog intents. The action selector 222 may take candidate operators of dialog state and consult the dialog policies 360 to decide what actions should be executed. In particular embodiments, a dialog policy 360 may a tree-based policy, which is a pre-constructed dialog plan. Based on the current dialog state, a dialog policy 360 may choose a node to execute and generate the corresponding actions. As an example and not by way of limitation, the tree-based policy may comprise topic grouping nodes and dialog action (leaf) nodes. In particular embodiments, a dialog policy 360 may also comprise a data structure that describes an execution plan of an action by an agent 228. A dialog policy 360 may further comprise multiple goals related to each other through logical operators. In particular embodiments, a goal may be an outcome of a portion of the dialog policy and it may be constructed by the dialog manager 216. A goal may be represented by an identifier (e.g., string) with one or more named arguments, which parameterize the goal. As an example and not by way of limitation, a goal with its associated goal argument may be represented as {confirm artist, args: {artist: “Madonna”}}. In particular embodiments, goals may be mapped to leaves of the tree of the tree-structured representation of the dialog policy 360.

In particular embodiments, the assistant system 140 may use hierarchical dialog policies 360 with general policy 362 handling the cross-domain business logic and task policies 364 handling the task/domain specific logic. The general policy 362 may be used for actions that are not specific to individual tasks. The general policy 362 may be used to determine task stacking and switching, proactive tasks, notifications, etc. The general policy 362 may comprise handling low-confidence intents, internal errors, unacceptable user response with retries, and/or skipping or inserting confirmation based on ASR or NLU confidence scores. The general policy 362 may also comprise the logic of ranking dialog state update candidates from the dialog state tracker 218 output and pick the one to update (such as picking the top ranked task intent). In particular embodiments, the assistant system 140 may have a particular interface for the general policy 362, which allows for consolidating scattered cross-domain policy/business-rules, especial those found in the dialog state tracker 218, into a function of the action selector 222. The interface for the general policy 362 may also allow for authoring of self-contained sub-policy units that may be tied to specific situations or clients (e.g., policy functions that may be easily switched on or off based on clients, situation). The interface for the general policy 362 may also allow for providing a layering of policies with back-off, i.e., multiple policy units, with highly specialized policy units that deal with specific situations being backed up by more general policies 362 that apply in wider circumstances. In this context the general policy 362 may alternatively comprise intent or task specific policy.

In particular embodiments, a task policy 364 may comprise the logic for action selector 222 based on the task and current state. The task policy 364 may be dynamic and ad-hoc. In particular embodiments, the types of task policies 364 may include one or more of the following types: (1) manually crafted tree-based dialog plans; (2) coded policy that directly implements the interface for generating actions; (3) configurator-specified slot-filling tasks; or (4) machine-learning model based policy learned from data. In particular embodiments, the assistant system 140 may bootstrap new domains with rule-based logic and later refine the task policies 364 with machine-learning models. In particular embodiments, the general policy 362 may pick one operator from the candidate operators to update the dialog state, followed by the selection of a user facing action by a task policy 364. Once a task is active in the dialog state, the corresponding task policy 364 may be consulted to select right actions.

In particular embodiments, the action selector 222 may select an action based on one or more of the event determined by the context engine 220, the dialog intent and state, the associated content objects, and the guidance from dialog policies 360. Each dialog policy 360 may be subscribed to specific conditions over the fields of the state. After an event is processed and the state is updated, the action selector 222 may run a fast search algorithm (e.g., similarly to the Boolean satisfiability) to identify which policies should be triggered based on the current state. In particular embodiments, if multiple policies are triggered, the action selector 222 may use a tie-breaking mechanism to pick a particular policy. Alternatively, the action selector 222 may use a more sophisticated approach which may dry-run each policy and then pick a particular policy which may be determined to have a high likelihood of success. In particular embodiments, mapping events to actions may result in several technical advantages for the assistant system 140. One technical advantage may include that each event may be a state update from the user or the user's physical/digital environment, which may or may not trigger an action from assistant system 140. Another technical advantage may include possibilities to handle rapid bursts of events (e.g., user enters a new building and sees many people) by first consuming all events to update state, and then triggering action(s) from the final state. Another technical advantage may include consuming all events into a single global assistant state.

In particular embodiments, the action selector 222 may take the dialog state update operators as part of the input to select the dialog action. The execution of the dialog action may generate a set of expectations to instruct the dialog state tracker 218 to handle future turns. In particular embodiments, an expectation may be used to provide context to the dialog state tracker 218 when handling the user input from next turn. As an example and not by way of limitation, slot request dialog action may have the expectation of proving a value for the requested slot. In particular embodiments, both the dialog state tracker 218 and the action selector 222 may not change the dialog state until the selected action is executed. This may allow the assistant system 140 to execute the dialog state tracker 218 and the action selector 222 for processing speculative ASR results and to do n-best ranking with dry runs.

In particular embodiments, the action selector 222 may call different agents 228 for task execution. Meanwhile, the dialog manager 216 may receive an instruction to update the dialog state. As an example and not by way of limitation, the update may comprise awaiting agents' 228 response. An agent 228 may select among registered content providers to complete the action. The data structure may be constructed by the dialog manager 216 based on an intent and one or more slots associated with the intent. In particular embodiments, the agents 228 may comprise first-party agents and third-party agents. In particular embodiments, first-party agents may comprise internal agents that are accessible and controllable by the assistant system 140 (e.g. agents associated with services provided by the online social network, such as messaging services or photo-share services). In particular embodiments, third-party agents may comprise external agents that the assistant system 140 has no control over (e.g., third-party online music application agents, ticket sales agents). The first-party agents may be associated with first-party providers that provide content objects and/or services hosted by the social-networking system 160. The third-party agents may be associated with third-party providers that provide content objects and/or services hosted by the third-party system 170. In particular embodiments, each of the first-party agents or third-party agents may be designated for a particular domain. As an example and not by way of limitation, the domain may comprise weather, transportation, music, shopping, social, videos, photos, events, locations, and/or work. In particular embodiments, the assistant system 140 may use a plurality of agents 228 collaboratively to respond to a user input. As an example and not by way of limitation, the user input may comprise “direct me to my next meeting.” The assistant system 140 may use a calendar agent to retrieve the location of the next meeting. The assistant system 140 may then use a navigation agent to direct the user to the next meeting.

In particular embodiments, the dialog manager 216 may support multi-turn compositional resolution of slot mentions. For a compositional parse from the NLU module 210, the resolver may recursively resolve the nested slots. The dialog manager 216 may additionally support disambiguation for the nested slots. As an example and not by way of limitation, the user input may be “remind me to call Alex”. The resolver may need to know which Alex to call before creating an actionable reminder to-do entity. The resolver may halt the resolution and set the resolution state when further user clarification is necessary for a particular slot. The general policy 362 may examine the resolution state and create corresponding dialog action for user clarification. In dialog state tracker 218, based on the user input and the last dialog action, the dialog manager 216 may update the nested slot. This capability may allow the assistant system 140 to interact with the user not only to collect missing slot values but also to reduce ambiguity of more complex/ambiguous utterances to complete the task. In particular embodiments, the dialog manager 216 may further support requesting missing slots in a nested intent and multi-intent user inputs (e.g., “take this photo and send it to Dad”). In particular embodiments, the dialog manager 216 may support machine-learning models for more robust dialog experience. As an example and not by way of limitation, the dialog state tracker 218 may use neural network based models (or any other suitable machine-learning models) to model belief over task hypotheses. As another example and not by way of limitation, for action selector 222, highest priority policy units may comprise white-list/black-list overrides, which may have to occur by design; middle priority units may comprise machine-learning models designed for action selection; and lower priority units may comprise rule-based fallbacks when the machine-learning models elect not to handle a situation. In particular embodiments, machine-learning model based general policy unit may help the assistant system 140 reduce redundant disambiguation or confirmation steps, thereby reducing the number of turns to execute the user input.

In particular embodiments, the determined actions by the action selector 222 may be sent to the delivery system 230. The delivery system 230 may comprise a CU composer 370, a response generation component 380, a dialog state writing component 382, and a text-to-speech (TTS) component 390. Specifically, the output of the action selector 222 may be received at the CU composer 370. In particular embodiments, the output from the action selector 222 may be formulated as a <k,c,u,d> tuple, in which k indicates a knowledge source, c indicates a communicative goal, u indicates a user model, and d indicates a discourse model.

In particular embodiments, the CU composer 370 may generate a communication content for the user using a natural-language generation (NLG) component 372. In particular embodiments, the NLG component 372 may use different language models and/or language templates to generate natural-language outputs. The generation of natural-language outputs may be application specific. The generation of natural-language outputs may be also personalized for each user. In particular embodiments, the NLG component 372 may comprise a content determination component, a sentence planner, and a surface realization component. The content determination component may determine the communication content based on the knowledge source, communicative goal, and the user's expectations. As an example and not by way of limitation, the determining may be based on a description logic. The description logic may comprise, for example, three fundamental notions which are individuals (representing objects in the domain), concepts (describing sets of individuals), and roles (representing binary relations between individuals or concepts). The description logic may be characterized by a set of constructors that allow the natural-language generator to build complex concepts/roles from atomic ones. In particular embodiments, the content determination component may perform the following tasks to determine the communication content. The first task may comprise a translation task, in which the input to the NLG component 372 may be translated to concepts. The second task may comprise a selection task, in which relevant concepts may be selected among those resulted from the translation task based on the user model. The third task may comprise a verification task, in which the coherence of the selected concepts may be verified. The fourth task may comprise an instantiation task, in which the verified concepts may be instantiated as an executable file that can be processed by the NLG component 372. The sentence planner may determine the organization of the communication content to make it human understandable. The surface realization component may determine specific words to use, the sequence of the sentences, and the style of the communication content.

In particular embodiments, the CU composer 370 may also determine a modality of the generated communication content using the UI payload generator 374. Since the generated communication content may be considered as a response to the user input, the CU composer 370 may additionally rank the generated communication content using a response ranker 376. As an example and not by way of limitation, the ranking may indicate the priority of the response. In particular embodiments, the CU composer 370 may comprise a natural-language synthesis (NLS) component that may be separate from the NLG component 372. The NLS component may specify attributes of the synthesized speech generated by the CU composer 370, including gender, volume, pace, style, or register, in order to customize the response for a particular user, task, or agent. The NLS component may tune language synthesis without engaging the implementation of associated tasks. In particular embodiments, the CU composer 370 may check privacy constraints associated with the user to make sure the generation of the communication content follows the privacy policies. More information on customizing natural-language generation (NLG) may be found in U.S. patent application Ser. No. 15/967,279, filed 30 Apr. 2018, and U.S. patent application Ser. No. 15/966,455, filed 30 Apr. 2018, which is incorporated by reference.

In particular embodiments, the delivery system 230 may perform different tasks based on the output of the CU composer 370. These tasks may include writing (i.e., storing/updating) the dialog state into the data store 330 using the dialog state writing component 382 and generating responses using the response generation component 380. In particular embodiments, the output of the CU composer 370 may be additionally sent to the TTS component 390 if the determined modality of the communication content is audio. In particular embodiments, the output from the delivery system 230 comprising one or more of the generated responses, the communication content, or the speech generated by the TTS component 390 may be then sent back to the dialog manager 216.

In particular embodiments, the orchestrator 206 may determine, based on the output of the entity resolution module 212, whether to processing a user input on the client system 130 or on the server, or in the third operational mode (i.e., blended mode) using both. Besides determining how to process the user input, the orchestrator 206 may receive the results from the agents 228 and/or the results from the delivery system 230 provided by the dialog manager 216. The orchestrator 206 may then forward these results to the arbitrator 226. The arbitrator 226 may aggregate these results, analyze them, select the best result, and provide the selected result to the render output module 232. In particular embodiments, the arbitrator 226 may consult with dialog policies 360 to obtain the guidance when analyzing these results. In particular embodiments, the render output module 232 may generate a response that is suitable for the client system 130.

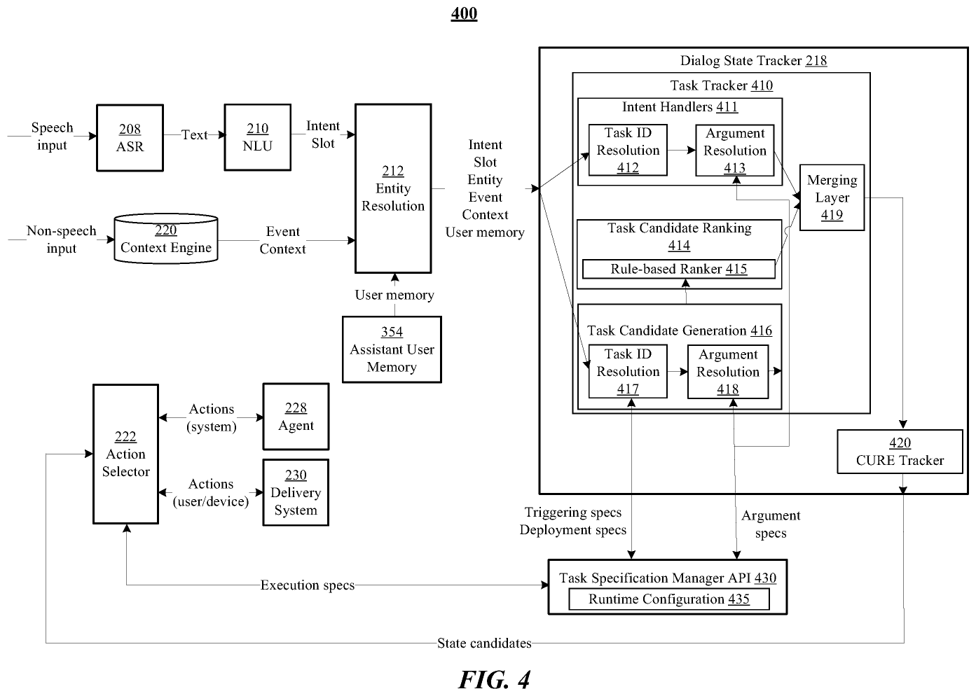

FIG. 4 illustrates an example task-centric flow diagram 400 of processing a user input. In particular embodiments, the assistant system 140 may assist users not only with voice-initiated experiences but also more proactive, multi-modal experiences that are initiated on understanding user context. In particular embodiments, the assistant system 140 may rely on assistant tasks for such purpose. An assistant task may be a central concept that is shared across the whole assistant stack to understand user intention, interact with the user and the world to complete the right task for the user. In particular embodiments, an assistant task may be the primitive unit of assistant capability. It may comprise data fetching, updating some state, executing some command, or complex tasks composed of a smaller set of tasks. Completing a task correctly and successfully to deliver the value to the user may be the goal that the assistant system 140 is optimized for. In particular embodiments, an assistant task may be defined as a capability or a feature. The assistant task may be shared across multiple product surfaces if they have exactly the same requirements so it may be easily tracked. It may also be passed from device to device, and easily picked up mid-task by another device since the primitive unit is consistent. In addition, the consistent format of the assistant task may allow developers working on different modules in the assistant stack to more easily design around it. Furthermore, it may allow for task sharing. As an example and not by way of limitation, if a user is listening to music on smart glasses, the user may say “play this music on my phone.” In the event that the phone hasn't been woken or has a task to execute, the smart glasses may formulate a task that is provided to the phone, which may then be executed by the phone to start playing music. In particular embodiments, the assistant task may be retained by each surface separately if they have different expected behaviors. In particular embodiments, the assistant system 140 may identify the right task based on user inputs in different modality or other signals, conduct conversation to collect all necessary information, and complete that task with action selector 222 implemented internally or externally, on server or locally product surfaces. In particular embodiments, the assistant stack may comprise a set of processing components from wake-up, recognizing user inputs, understanding user intention, reasoning about the tasks, fulfilling a task to generate natural-language response with voices.

In particular embodiments, the user input may comprise speech input. The speech input may be received at the ASR module 208 for extracting the text transcription from the speech input. The ASR module 208 may use statistical models to determine the most likely sequences of words that correspond to a given portion of speech received by the assistant system 140 as audio input. The models may include one or more of hidden Markov models, neural networks, deep learning models, or any combination thereof. The received audio input may be encoded into digital data at a particular sampling rate (e.g., 16, 44.1, or 96 kHz) and with a particular number of bits representing each Sample (e.g., 8, 16, of 24 bits).

In particular embodiments, the ASR module 208 may comprise one or more of a grapheme-to-phoneme (G2P) model, a pronunciation learning model, a personalized acoustic model, a personalized language model (PLM), or an end-pointing model. In particular embodiments, the grapheme-to-phoneme (G2P) model may be used to determine a user's grapheme-to-phoneme style (i.e., what it may sound like when a particular user speaks a particular word). In particular embodiments, the personalized acoustic model may be a model of the relationship between audio signals and the sounds of phonetic units in the language. Therefore, such personalized acoustic model may identify how a user's voice sounds. The personalized acoustical model may be generated using training data such as training speech received as audio input and the corresponding phonetic units that correspond to the speech. The personalized acoustical model may be trained or refined using the voice of a particular user to recognize that user's speech. In particular embodiments, the personalized language model may then determine the most likely phrase that corresponds to the identified phonetic units for a particular audio input. The personalized language model may be a model of the probabilities that various word sequences may occur in the language. The sounds of the phonetic units in the audio input may be matched with word sequences using the personalized language model, and greater weights may be assigned to the word sequences that are more likely to be phrases in the language. The word sequence having the highest weight may be then selected as the text that corresponds to the audio input. In particular embodiments, the personalized language model may also be used to predict what words a user is most likely to say given a context. In particular embodiments, the end-pointing model may detect when the end of an utterance is reached. In particular embodiments, based at least in part on a limited computing power of the client system 130, the assistant system 140 may optimize the personalized language model at runtime during the client-side process. As an example and not by way of limitation, the assistant system 140 may pre-compute a plurality of personalized language models for a plurality of possible subjects a user may talk about. When a user input is associated with a request for assistance, the assistant system 140 may promptly switch between and locally optimize the pre-computed language models at runtime based on user activities. As a result, the assistant system 140 may preserve computational resources while efficiently identifying a subject matter associated with the user input. In particular embodiments, the assistant system 140 may also dynamically re-learn user pronunciations at runtime.

In particular embodiments, the user input may comprise non-speech input. The non-speech input may be received at the context engine 220 for determining events and context from the non-speech input. The context engine 220 may determine multi-modal events comprising voice/text intents, location updates, visual events, touch, gaze, gestures, activities, device/application events, and/or any other suitable type of events. The voice/text intents may depend on the ASR module 208 and the NLU module 210. The location updates may be consumed by the dialog manager 216 to support various proactive/reactive scenarios. The visual events may be based on person or object appearing in the user's field of view. These events may be consumed by the dialog manager 216 and recorded in transient user state to support visual co-reference (e.g., resolving “that” in “how much is that shirt?” and resolving “him” in “send him my contact”). The gaze, gesture, and activity may result in flags being set in the transient user state (e.g., user is running) which may condition the action selector 222. For the device/application events, if an application makes an update to the device state, this may be published to the assistant system 140 so that the dialog manager 216 may use this context (what is currently displayed to the user) to handle reactive and proactive scenarios. As an example and not by way of limitation, the context engine 220 may cause a push notification message to be displayed on a display screen of the user's client system 130. The user may interact with the push notification message, which may initiate a multi-modal event (e.g., an event workflow for replying to a message received from another user). Other example multi-modal events may include seeing a friend, seeing a landmark, being at home, running, starting a call with touch, taking a photo with touch, opening an application, etc. In particular embodiments, the context engine 220 may also determine world/social events based on world/social updates (e.g., weather changes, a friend getting online). The social updates may comprise events that a user is subscribed to, (e.g., friend's birthday, posts, comments, other notifications). These updates may be consumed by the dialog manager 216 to trigger proactive actions based on context (e.g., suggesting a user call a friend on their birthday, but only if the user is not focused on something else). As an example and not by way of limitation, receiving a message may be a social event, which may trigger the task of reading the message to the user.

In particular embodiments, the text transcription from the ASR module 208 may be sent to the NLU module 210. The NLU module 210 may process the text transcription and extract the user intention (i.e., intents) and parse the slots or parsing result based on the linguistic ontology. In particular embodiments, the intents and slots from the NLU module 210 and/or the events and contexts from the context engine 220 may be sent to the entity resolution module 212. In particular embodiments, the entity resolution module 212 may resolve entities associated with the user input based on the output from the NLU module 210 and/or the context engine 220. The entity resolution module 212 may use different techniques to resolve the entities, including accessing user memory from the assistant user memory (AUM) 354. In particular embodiments, the AUM 354 may comprise user episodic memories helpful for resolving the entities by the entity resolution module 212. The AUM 354 may be the central place for storing, retrieving, indexing, and searching over user data.

In particular embodiments, the entity resolution module 212 may provide one or more of the intents, slots, entities, events, context, or user memory to the dialog state tracker 218. The dialog state tracker 218 may identify a set of state candidates for a task accordingly, conduct interaction with the user to collect necessary information to fill the state, and call the action selector 222 to fulfill the task. In particular embodiments, the dialog state tracker 218 may comprise a task tracker 410. The task tracker 410 may track the task state associated with an assistant task. In particular embodiments, a task state may be a data structure persistent cross interaction turns and updates in real time to capture the state of the task during the whole interaction. The task state may comprise all the current information about a task execution status, such as arguments, confirmation status, confidence score, etc. Any incorrect or outdated information in the task state may lead to failure or incorrect task execution. The task state may also serve as a set of contextual information for many other components such as the ASR module 208, the NLU module 210, etc.

In particular embodiments, the task tracker 410 may comprise intent handlers 411, task candidate ranking module 414, task candidate generation module 416, and merging layer 419. In particular embodiments, a task may be identified by its ID name. The task ID may be used to associate corresponding component assets if it is not explicitly set in the task specification, such as dialog policy 360, agent execution, NLG dialog act, etc. Therefore, the output from the entity resolution module 212 may be received by a task ID resolution component 417 of the task candidate generation module 416 to resolve the task ID of the corresponding task. In particular embodiments, the task ID resolution component 417 may call a task specification manager API 430 to access the triggering specifications and deployment specifications for resolving the task ID. Given these specifications, the task ID resolution component 417 may resolve the task ID using intents, slots, dialog state, context, and user memory.

In particular embodiments, the technical specification of a task may be defined by a task specification. The task specification may be used by the assistant system 140 to trigger a task, conduct dialog conversation, and find a right execution module (e.g., agents 228) to execute the task. The task specification may be an implementation of the product requirement document. It may serve as the general contract and requirements that all the components agreed on. It may be considered as an assembly specification for a product, while all development partners deliver the modules based on the specification. In particular embodiments, an assistant task may be defined in the implementation by a specification. As an example and not by way of limitation, the task specification may be defined as the following categories. One category may be a basic task schema which comprises the basic identification information such as ID, name, and the schema of the input arguments. Another category may be a triggering specification, which is about how a task can be triggered, such as intents, event message ID, etc. Another category may be a conversational specification, which is for dialog manager 216 to conduct the conversation with users and systems. Another category may be an execution specification, which is about how the task will be executed and fulfilled. Another category may be a deployment specification, which is about how a feature will be deployed to certain surfaces, local, and group of users.

In particular embodiments, the task specification manager API 430 may be an API for accessing a task specification manager. The task specification manager may be a module in the runtime stack for loading the specifications from all the tasks and providing interfaces to access all the tasks specifications for detailed information or generating task candidates. In particular embodiments, the task specification manager may be accessible for all components in the runtime stack via the task specification manager API 430. The task specification manager may comprise a set of static utility functions to manage tasks with the task specification manager, such as filtering task candidates by platform. Before landing the task specification, the assistant system 140 may also dynamically load the task specifications to support end-to-end development on the development stage.

In particular embodiments, the task specifications may be grouped by domains and stored in runtime configurations 435. The runtime stack may load all the task specifications from the runtime configurations 435 during the building time. In particular embodiments, in the runtime configurations 435, for a domain, there may be a cconf file and a cinc file (e.g., sidechef_task.cconf and sidechef_task.inc). As an example and not by way of limitation, <domain>_tasks.cconf may comprise all the details of the task specifications. As another example and not by way of limitation, <domain>_tasks.cinc may provide a way to override the generated specification if there is no support for that feature yet.

In particular embodiments, a task execution may require a set of arguments to execute. Therefore, an argument resolution component 418 may resolve the argument names using the argument specifications for the resolved task ID. These arguments may be resolved based on NLU outputs (e.g., slot [SL:contact]), dialog state (e.g., short-term calling history), user memory (such as user preferences, location, long-term calling history, etc.), or device context (such as timer states, screen content, etc.). In particular embodiments, the argument modality may be text, audio, images or other structured data. The slot to argument mapping may be defined by a filling strategy and/or language ontology. In particular embodiments, given the task triggering specifications, the task candidate generation module 416 may look for the list of tasks to be triggered as task candidates based on the resolved task ID and arguments.

In particular embodiments, the generated task candidates may be sent to the task candidate ranking module 414 to be further ranked. The task candidate ranking module 414 may use a rule-based ranker 415 to rank them. In particular embodiments, the rule-based ranker 415 may comprise a set of heuristics to bias certain domain tasks. The ranking logic may be described as below with principles of context priority. In particular embodiments, the priority of a user specified task may be higher than an on-foreground task. The priority of the on-foreground task may be higher than a device-domain task when the intent is a meta intent. The priority of the device-domain task may be higher than a task of a triggering intent domain. As an example and not by way of limitation, the ranking may pick the task if the task domain is mentioned or specified in the utterance, such as “create a timer in TIMER app”. As another example and not by way of imitation, the ranking may pick the task if the task domain is on foreground or active state, such as “stop the timer” to stop the timer while the TIMER app is on foreground and there is an active timer. As yet another example and not by way of imitation, the ranking may pick the task if the intent is general meta intent, and the task is device control while there is no other active application or active state. As yet another example and not by way of imitation, the ranking may pick the task if the task is the same as the intent domain. In particular embodiments, the task candidate ranking module 414 may customize some more logic to check the match of intent/slot/entity types. The ranked task candidates may be sent to the merging layer 419.

In particular embodiments, the output from the entity resolution module 212 may also sent to a task ID resolution component 412 of the intent handlers 411. The task ID resolution component 412 may resolve the task ID of the corresponding task similarly to the task ID resolution component 417. In particular embodiments, the intent handlers 411 may additionally comprise an argument resolution component 413. The argument resolution component 413 may resolve the argument names using the argument specifications for the resolved task ID similarly to the argument resolution component 418. In particular embodiments, intent handlers 411 may deal with task agnostic features and may not be expressed within the task specifications which are task specific. Intent handlers 411 may output state candidates other than task candidates such as argument update, confirmation update, disambiguation update, etc. In particular embodiments, some tasks may require very complex triggering conditions or very complex argument filling logic that may not be reusable by other tasks even if they were supported in the task specifications (e.g., in-call voice commands, media tasks via [IN:PLAY_MEDIA], etc.). Intent handlers 411 may be also suitable for such type of tasks. In particular embodiments, the results from the intent handlers 411 may take precedence over the results from the task candidate ranking module 414. The results from the intent handlers 411 may be also sent to the merging layer 419.

In particular embodiments, the merging layer 419 may combine the results from the intent handlers 411 and the results from the task candidate ranking module 414. The dialog state tracker 218 may suggest each task as a new state for the dialog policies 360 to select from, thereby generating a list of state candidates. The merged results may be further sent to a conversational understanding reinforcement engine (CURE) tracker 420. In particular embodiments, the CURE tracker 420 may be a personalized learning process to improve the determination of the state candidates by the dialog state tracker 218 under different contexts using real-time user feedback. More information on conversational understanding reinforcement engine may be found in U.S. patent application Ser. No. 17/186,459, filed 26 Feb. 2021, which is incorporated by reference.

In particular embodiments, the state candidates generated by the CURE tracker 420 may be sent to the action selector 222. The action selector 222 may consult with the task policies 364, which may be generated from execution specifications accessed via the task specification manager API 430. In particular embodiments, the execution specifications may describe how a task should be executed and what actions the action selector 222 may need to take to complete the task.

In particular embodiments, the action selector 222 may determine actions associated with the system. Such actions may involve the agents 228 to execute. As a result, the action selector 222 may send the system actions to the agents 228 and the agents 228 may return the execution results of these actions. In particular embodiments, the action selector may determine actions associated with the user or device. Such actions may need to be executed by the delivery system 230. As a result, the action selector 222 may send the user/device actions to the delivery system 230 and the delivery system 230 may return the execution results of these actions.

The embodiments disclosed herein may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

### Social Graphs

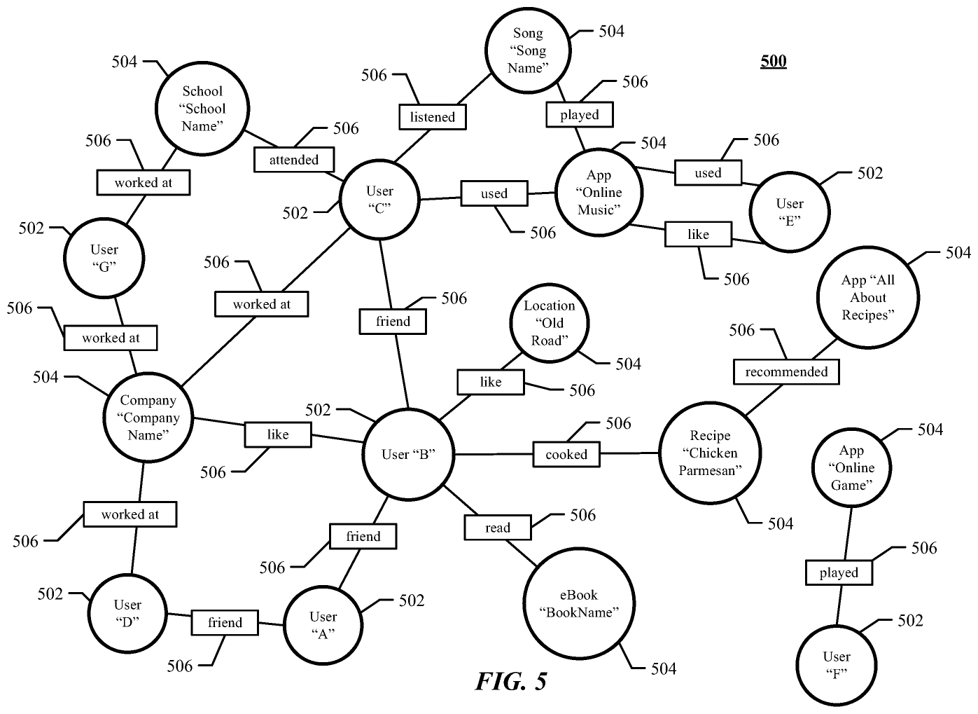

FIG. 5 illustrates an example social graph 500. In particular embodiments, the social-networking system 160 may store one or more social graphs 500 in one or more data stores. In particular embodiments, the social graph 500 may include multiple nodes—which may include multiple user nodes 502 or multiple concept nodes 504—and multiple edges 506 connecting the nodes. Each node may be associated with a unique entity (i.e., user or concept), each of which may have a unique identifier (ID), such as a unique number or username. The example social graph 500 illustrated in FIG. 5 is shown, for didactic purposes, in a two-dimensional visual map representation. In particular embodiments, a social-networking system 160, a client system 130, an assistant system 140, or a third-party system 170 may access the social graph 500 and related social-graph information for suitable applications. The nodes and edges of the social graph 500 may be stored as data objects, for example, in a data store (such as a social-graph database). Such a data store may include one or more searchable or queryable indexes of nodes or edges of the social graph 500.

In particular embodiments, a user node 502 may correspond to a user of the social-networking system 160 or the assistant system 140. As an example and not by way of limitation, a user may be an individual (human user), an entity (e.g., an enterprise, business, or third-party application), or a group (e.g., of individuals or entities) that interacts or communicates with or over the social-networking system 160 or the assistant system 140. In particular embodiments, when a user registers for an account with the social-networking system 160, the social-networking system 160 may create a user node 502 corresponding to the user, and store the user node 502 in one or more data stores. Users and user nodes 502 described herein may, where appropriate, refer to registered users and user nodes 502 associated with registered users. In addition or as an alternative, users and user nodes 502 described herein may, where appropriate, refer to users that have not registered with the social-networking system 160. In particular embodiments, a user node 502 may be associated with information provided by a user or information gathered by various systems, including the social-networking system 160. As an example and not by way of limitation, a user may provide his or her name, profile picture, contact information, birth date, sex, marital status, family status, employment, education background, preferences, interests, or other demographic information. In particular embodiments, a user node 502 may be associated with one or more data objects corresponding to information associated with a user. In particular embodiments, a user node 502 may correspond to one or more web interfaces.

In particular embodiments, a concept node 504 may correspond to a concept. As an example and not by way of limitation, a concept may correspond to a place (such as, for example, a movie theater, restaurant, landmark, or city); a website (such as, for example, a website associated with the social-networking system 160 or a third-party website associated with a web-application server); an entity (such as, for example, a person, business, group, sports team, or celebrity); a resource (such as, for example, an audio file, video file, digital photo, text file, structured document, or application) which may be located within the social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 504 may be associated with information of a concept provided by a user or information gathered by various systems, including the social-networking system 160 and the assistant system 140. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 504 may be associated with one or more data objects corresponding to information associated with concept node 504. In particular embodiments, a concept node 504 may correspond to one or more web interfaces.

In particular embodiments, a node in the social graph 500 may represent or be represented by a web interface (which may be referred to as a “profile interface”). Profile interfaces may be hosted by or accessible to the social-networking system 160 or the assistant system 140. Profile interfaces may also be hosted on third-party websites associated with a third-party system 170. As an example and not by way of limitation, a profile interface corresponding to a particular external web interface may be the particular external web interface and the profile interface may correspond to a particular concept node 504. Profile interfaces may be viewable by all or a selected subset of other users. As an example and not by way of limitation, a user node 502 may have a corresponding user-profile interface in which the corresponding user may add content, make declarations, or otherwise express himself or herself. As another example and not by way of limitation, a concept node 504 may have a corresponding concept-profile interface in which one or more users may add content, make declarations, or express themselves, particularly in relation to the concept corresponding to concept node 504.

In particular embodiments, a concept node 504 may represent a third-party web interface or resource hosted by a third-party system 170. The third-party web interface or resource may include, among other elements, content, a selectable or other icon, or other inter-actable object representing an action or activity. As an example and not by way of limitation, a third-party web interface may include a selectable icon such as “like,” “check-in,” “eat,” “recommend,” or another suitable action or activity. A user viewing the third-party web interface may perform an action by selecting one of the icons (e.g., “check-in”), causing a client system 130 to send to the social-networking system 160 a message indicating the user's action. In response to the message, the social-networking system 160 may create an edge (e.g., a check-in-type edge) between a user node 502 corresponding to the user and a concept node 504 corresponding to the third-party web interface or resource and store edge 506 in one or more data stores.

In particular embodiments, a pair of nodes in the social graph 500 may be connected to each other by one or more edges 506. An edge 506 connecting a pair of nodes may represent a relationship between the pair of nodes. In particular embodiments, an edge 506 may include or represent one or more data objects or attributes corresponding to the relationship between a pair of nodes. As an example and not by way of limitation, a first user may indicate that a second user is a “friend” of the first user. In response to this indication, the social-networking system 160 may send a “friend request” to the second user. If the second user confirms the “friend request,” the social-networking system 160 may create an edge 506 connecting the first user's user node 502 to the second user's user node 502 in the social graph 500 and store edge 506 as social-graph information in one or more of data stores 164. In the example of FIG. 5, the social graph 500 includes an edge 506 indicating a friend relation between user nodes 502 of user “A” and user “B” and an edge indicating a friend relation between user nodes 502 of user “C” and user “B.” Although this disclosure describes or illustrates particular edges 506 with particular attributes connecting particular user nodes 502, this disclosure contemplates any suitable edges 506 with any suitable attributes connecting user nodes 502. As an example and not by way of limitation, an edge 506 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in the social graph 500 by one or more edges 506. The degree of separation between two objects represented by two nodes, respectively, is a count of edges in a shortest path connecting the two nodes in the social graph 500. As an example and not by way of limitation, in the social graph 500, the user node 502 of user “C” is connected to the user node 502 of user “A” via multiple paths including, for example, a first path directly passing through the user node 502 of user “B,” a second path passing through the concept node 504 of company “CompanyName” and the user node 502 of user “D,” and a third path passing through the user nodes 502 and concept nodes 504 representing school “SchoolName,” user “G,” company “CompanyName,” and user “D.” User “C” and user “A” have a degree of separation of two because the shortest path connecting their corresponding nodes (i.e., the first path) includes two edges 506.

In particular embodiments, an edge 506 between a user node 502 and a concept node 504 may represent a particular action or activity performed by a user associated with user node 502 toward a concept associated with a concept node 504. As an example and not by way of limitation, as illustrated in FIG. 5, a user may “like,” “attended,” “played,” “listened,” “cooked,” “worked at,” or “read” a concept, each of which may correspond to an edge type or subtype. A concept-profile interface corresponding to a concept node 504 may include, for example, a selectable “check in” icon (such as, for example, a clickable “check in” icon) or a selectable “add to favorites” icon. Similarly, after a user clicks these icons, the social-networking system 160 may create a “favorite” edge or a “check in” edge in response to a user's action corresponding to a respective action. As another example and not by way of limitation, a user (user “C”) may listen to a particular song (“SongName”) using a particular application (a third-party online music application). In this case, the social-networking system 160 may create a “listened” edge 506 and a “used” edge (as illustrated in FIG. 5) between user nodes 502 corresponding to the user and concept nodes 504 corresponding to the song and application to indicate that the user listened to the song and used the application. Moreover, the social-networking system 160 may create a “played” edge 506 (as illustrated in FIG. 5) between concept nodes 504 corresponding to the song and the application to indicate that the particular song was played by the particular application. In this case, “played” edge 506 corresponds to an action performed by an external application (the third-party online music application) on an external audio file (the song “SongName”). Although this disclosure describes particular edges 506 with particular attributes connecting user nodes 502 and concept nodes 504, this disclosure contemplates any suitable edges 506 with any suitable attributes connecting user nodes 502 and concept nodes 504. Moreover, although this disclosure describes edges between a user node 502 and a concept node 504 representing a single relationship, this disclosure contemplates edges between a user node 502 and a concept node 504 representing one or more relationships. As an example and not by way of limitation, an edge 506 may represent both that a user likes and has used at a particular concept. Alternatively, another edge 506 may represent each type of relationship (or multiples of a single relationship) between a user node 502 and a concept node 504 (as illustrated in FIG. 5 between user node 502 for user “E” and concept node 504 for “online music application”).

In particular embodiments, the social-networking system 160 may create an edge 506 between a user node 502 and a concept node 504 in the social graph 500. As an example and not by way of limitation, a user viewing a concept-profile interface (such as, for example, by using a web browser or a special-purpose application hosted by the user's client system 130) may indicate that he or she likes the concept represented by the concept node 504 by clicking or selecting a “Like” icon, which may cause the user's client system 130 to send to the social-networking system 160 a message indicating the user's liking of the concept associated with the concept-profile interface. In response to the message, the social-networking system 160 may create an edge 506 between user node 502 associated with the user and concept node 504, as illustrated by “like” edge 506 between the user and concept node 504. In particular embodiments, the social-networking system 160 may store an edge 506 in one or more data stores. In particular embodiments, an edge 506 may be automatically formed by the social-networking system 160 in response to a particular user action. As an example and not by way of limitation, if a first user uploads a picture, reads a book, watches a movie, or listens to a song, an edge 506 may be formed between user node 502 corresponding to the first user and concept nodes 504 corresponding to those concepts. Although this disclosure describes forming particular edges 506 in particular manners, this disclosure contemplates forming any suitable edges 506 in any suitable manner.

### Vector Spaces and Embeddings

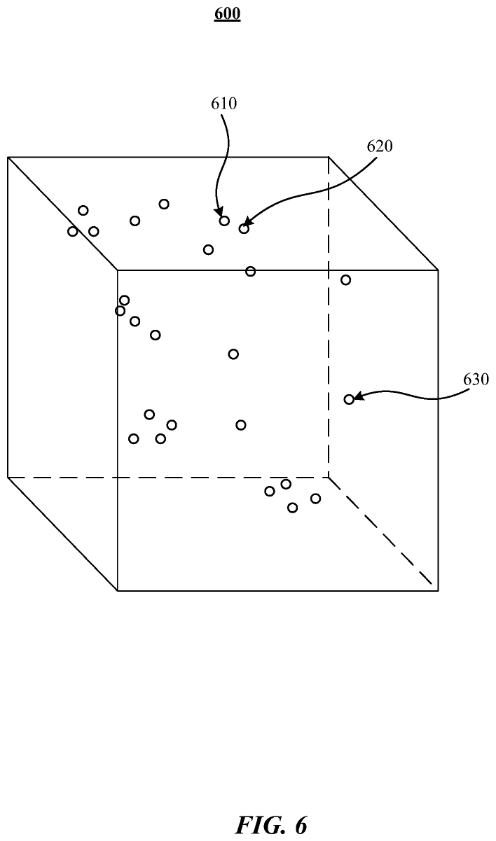

FIG. 6 illustrates an example view of a vector space 600. In particular embodiments, an object or an n-gram may be represented in a d-dimensional vector space, where d denotes any suitable number of dimensions. Although the vector space 600 is illustrated as a three-dimensional space, this is for illustrative purposes only, as the vector space 600 may be of any suitable dimension. In particular embodiments, an n-gram may be represented in the vector space 600 as a vector referred to as a term embedding. Each vector may comprise coordinates corresponding to a particular point in the vector space 600 (i.e., the terminal point of the vector). As an example and not by way of limitation, vectors 610, 620, and 630 may be represented as points in the vector space 600, as illustrated in FIG. 6. An n-gram may be mapped to a respective vector representation. As an example and not by way of limitation, n-grams t₁ and t₂ may be mapped to vectors [symbol] and [symbol] in the vector space 600, respectively, by applying a function [symbol] defined by a dictionary, such that [symbol] = [symbol] (t₁) and [symbol] = [symbol] (t₂). As another example and not by way of limitation, a dictionary trained to map text to a vector representation may be utilized, or such a dictionary may be itself generated via training. As another example and not by way of limitation, a word-embeddings model may be used to map an n-gram to a vector representation in the vector space 600. In particular embodiments, an n-gram may be mapped to a vector representation in the vector space 600 by using a machine leaning model (e.g., a neural network). The machine learning model may have been trained using a sequence of training data (e.g., a corpus of objects each comprising n-grams).

In particular embodiments, an object may be represented in the vector space 600 as a vector referred to as a feature vector or an object embedding. As an example and not by way of limitation, objects e₁ and e₂ may be mapped to vectors [symbol] and [symbol] in the vector space 600, respectively, by applying a function [symbol] , such that [symbol] = [symbol] (e₁) and [symbol] = [symbol] (e₂). In particular embodiments, an object may be mapped to a vector based on one or more properties, attributes, or features of the object, relationships of the object with other objects, or any other suitable information associated with the object. As an example and not by way of limitation, a function may map objects to vectors by feature extraction, which may start from an initial set of measured data and build derived values (e.g., features). As an example and not by way of limitation, an object comprising a video or an image may be mapped to a vector by using an algorithm to detect or isolate various desired portions or shapes of the object. Features used to calculate the vector may be based on information obtained from edge detection, corner detection, blob detection, ridge detection, scale-invariant feature transformation, edge direction, changing intensity, autocorrelation, motion detection, optical flow, thresholding, blob extraction, template matching, Hough transformation (e.g., lines, circles, ellipses, arbitrary shapes), or any other suitable information. As another example and not by way of limitation, an object comprising audio data may be mapped to a vector based on features such as a spectral slope, a tonality coefficient, an audio spectrum centroid, an audio spectrum envelope, a Mel-frequency cepstrum, or any other suitable information. In particular embodiments, when an object has data that is either too large to be efficiently processed or comprises redundant data, a function [symbol] may map the object to a vector using a transformed reduced set of features (e.g., feature selection). In particular embodiments, a function [symbol] may map an object e to a vector [symbol] (e) based on one or more n-grams associated with object e. Although this disclosure describes representing an n-gram or an object in a vector space in a particular manner, this disclosure contemplates representing an n-gram or an object in a vector space in any suitable manner.

In particular embodiments, the social-networking system 160 may calculate a similarity metric of vectors in vector space 600. A similarity metric may be a cosine similarity, a Minkowski distance, a Mahalanobis distance, a Jaccard similarity coefficient, or any suitable similarity metric. As an example and not by way of limitation, a similarity metric of [symbol] and [symbol] may be a cosine similarity

$$\frac{\vec{{v}_{1}} \cdot \vec{{v}_{2}}}{‖ \vec{{v}_{1}} ‖ ‖ \vec{{v}_{2}} ‖} .$$

As another example and not by way of limitation, a similarity metric of [symbol] and [symbol] may be a Euclidean distance ∥ [symbol] - [symbol] ∥. A similarity metric of two vectors may represent how similar the two objects or n-grams corresponding to the two vectors, respectively, are to one another, as measured by the distance between the two vectors in the vector space 600. As an example and not by way of limitation, vector 610 and vector 620 may correspond to objects that are more similar to one another than the objects corresponding to vector 610 and vector 630, based on the distance between the respective vectors. Although this disclosure describes calculating a similarity metric between vectors in a particular manner, this disclosure contemplates calculating a similarity metric between vectors in any suitable manner.

More information on vector spaces, embeddings, feature vectors, and similarity metrics may be found in U.S. patent application Ser. No. 14/949,436, filed 23 Nov. 2015, U.S. patent application Ser. No. 15/286,315, filed 5 Oct. 2016, and U.S. patent application Ser. No. 15/365,789, filed 30 Nov. 2016, each of which is incorporated by reference.

### Artificial Neural Networks

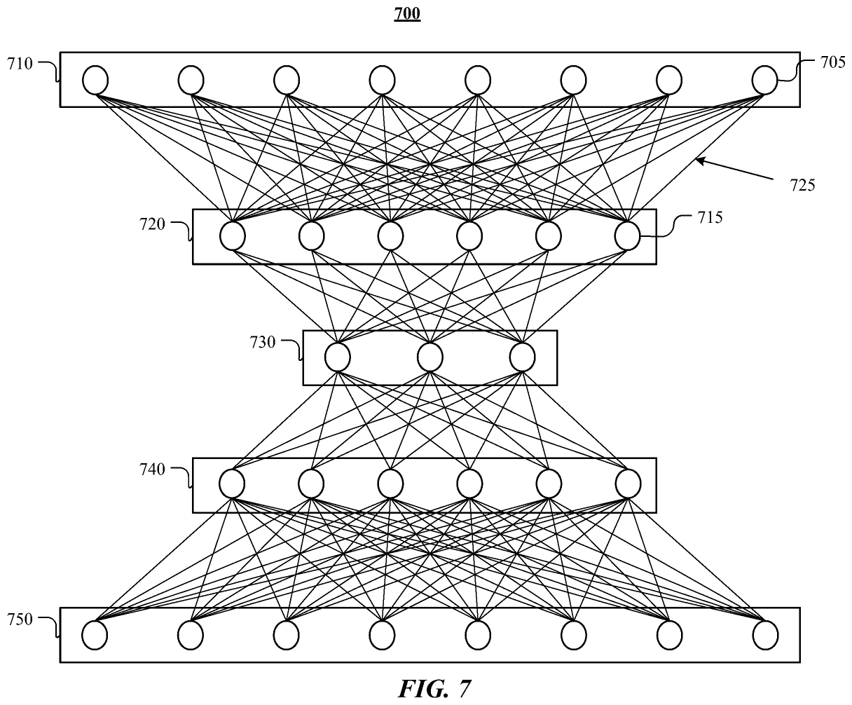

FIG. 7 illustrates an example artificial neural network (“ANN”) 700. In particular embodiments, an ANN may refer to a computational model comprising one or more nodes. Example ANN 700 may comprise an input layer 710, hidden layers 720, 730, 740, and an output layer 750. Each layer of the ANN 700 may comprise one or more nodes, such as a node 705 or a node 715. In particular embodiments, each node of an ANN may be connected to another node of the ANN. As an example and not by way of limitation, each node of the input layer 710 may be connected to one of more nodes of the hidden layer 720. In particular embodiments, one or more nodes may be a bias node (e.g., a node in a layer that is not connected to and does not receive input from any node in a previous layer). In particular embodiments, each node in each layer may be connected to one or more nodes of a previous or subsequent layer. Although FIG. 7 depicts a particular ANN with a particular number of layers, a particular number of nodes, and particular connections between nodes, this disclosure contemplates any suitable ANN with any suitable number of layers, any suitable number of nodes, and any suitable connections between nodes. As an example and not by way of limitation, although FIG. 7 depicts a connection between each node of the input layer 710 and each node of the hidden layer 720, one or more nodes of the input layer 710 may not be connected to one or more nodes of the hidden layer 720.

In particular embodiments, an ANN may be a feedforward ANN (e.g., an ANN with no cycles or loops where communication between nodes flows in one direction beginning with the input layer and proceeding to successive layers). As an example and not by way of limitation, the input to each node of the hidden layer 720 may comprise the output of one or more nodes of the input layer 710. As another example and not by way of limitation, the input to each node of the output layer 750 may comprise the output of one or more nodes of the hidden layer 740. In particular embodiments, an ANN may be a deep neural network (e.g., a neural network comprising at least two hidden layers). In particular embodiments, an ANN may be a deep residual network. A deep residual network may be a feedforward ANN comprising hidden layers organized into residual blocks. The input into each residual block after the first residual block may be a function of the output of the previous residual block and the input of the previous residual block. As an example and not by way of limitation, the input into residual block N may be F(x)+x, where F(x) may be the output of residual block N−1, x may be the input into residual block N−1. Although this disclosure describes a particular ANN, this disclosure contemplates any suitable ANN.

In particular embodiments, an activation function may correspond to each node of an ANN. An activation function of a node may define the output of a node for a given input. In particular embodiments, an input to a node may comprise a set of inputs. As an example and not by way of limitation, an activation function may be an identity function, a binary step function, a logistic function, or any other suitable function. As another example and not by way of limitation, an activation function for a node k may be the sigmoid function

$${F}_{k} ( {s}_{k} ) = \frac{1}{1 + {e}^{- {s}_{k}}} ,$$

the hyperbolic tangent function

$${F}_{k} ( {s}_{k} ) = \frac{{e}^{{s}_{k}} - {e}^{- {s}_{k}}}{{e}^{{s}_{k}} + {e}^{- {s}_{k}}} ,$$

the rectifier Fₖ(sₖ)=max(0, sₖ), or any other suitable function Fₖ(sₖ), where sₖ may be the effective input to node k. In particular embodiments, the input of an activation function corresponding to a node may be weighted. Each node may generate output using a corresponding activation function based on weighted inputs. In particular embodiments, each connection between nodes may be associated with a weight. As an example and not by way of limitation, a connection 725 between the node 705 and the node 715 may have a weighting coefficient of 0.4, which may indicate that 0.4 multiplied by the output of the node 705 is used as an input to the node 715. As another example and not by way of limitation, the output yₖ of node k may be yₖ=Fₖ(sₖ), where Fₖ may be the activation function corresponding to node k, sₖ=Σⱼ(wⱼₖxⱼ) may be the effective input to node k, xⱼ may be the output of a node j connected to node k, and wⱼₖ may be the weighting coefficient between node j and node k. In particular embodiments, the input to nodes of the input layer may be based on a vector representing an object. Although this disclosure describes particular inputs to and outputs of nodes, this disclosure contemplates any suitable inputs to and outputs of nodes. Moreover, although this disclosure may describe particular connections and weights between nodes, this disclosure contemplates any suitable connections and weights between nodes.

In particular embodiments, an ANN may be trained using training data. As an example and not by way of limitation, training data may comprise inputs to the ANN 700 and an expected output. As another example and not by way of limitation, training data may comprise vectors each representing a training object and an expected label for each training object. In particular embodiments, training an ANN may comprise modifying the weights associated with the connections between nodes of the ANN by optimizing an objective function. As an example and not by way of limitation, a training method may be used (e.g., the conjugate gradient method, the gradient descent method, the stochastic gradient descent) to backpropagate the sum-of-squares error measured as a distances between each vector representing a training object (e.g., using a cost function that minimizes the sum-of-squares error). In particular embodiments, an ANN may be trained using a dropout technique. As an example and not by way of limitation, one or more nodes may be temporarily omitted (e.g., receive no input and generate no output) while training. For each training object, one or more nodes of the ANN may have some probability of being omitted. The nodes that are omitted for a particular training object may be different than the nodes omitted for other training objects (e.g., the nodes may be temporarily omitted on an object-by-object basis). Although this disclosure describes training an ANN in a particular manner, this disclosure contemplates training an ANN in any suitable manner.

### Privacy

In particular embodiments, one or more objects (e.g., content or other types of objects) of a computing system may be associated with one or more privacy settings. The one or more objects may be stored on or otherwise associated with any suitable computing system or application, such as, for example, a social-networking system 160, a client system 130, an assistant system 140, a third-party system 170, a social-networking application, an assistant application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system 160 or assistant system 140 or shared with other systems (e.g., a third-party system 170). Although this disclosure describes using particular privacy settings in a particular manner, this disclosure contemplates using any suitable privacy settings in any suitable manner.

In particular embodiments, privacy settings may be based on one or more nodes or edges of a social graph 500. A privacy setting may be specified for one or more edges 506 or edge-types of the social graph 500, or with respect to one or more nodes 502, 504 or node-types of the social graph 500. The privacy settings applied to a particular edge 506 connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a first user may share an object to the social-networking system 160. The object may be associated with a concept node 504 connected to a user node 502 of the first user by an edge 506. The first user may specify privacy settings that apply to a particular edge 506 connecting to the concept node 504 of the object, or may specify privacy settings that apply to all edges 506 connecting to the concept node 504. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system 160 may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system 160 may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems 170, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers 162 may be authorization/privacy servers for enforcing privacy settings. In response to a request from a user (or other entity) for a particular object stored in a data store 164, the social-networking system 160 may send a request to the data store 164 for the object. The request may identify the user associated with the request and the object may be sent only to the user (or a client system 130 of the user) if the authorization server determines that the user is authorized to access the object based on the privacy settings associated with the object. If the requesting user is not authorized to access the object, the authorization server may prevent the requested object from being retrieved from the data store 164 or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user, or may be the particular user's account or information stored on the social-networking system 160, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In particular embodiments, the social-networking system 160 may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system 160 or assistant system 140 may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system 160 or assistant system 140 may access such information in order to provide a particular function or service to the first user, without the social-networking system 160 or assistant system 140 having access to that information for any other purposes. Before accessing, storing, or using such objects or information, the social-networking system 160 or assistant system 140 may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system 160 or assistant system 140.

In particular embodiments, a user may specify whether particular types of objects or information associated with the first user may be accessed, stored, or used by the social-networking system 160 or assistant system 140. As an example and not by way of limitation, the first user may specify that images sent by the first user through the social-networking system 160 or assistant system 140 may not be stored by the social-networking system 160 or assistant system 140. As another example and not by way of limitation, a first user may specify that messages sent from the first user to a particular second user may not be stored by the social-networking system 160 or assistant system 140. As yet another example and not by way of limitation, a first user may specify that all objects sent via a particular application may be saved by the social-networking system 160 or assistant system 140.

In particular embodiments, privacy settings may allow a first user to specify whether particular objects or information associated with the first user may be accessed from particular client systems 130 or third-party systems 170. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system 160 or assistant system 140 may provide default privacy settings with respect to each device, system, or application, and/or the first user may be prompted to specify a particular privacy setting for each context. As an example and not by way of limitation, the first user may utilize a location-services feature of the social-networking system 160 or assistant system 140 to provide recommendations for restaurants or other places in proximity to the user. The first user's default privacy settings may specify that the social-networking system 160 or assistant system 140 may use location information provided from a client system 130 of the first user to provide the location-based services, but that the social-networking system 160 or assistant system 140 may not store the location information of the first user or provide it to any third-party system 170. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular embodiments, the social-networking system 160 or assistant system 140 may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the social-networking system 160 or assistant system 140. The user's privacy settings may specify that such information may be used only for particular processes, such as authentication, and further specify that such information may not be shared with any third-party system 170 or used for other processes or applications associated with the social-networking system 160 or assistant system 140. As another example and not by way of limitation, the social-networking system 160 may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any third-party system 170 or used by other processes or applications associated with the social-networking system 160.

### Systems and Methods

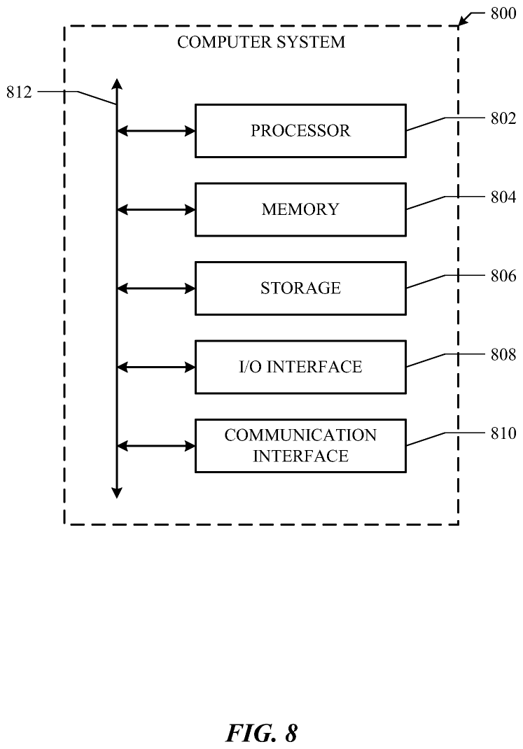

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Managing Audio Processing During Multi-User Communications

In particular embodiments, the assistant system 140 may protect user privacy when users interact with the assistant application 136 during multi-party interactions by utilizing client-side processes to limit the audio data received and processed by each user and their respective assistant system 140. The multi-party interactions may be communications between two or more users over a network 110, in-person, or through any other suitable form of communication. In particular embodiments, the assistant system 140 may enable users to conduct multi-party interactions in a primarily hands-free computing environment. For example, two or more remotely separated users may each be associated with a client system 130, which may be a wireless electronic device such as a smartphone, a smart assistant device, a wearable smart device (e.g., AR smart glasses), or any suitable wireless electronic device associated with assistant system 140. The two or more users may conduct an audio or video call over a network 110 using the audio and/or video receiving and transmitting capabilities of their respective client systems 130. As another example, a user with a client system 130 (e.g., a wearable smart device) associated with assistant system 140 may conduct an in-person conversation with one or more other individuals.

During multi-party communications, users may have a reasonable expectation of privacy for the multi-modal data which may be captured, processed, recorded, shared, and/or transmitted during the course of the multi-party interaction. For example, a user may reasonably expect the assistant system 140 to be implemented with limitations on the scope of audio data (e.g., verbal communications in a call between two users) that may be recorded by the client system 130 of the user, received by the client system 130 of another user, or transmitted over a network 110 to another remote computing system (e.g., a centralized server associated with the assistant system 140). As another example, during a call between users, a user may prefer, when interacting with the assistant application 136 during a multi-party call (e.g., verbal requests by the user to the assistant xbot, audio responses rendered by the assistant xbot), that other users cannot hear or otherwise observe interactions between the user and the assistant application 136. In addition to such expectations of privacy, users may also expect that the assistant system 140 provides satisfactory levels of utility, performance, accuracy, responsiveness, and safety, which may conflict with or limit the feasibility and available resources for ensuring satisfactory privacy protection. In other words, there is a need to implement an assistant system 140 that balances and satisfies these complex user expectations. The embodiments described herein address this need by managing the processing and transmission of user audio data during multi-party communications based on relevant design parameters, which may include the type and content of the communication (e.g., business calls, personal calls), the mode of communication (e.g., audio call, video call), the manner of activating the assistant system 140 (e.g., wake-words, button presses, body gestures, eye movements), the manner in which users are notified that the assistant system 140 is in an activated state, whether other users are notified that the assistant system 140 associated with the user is in an activated state, whether audio data processing occurs on one or both sides of the connection (e.g., by the client systems 130 for each user), and whether any audio data processing is performed at any remote computing systems (e.g., cloud computing). Although this disclosure describes assistant systems 140 that balance and satisfy particular user expectations using particular design parameters, this disclosure contemplates assistant systems that balance and satisfy any relevant user expectations using any suitable design parameters.

In particular embodiments, a client system 130 may receive a verbal user input from a user associated with the client system 130. The user input may be based on the user's voice (e.g., the user may speak to the client system 130), and may be processed by a system audio API 202 (application programming interface) on the client system 130. The system audio API 202 may conduct echo cancellation, noise removal, beam forming, and self-user voice activation, speaker identification, voice activity detection (VAD), and any other suitable acoustic techniques to generate audio data that is readily processable by the assistant system 140 and other client-side processes of the assistant application 136 on the client system 130. In particular embodiments, the system audio API 202 may perform a wake-word detection 204 from the user input. As an example and not by way of limitation, a wake-word may be “hey assistant.” If a wake-word is detected, the assistant system 140 may be activated accordingly. In particular embodiments, the wake-word may be a pre-determined wake-word associated with the assistant system 140, or may be a wake-word that the user may have previously designated as a chosen wake-word. Although this disclosure describes detecting particular wake-words using particular wake-word detection techniques, this disclosure contemplates detecting any suitable wake-words using any suitable wake-word detection techniques.

In particular embodiments, prior to detection of a wake-word, client-side processes on the client system 130 may be configured to limit audio data processing unrelated to wake-word detection of audio data received by the client system 130. For example, prior to detection of a wake-word, the assistant orchestrator 206 on the client system 130 may be configured to limit the transmission of audio data generated by the system audio API 202 to the assistant system 140. As another example, prior to detection of a wake-word, the assistant orchestrator 206 may limit the audio data it passes to other client-side processes (e.g., ASR module 217, NLU module 218). In this case, even after a wake-word is detected, the assistant orchestrator 206 may continue to limit the audio data it passes to other client-side processes to only what is necessary for the reasoning module 222 to perform false trigger mitigation to detect false activation requests. Limiting unnecessary processing and transmission of audio data prior to detection of a valid wake-word may assure users that their privacy is being protected in a reasonable manner. Although this disclosure describes limiting processing and transmission of audio data in a particular manner, this disclosure contemplates limiting processing and transmission of audio data in any suitable manner.

In particular embodiments, upon detection of a wake-word, the assistant system 140 may be activated to enable the user to interact with the assistant system 140 in stateful and multi-turn conversations to get assistance in obtaining information, services, and performance of assistant-related tasks. For example, a user may say “hey assistant, call Michael.” In this example, the assistant system 140 may be activated upon detection of the wake-word “hey assistant,” and may begin processing the subsequent verbal request to “call Michael.” In particular embodiments, activation requirements for the assistant system 140 may be loosened to enable invocation of the assistant system 140 without required detection of an associated wake-word. For example, if the assistant system 140 determines that an alarm has been activated on a client system 130 such that the client system 130 is actively broadcasting an abrasive audio alert, the activation requirements for the assistant system 140 may be loosened to permit the user to invoke the assistant system 140 by saying “stop,” without having to recite the designated wake-word “hey assistant,” as would otherwise be required. In alternative embodiments, activation requirements for the assistant system 140 may be heightened to require that an increased recognition confidence threshold is satisfied before the assistant system 140 may be invoked. For example, if the assistant system 140 determines that two users are engaged in a call, if a first user says the wake-word “hey assistant,” which is then transmitted and output as audio to the second user, the assistant system 140 and/or the assistant application 136 for each user may determine that a wake-word recognition confidence is satisfied for the first user but is not satisfied for the second user. The assistant system 140 may then be activated for the first user but may remain inactive for the second user. Although this disclosure describes activating assistant system 140 based on particular wake-word detection techniques, this disclosure contemplates activating assistant systems based on any suitable activation techniques.

In particular embodiments, upon detection of a wake-word by a user during a multi-party call that activates the assistant system 140, the assistant application 136 and/or the assistant system 140 may be configured to prevent or limit the client device 130 of a user from transmitting audio data received by the client device 130 until the user finishes interacting with the assistant system 140. For example, during a multi-party call, a user may say “hey assistant, tell me what the weather is in Chicago today,” which may cause the assistant system 140 to provide an audio response describing the weather in Chicago. In this example, following detection of the wake-word “hey assistant,” the assistant system 140 may prevent transmission of a subsequent request input by the user to other users on the call. Additionally or alternatively, upon detection of the wake-word, the assistant system 140 may prevent or limit the client device 130 of the user from broadcasting incoming audio data received from other users on the call. In this case, using the preceding example, following detection of the wake-word “hey assistant,” the assistant application 136 or assistant system 140 may mute or reduce the volume of other user's voices. In alternative embodiments, the assistant application 136 or assistant system 140 may instead be configured to determine that the user has finished vocalizing their request following the wake-word before preventing or limiting the incoming or outgoing audio data as described above. In particular embodiments, the determination that the user has finished vocalizing their request following the wake-word may be based on an end-pointing model configured to detect the end-point of a user's utterance. In this case, using the preceding example, the assistant system 140 may first determine that the user has finished saying “hey assistant, tell me what the weather is in Chicago today” before muting the voices of other users or preventing audio transmissions to other users. In particular embodiments, rather than preventing or limiting the incoming or outgoing audio data as described above, the incoming audio data may continue to be broadcast by the client device 130, but may be algorithmically subtracted out from the audio received by the client device 130 of the user to avoid inadvertently affecting the interactions between the user and the assistant system 140 based on words spoken by the other users. Additionally or alternatively, the client device 130 of the user may be configured to use known beamforming techniques to ensure that the assistant system 140 properly responds to verbal input from the user, and avoids responding to other sources of audio input received by the client device 130 (e.g., verbal inputs received from other users, audio signal noise, sounds originating from the user's environment).

In particular embodiments, the assistant system 140 may selectively prevent or limit the incoming or outgoing audio data based on a sensitivity threshold associated with a verbal request input by a user. For example, requests by a user to read their messages, emails, or check their calendar may be considered sensitive requests, in which case the assistant system 140 may mute the voices of other users and prevent audio transmissions to other users as described above. As another example, requests associated with the current time, date, or weather may be considered non-sensitive requests, in which case the assistant system 140 may refrain from muting the voices of other users and preventing audio transmissions to other users. In particular embodiments, requests input by the user may result in a multi-turn interaction (e.g., requests requiring further disambiguation, entity resolution, or information retrieval), in which case the assistant system 140 may prevent or limit incoming or outgoing audio data for part or all of the multi-turn interaction. The assistant system 140 may determine, for each turn of the multi-turn interaction, whether to continue preventing or limiting audio data based on a sensitivity level for that that turn of the multi-turn interaction. In particular embodiments, a multi-turn interaction may require or benefit from an interaction with another user on the call and/or another assistant system 140 associated with the client system 130 of another user. For example, a user may say “hey assistant, help me schedule a lunch with Michael,” in which case the assistant system 140 may require information from Michael or from the assistant system 140 associated with Michael's client system 130 to resolve the user's request. In particular embodiments, the assistant system 140 may prompt the user and/or other user for permission to interact with the other user or the assistant system 140 associated with the client system 130 of the other user (e.g., by displaying an authorization prompt on the client device 130 of the user and/or other user). Alternatively, an assistant system 140 may be authorized to interact with the other user or the assistant system 140 associated with the client system 130 of the other user based on a previous authorization to interact with the other user or the assistant system 140 associated with the client system 130 of the other user (e.g., express ongoing authorization; implied authorization determined by machine learning techniques). If the assistant system 140 is authorized to interact with the other user or the assistant system 140 associated with the client system 130 of the other user, the assistant system 140 may discontinue or reduce the limitations placed on the incoming or outgoing audio data in order to interact with the other user or the assistant system 140 associated with the client system 130 of the other user. In this case, using the preceding example, if the user and/or Michael are prompted and agree to authorize the assistant system 140 to interact with Michael, the assistant system 140 may unmute Michael's incoming voice data, transmit available scheduling options to Michael, process the audio response received from Michael, and schedule a lunch between the user and Michael based on the received response. In alternative embodiments, the assistant system 140 may communicate directly with the assistant system 140 associated with the client system 130 of the other user. In this case, using the preceding example, the assistant system 140 may communicate scheduling options to the assistant system 140 associated with Michael's client system 130, which may then check Michael's schedule or interact with Michael in the same privacy preserving manner as described above. The assistant system 140 associated with Michael's client system 130 may then communicate acceptable scheduling options back to the assistant system 140. The assistant systems 140 associated with the client devices 130 for both the user and Michael may then add the scheduled lunch to the respective calendars. Having the assistant systems 140 communicate directly with each other eliminates the need to obtain user consent for an assistant system 140 associated with a client system of one user to communicate directly with another user. Additionally, direct communication between the assistant systems 140 eliminates the need to transmit audio data associated with interactions between a user and their assistant system 140 to other users.

In particular embodiments, the assistant system 140 may cause an indicator or notification to be displayed or output as audio to the user and/or other users on the call when the assistant system 140 prevents or limits the incoming or outgoing audio data as described above. For example, when the assistant system 140 has muted the voices of the other users and prevented the user's audio data from being transmitted to other users, the assistant system 140 may inform the user and/or other users on the call by causing a visual indicator (e.g., mute symbol, explanatory text) to be displayed on the client devices 130 of the user and/or other users on the call. As another example, the assistant system 140 may cause an audio indicator (e.g., alert tone) to be broadcast by the client devices 130 of the user and/or other users on the call. As yet another example, the assistant system 140 may cause a visual indicator to be observable on the user's client device 130 by the user and/or other nearby users (e.g., an LED on the exterior and/or interior of a wearable smart device). In particular embodiments, in a video call between users in which a live video feed of the user is displayed on the client devices of the other users, when the assistant system 140 has muted the voices of other users and prevented the user's audio data from being transmitted to other users, the assistant system 140 may additionally cause the user's mouth to be blurred or otherwise obscured to prevent the other users from clearly observing the user's lips move when interacting with the assistant system 140.

In particular embodiments, the prevention or limitation of incoming or outgoing audio data as described above may continue until the user finishes interacting with their assistant system 140. For example, during a multi-party call, a user may say “hey assistant, tell me what the weather is in Chicago today,” which may cause the user's assistant system 140 to provide an audio response describing the weather in Chicago. In this case, the assistant system 140 may unmute the other user's voices and resume audio transmission to other users after providing the audio response describing the weather in Chicago. In particular embodiments, the assistant system 140 may determine that the user has finished interacting with their assistant based on a verbal input (e.g., the user says “never mind”), a non-verbal input (e.g., a button press), a contextual determination (e.g., end-point detection; single-turn interactions), or a period of time in which no verbal input is received by the user that exceeds a threshold period of time (i.e., timeout).

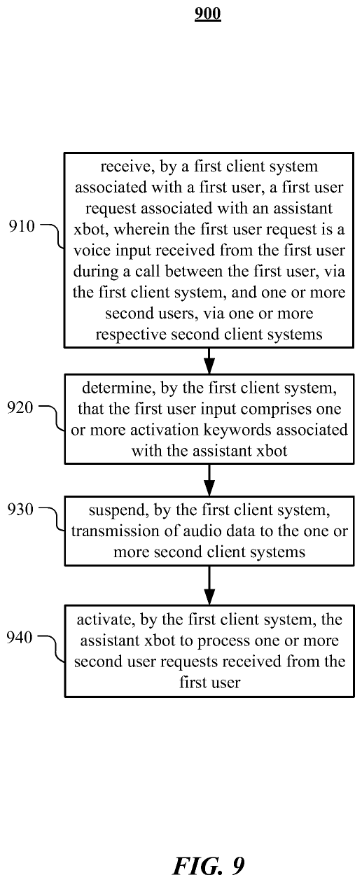

FIG. 9 illustrates an example method 900 for managing audio processing during multi-party calls. The method may begin at step 910, where the assistant system 140 may receive, by a first client system associated with a first user, a first user request associated with an assistant xbot, wherein the first user request is a voice input received from the first user during a call between the first user, via the first client system, and one or more second users, via one or more respective second client systems. At step 920, the assistant system 140 may determine, by the first client system, that the first user input comprises one or more activation keywords associated with the assistant xbot. At step 930, the assistant system 140 may suspend, by the first client system, transmission of audio data to the one or more second client systems. At step 940, the assistant system 140 may activate, by the first client system, the assistant xbot to process one or more second user requests received from the first user. Particular embodiments may repeat one or more steps of the method of FIG. 9, where appropriate. Although this disclosure describes and illustrates particular steps of the method of FIG. 9 as occurring in a particular order, this disclosure contemplates any suitable steps of the method of FIG. 9 occurring in any suitable order. Moreover, although this disclosure describes and illustrates an example method for managing audio processing during multi-party calls including the particular steps of the method of FIG. 9, this disclosure contemplates any suitable method for managing audio processing during multi-party calls, including any suitable steps, which may include all, some, or none of the steps of the method of FIG. 9, where appropriate. Furthermore, although this disclosure describes and illustrates particular components, devices, or systems carrying out particular steps of the method of FIG. 9, this disclosure contemplates any suitable combination of any suitable components, devices, or systems carrying out any suitable steps of the method of FIG. 9.

### Inbox Summarization

In particular embodiments, the assistant system 140 may implement a framework for providing users with effective and intuitive hands-free inbox management across multiple messaging platforms. Existing smart devices can handle sending and receiving messages from a given messaging platform, but cannot concurrently manage messaging across multiple platforms, especially when each platform is associated with unique signals and requires retrieval of platform-specific types of content with varying levels of privacy. Similarly, existing platforms may be configured to aggregate content from multiple platforms using the same identity model (e.g., an email address), but are not capable of aggregating content from platforms with different identity models (e.g., an email address and a social media handle), particularly when certain platforms may have completely different models for contacts, social graphs, favorites, end-to-end privacy, etc.

Particular implementations disclosed herein provide inbox summarization techniques for smart devices (e.g., smart glasses, smart speakers) which may lack display screens, touch input interfaces, or other clear modes of interaction. In particular, users may be limited to interacting with their devices via audio communication, but may still require a means for content navigation. In particular embodiments, a user of one or more online media platforms (e.g., email, text messaging, social media) may wish to be informed of any new messages, posts, or other content that they have received on these online media platforms in an audio format. For example, a user's hands may be preoccupied (e.g., driving, carrying groceries) but may be able to vocally communicate with an electronic device (e.g., wearable device, smart phone). In particular embodiments, an assistant system 140 may provide users with a natural and useful synopsis of a heterogenous set of pending messages across multiple messaging platforms (e.g., email, text messaging, social media). Inbox summarizations may be customized based on contact rankings, recency signals, user input, and platform-specific content types. Particular implementations may incorporate persistent state functionality during readout to let users linearly drill down on inbox content through conversational interaction with the Assistant. Although this disclosure describes providing users with voice-mediated content navigation techniques for particular types of content (e.g., received messages), this disclosure contemplates providing users with any suitable voice-mediated content navigation techniques for any suitable types of content (e.g., real-time messaging, social media feeds, news feeds).

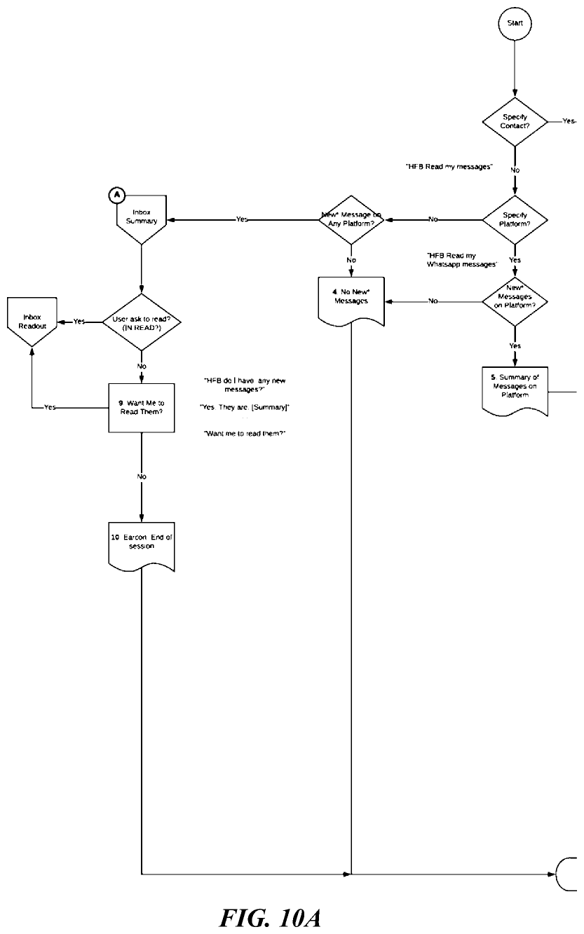

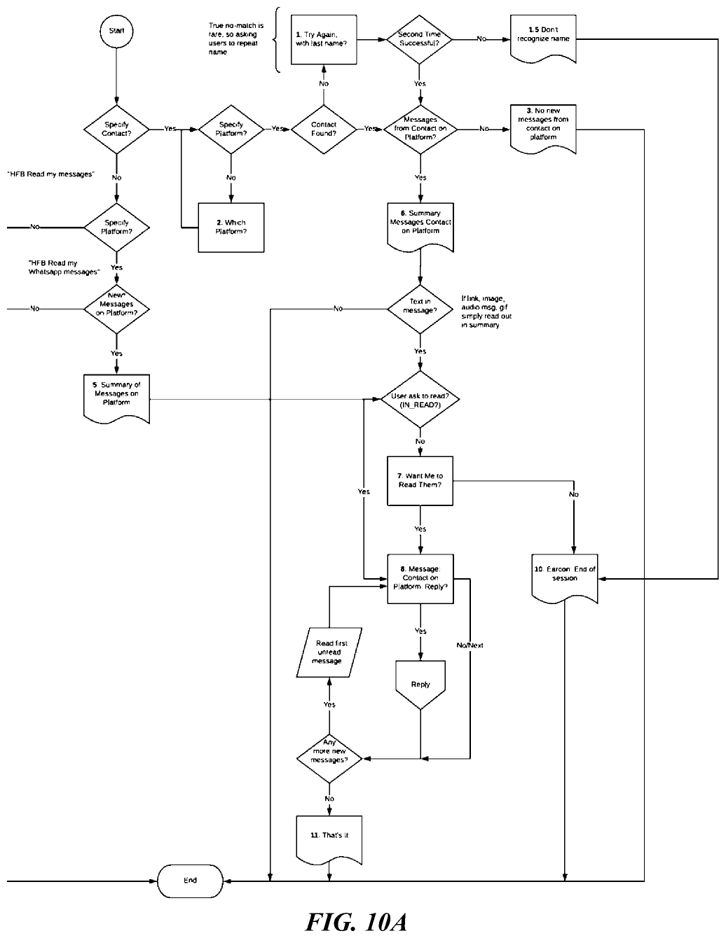

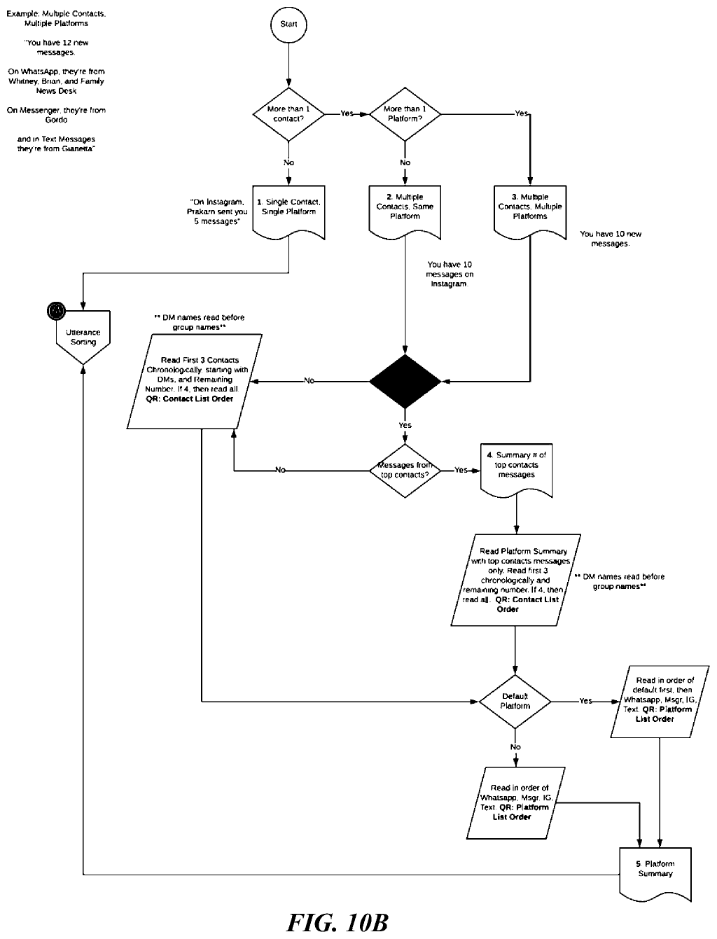

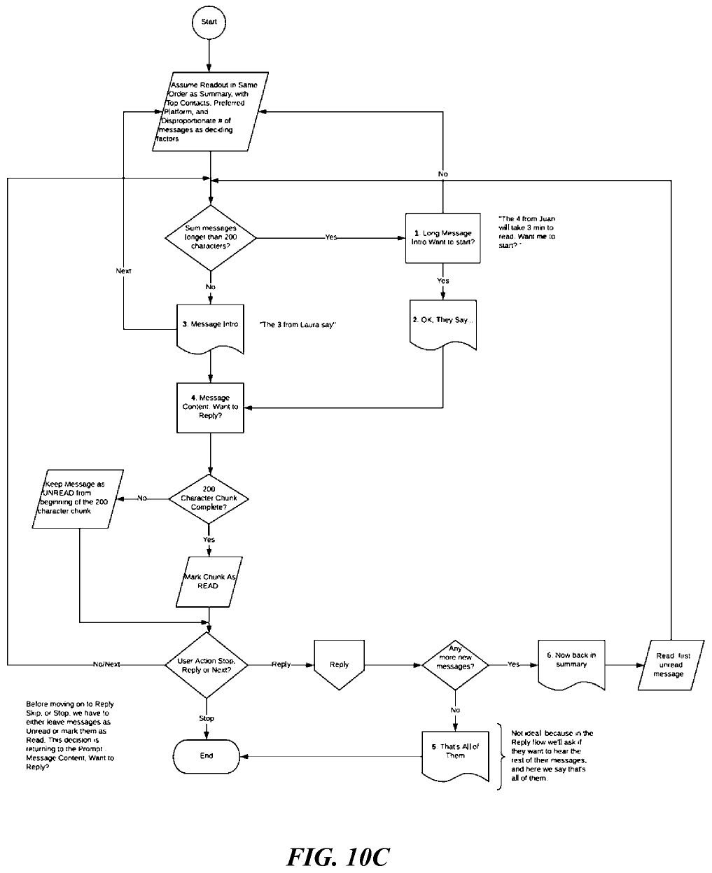

FIG. 10A illustrates an example framework in which an assistant system 140 may receive, from a client system associated with a user, a user request associated with one or more messages received by the user on one or more messaging platforms. The user request may be a voice-input request (i.e., an utterance) received from the user. The user request may then be processed by ASR 217 and NLU 218 of the client device and/or by ASR 208 and NLU 210 of the assistant system 140 before being sent to dialog arbitrator 216 in order to determine a user intent from the voice-input request. In particular embodiments, the processing of the user request may be performed on the client device when the user request is determined to contain privacy sensitive content (e.g., names of other users). In particular embodiments, the user intent may indicate that the user wishes to be informed of any new messages received on any platforms associated with the user. The user may do this by first activating the assistant system 140 and then vocalizing a request without specifying a particular platform or contact. For example, the user may say “Assistant, read my messages,” “Assistant, what are my new messages?”, or “Assistant, do I have any unread messages?” Alternatively, the user intent may indicate that the user wishes to be informed of messages from a specific platform, contact, groups, group name, time period, message priority, or any combination thereof. For example, the user may say “Assistant, did I get any messages from group chats last night on Social_Networking_App_3?”, “Assistant, can you give me a summary of my messages from 1:30 until now?”, “Assistant, can you tell me my most important messages?”, or “Assistant, tell me everything I've missed since 2:00.” In particular embodiments, the user intent may additionally indicate that the user would like the assistant system 140 to readout one or more of the user's messages. For example, the user may say “Assistant, read all of my new messages” or “Assistant, read my last message from Tony on Social_Networking_App_1.”

In particular embodiments, after the user intent is determined, dialog arbitrator 216 may request inbox snapshots for one or more platforms by transmitting an API call to the client device to fetch new messages stored on the client device. In particular embodiments, messages may be required to be fetched on-device due to privacy concerns (e.g., platform-specific privacy protocols, messages containing privacy-sensitive content). Responsive to the inbox snapshot request, the client device may transmit the requested inbox snapshots back to dialog arbitrator 216. In particular embodiments, the inbox snapshots may include textual message content and metadata for the message or media content associated with the message, but may exclude attachments, images, or other media content from the inbox snapshot.

FIG. 10B illustrates an example framework in which the assistant system 140 may generate an inbox summary comprising an indication of a total number of unread messages in the message inboxes of the one or more messaging platforms and, for each platform having one or more unread messages, an identification of one or more contacts that each sent an unread message to the user. To generate the inbox summary, dialog arbitrator 216 may process each received inbox snapshot to identify multiple message threads within the platform snapshot, extract information relevant to each identified thread (e.g., identity of a contact associated with the thread, number of messages from each contact), and identify a language template based on the determined user intent. The extracted information and identified template may then be sent to NLG 356 and TTS 238 of Response Execution module 232, which may populate the templates with the extracted information and generate the full inbox summary. Alternatively, dialog arbitrator 216 may instead send the extracted information and identified template to the client device, where it may be processed in a similar manner by the NLG and TTS 240 modules on the client device. Once the inbox summary is generated, it may then be sent to Render Output module 242, which may cause the inbox summary to be broadcast to the user as an audio output.

In particular embodiments, where the user request does not specify a particular platform or contact, the inbox summary may first indicate a total number of new messages, and then identify, for each platform, the contact(s) who sent the new messages. For example, the inbox summary may be “You have 12 new messages. On Social_Networking_App_1 they're from Laura and Juan. On Social_Networking_App_2, they're from Paula, Miguel, and Ioseba. On Social_Networking_App_3 they're from Gabrielle and Demetria.” In particular embodiments, where the user request specifies a particular platform, the inbox summary may indicate the total number of unread messages on that platform, and then identify the contact(s) who sent the new messages. For example, the inbox summary may be “On Social_Networking_App_1you have 4 new messages, they're from Paula, Miguel, and Ioseba.” In particular embodiments, where the user request specifies a particular contact, the inbox summary may indicate the total number of unread messages from that contact and identify the platform the contact sent the new messages on. For example, the inbox summary may be “You have three new messages from Sam on Social_Networking_App_1.” In particular embodiments, where a user request specifies a group messaging thread and/or where one or more new messages are in a group messaging thread, the inbox summary may be, for example, “You have three new messages from the group Friday Bowlers on Social_Networking_App_1.” In particular embodiments, where new messages on a particular platform are from a number of contacts exceeding a threshold number of contacts, the inbox summary may be, for example, “On Social_Networking_App_1you have 8 new messages, they're from Paula, Miguel, and Ioseba, and three others.” In particular embodiments, the assistant system 140 may filter out particular messages from being included in the inbox summary based on a value of the message. For example, the inbox summary may filter out low value content (e.g., advertisements, promotions, spam messages) and/or non-urgent messages (e.g., group chatter). In particular embodiments, the assistant system 140 may generate inbox summaries for messages that include non-Latin text or other non-textual content (e.g., contact names with foreign characters), which may be generated in accordance with U.S. Provisional Patent Application No. 63/151,027, filed 18 Feb. 2021, which is incorporated herein by reference.

In particular embodiments, dialog arbitrator 216 may disambiguate or determine a prioritization order where new messages may be on multiple platforms and/or received from multiple contacts. The inbox summary may prioritize multiple platforms based on the user's default platform (e.g., the user's primary messaging platform). Alternatively, the assistant system 140 may prompt the user to specify a specific platform to be summarized and/or read out. For example, the user request may be “Assistant, any new messages from Sam?”, to which the assistant system 140 may prompt the user to select a platform with “On Social_Networking_App_1 or Social_Networking_App_3?” In particular embodiments, where new messages on a particular platform are from multiple contacts, the inbox summary may prioritize contacts based on a type of connection between the user and the contact (e.g., a contact tagged as a close friend or favorite), an attribute of the new message(s) from the contact (e.g., a recency of the new message), and/or a volume of new messages from a particular contact (e.g., 100 new messages, 93 of which are from Bob).

FIG. 10C illustrates an example framework in which, after providing the inbox summary to the user as an audio output, if the determined user intent indicated that the user desired for the requested messages to be read out, the assistant system 140 may begin reading out the requested messages. In particular embodiments, after providing the inbox summary to the user as an audio output, if the determined user intent did not indicate whether the user desired for the requested messages to be read out, the assistant system 140 may prompt the user to indicate whether assistant system 140 should begin reading out the requested messages. For example, the assistant system 140 may ask “Want me to read them?” or “Want to hear them?” In particular embodiments, the assistant system 140 may improve the clarity and usability of the readout experience by including a time estimate in the user prompt. For example, the assistant system 140 may say “You have four new messages from Lamia and the group Winter Troopers. It'll take three minutes to catch up. Want to hear your messages?” In particular embodiments, the time estimate may be based on only the time to read out the message(s), or alternatively, the time estimate may be based on the time to read out the message(s) and for the user to reply to the message(s). In particular embodiments, because determining an exact estimate for the time to read out the message(s) may raise privacy concerns, the assistant system 140 may instead estimate the time to read out the message(s) in predetermined time intervals (e.g., 15 seconds).

After providing an inbox summary, the assistant system 140 may begin reading out the requested messages in a suitable manner. In particular embodiments, where a particular message or a group of messages (e.g., a group thread) being read out exceeds a threshold message length, the assistant system 140 may break up the message(s) into message “chunks” and may pause between each message chunk. After pausing or in lieu of pausing, the assistant system 140 may prompt the user to indicate whether assistant system 140 should continue reading out the remainder of the message(s). For example, assistant system 140 may read out a message and prompt as “Lamia sent: ‘Hey, just wanted to share an update on the project and how things went today while you were out. We're making good progress on the presentation but will need your help working on the layout and the graphics.’ Do you want to hear the rest?” Alternatively, when a particular message or a group of messages (e.g., a group thread) being read out exceeds a threshold message length, the assistant system 140 may instead generate and read out a summary of the message(s). In particular embodiments, the assistant system 140 may enable users to navigate within or between messages that are being read out. For example, users may use commands such as “Skip” and “Next” to move to the next message or message thread, “Stop” to exit the message readout experience, as well as commands to decrease or increase the speed at which the message(s) are read out. In particular embodiments, the assistant system 140 may inform the user of the available thread navigation commands at one or more points during the message readout experience.

In particular embodiments, during or after reading out an inbox summary or reading out message(s), the assistant system 140 may include one or more pivots associated with follow-up actions for the user to choose from. Pivots may include prompting the user to reply to individual messages in the inbox summary, repeat a message, pause or stop a message readout, dismiss or skip a message, mark a message as unread or save for later (which may be particularly helpful for messages containing an image or link), or request a message timestamp. For example, assistant system 140 may prompt the user with “Want to reply?” or “Do you want to hear more?” By providing pivots to the user, the assistant system 140 may give the user a clear indication that they are able to perform particular actions during the message readout experience. In particular embodiments, certain pivots may be tapered in subsequent prompts directed to the same pivot. For example, a first pivot may be “Do you want to reply?”, and a subsequent pivot may be shortened to just “Reply?” Tapering pivots over time may result in a more concise and efficient readout experience without diminishing the user's ability to understand or act on the reply pivot. In particular embodiments, between reading out messages from particular contacts and between reading out messages on different platforms, the assistant system 140 may include conversation markers to smoothly and naturally transition from readout of one platform to the next, and from one contact to the next. For example, after reading out a last message on a platform, the assistant system 140 may say “Ok. Moving on to [platform]” before starting to read out messages on the next platform. As another example, when reading out multiple messages from the same contact on the same platform, the assistant system 140 may begin the first message with “First” and begin the last message with “Lastly,” and then before beginning to read out messages from the next contact, assistant system 140 may say “Up next.” In particular embodiments, after all messages have been read out to the user, the assistant system 140 may include a conversation marker to indicate that the readout experience has concluded by saying, for example, “That's it for now. You're all caught up.” Alternatively, the assistant system 140 may indicate that the session has concluded with an audio earcon (i.e., a brief, distinctive sound).

In particular embodiments, after reading out a particular message or message chunk, the assistant system 140 may access the associated platform and mark the corresponding unread message as having been read by the user. In particular embodiments, if a message readout has been skipped by the user or if a message has been unread for more than a threshold period of time (e.g., 24 hours), the assistant system 140 may access the associated platform and mark the corresponding unread message as “Stale” (i.e., not to be surfaced in future inbox summaries).

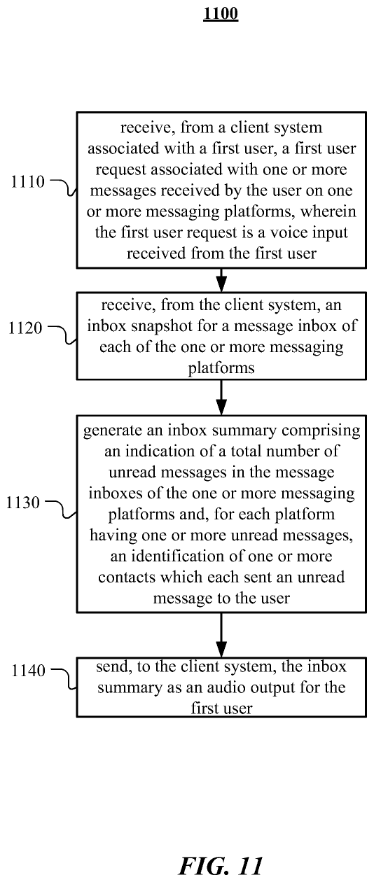

FIG. 11 illustrates an example method 1100 for providing users with a hands-free inbox management system across multiple messaging platforms. The method may begin at step 1110, where the assistant system 140 may receive, from a client system associated with a first user, a first user request associated with one or more messages received by the user on one or more messaging platforms, wherein the first user request is a voice input received from the first user. At step 1120, the assistant system 140 may receive, from the client system, an inbox snapshot for a message inbox of each of the one or more messaging platforms. At step 1130, the assistant system 140 may generate an inbox summary comprising an indication of a total number of unread messages in the message inboxes of the one or more messaging platforms and, for each platform having one or more unread messages, an identification of one or more contacts which each sent an unread message to the user. At step 1140, the assistant system 140 may send, to the client system, the inbox summary as an audio output for the first user. Particular embodiments may repeat one or more steps of the method of FIG. 11, where appropriate. Although this disclosure describes and illustrates particular steps of the method of FIG. 11 as occurring in a particular order, this disclosure contemplates any suitable steps of the method of FIG. 11 occurring in any suitable order. Moreover, although this disclosure describes and illustrates an example method for providing users with a hands-free inbox management system across multiple messaging platforms including the particular steps of the method of FIG. 11, this disclosure contemplates any suitable method for hands-free inbox management system across multiple messaging platforms including any suitable steps, which may include all, some, or none of the steps of the method of FIG. 11, where appropriate. Furthermore, although this disclosure describes and illustrates particular components, devices, or systems carrying out particular steps of the method of FIG. 11, this disclosure contemplates any suitable combination of any suitable components, devices, or systems carrying out any suitable steps of the method of FIG. 11.

### Assistant Proactive Account Warnings

In particular embodiments, the assistant system 140 may monitor and proactively inform users when their accounts or information have been compromised without being explicitly and affirmatively provided with personal data by users. Instead, the assistant system 140 may proactively obtain a user's personal data by utilizing its existing access to users' personal information (e.g., biographical information, social media account information, email account information, email inbox content, etc.), by passively monitoring user inputs and interactions with the assistant system 140 (e.g., bank account credentials provided to the assistant system 140 in response to a user request to check their balance), and/or by accessing data stored in the user memory of the assistant system 140 (e.g., previously received and stored bank account credentials recorded for subsequent use at the user's request).

In particular embodiments, once the assistant system 140 has obtained a user's personal data, the assistant system 140 may scan and monitor the internet to detect online data breaches (either by the assistant system 140 or by integrating a third-party monitoring service) and determine whether any of the user's personal data has been compromised. In particular embodiments, the assistant system 140 may initiate active monitoring and searching for compromised personal data in response to a determination that a new breach data dump has been identified. New breach data dumps may be identified directly by the assistant system 140, indirectly by a third-party monitoring service, based on public announcements of a new data breach (e.g., a press release or news article indicating that a particular platform has been hacked), or in any other suitable manner.

In particular embodiments, upon detection of a data breach which potentially compromises a user's personal data, the assistant system 140 may notify the user of the breach and provide recommendations and/or instructions for corrective actions available to the user (e.g., by directing the user to set a new and more difficult password). In particular embodiments, at any point prior to, during, or after any of the disclosed monitoring and notification functionality is implemented, the assistant system 140 may provide the user with solicited or unsolicited information about the monitoring and notification functionality to educate the user about data security and how the user may utilize or personalize how this monitoring and notification functionality may be implemented.

In particular embodiments, the monitoring and notification techniques disclosed herein may be automatically implemented by the assistant system 140 for all users and/or all user accounts on a particular platform. In this case, users may be provided with the ability to opt-out of having their personal data monitored by the assistant system 140. Alternatively, these monitoring and notification techniques may be an optional functionality that is only implemented when a user opts-in to the monitoring service, which may be the default implementation in order to protect user privacy. In particular embodiments, these monitoring and notification techniques may be selectively applied or prioritized for specific user accounts based on any suitable factors (e.g., activity levels, prior incidents of compromised accounts).

In particular embodiments, the assistant system 140 may personalize various aspects of the monitoring and notification techniques disclosed herein. The assistant system 140 may personalize levels of risk assessment and risk tolerance for a specific user or user account. For example, the assistant system 140 may personalize the types of breaches being monitored (e.g., only monitor publicized data breaches) and/or the severity of breaches that will trigger notifications (e.g., only detect and report particularly egregious data dumps). The assistant system 140 may also personalize aspects of the notifications provided to specific users or for specific user accounts. For example, the assistant system 140 may personalize the frequency, timing, and/or aggregation of breach notifications (e.g., daily, weekly, outside of work hours), the notification delivery methods (e.g., email, SMS message, push notification), the notification content (e.g., breach details, personal data compromised), and/or the corrective actions available to the user (e.g., whether recommendations or instructions for corrective action are provided in the notification).

In particular embodiments, these personalizations may be predetermined or set by the user in any suitable manner. Additionally and/or alternatively, these personalizations may be influenced or determined based on the monitoring history and/or prior user behavior. For example, if a user has been previously notified three times that their login credentials for a particular account may have been compromised, but the user has indicated each time that their account has not actually been compromised, the assistant system 140 may determine that the user should be associated with a higher risk tolerance and reduce the frequency of notifications provided to that user in the future. This disclosure also contemplates implementing machine learning techniques to improve to improve and modify these personalizations for specific users.

In particular embodiments, the assistant system 140 may utilize multiple alert levels when monitoring and notifying users of potential personal data breaches. For example, a high alert level may be associated with a user's personal data being detected in a data dump associated with a breach. In this case, the assistant system 140 may have a high level of confidence that the user's personal data has been compromised, which may be indicated in the notification provided to the user. In contrast, a lower alert level may be associated with a user's personal data being detected outside of a serious data breach (e.g., on another platform). In this case, the assistant system 140 may not have a high level of certainty that the user's personal data has been compromised, and the notification provided to the user may just indicate that the user's personal data has been detected.

In particular embodiments, the assistant system 140 may monitor, detect, and notify users of alternative forms of misuse of personal user data and/or monitor, detect, and notify users for specific types of data which may not be readily accessible to existing monitoring solutions. For example, the assistant system 140 may be associated with a particular social media platform and may have access to personal user data specific to the social media platform. In this example, a user's original profile page on a social media platform may include the user's name, profile photo, and various other personal user data. The assistant system 140 may monitor the internet and detect that the user's personal data appears on a new profile page created on another platform. The assistant system 140 may then provide the user with a notification that someone may have stolen the user's personal information stolen to create a spoof account with a fake profile page that falsely appears to be associated with the user.

This example also illustrates the need for multiple alert levels as disclosed above. As discussed, a high alert level may be associated with a user's personal data being detected in a data dump associated with a breach such that the assistant system 140 may have a high level of confidence that the user's personal data has been compromised, which may be indicated in the notification provided to the user. In contrast, a lower alert level may be associated with a user's personal data being detected on another platform such that the assistant system 140 may not have a high level of certainty that the user's personal data has been compromised, and the notification provided to the user may simply indicate that the user's personal data has been detected on another platform. Continuing with the above example, when the user's name and profile photo are detected on the new profile page on another platform, the assistant system 140 may not be able to determine with a high measure of confidence whether the new profile page was actually created by the user, or whether someone other than the user created the new profile page by stealing the user's name and profile photo from the user's original profile page. In this example, to avoid accidentally flagging this as a false positive (in case the user legitimately created the new profile page), the assistant system 140 may simply prompt the user to confirm whether they created the new profile page or whether someone has stolen their personal data.

As another example, the assistant system 140 may have access to a user's email or message inbox and may identify one or more emails or messages that include undesirable content (e.g., promotions, spam) or malicious content (e.g., viruses, phishing links) and/or are determined to be associated with suspicious or malicious entities or websites. The assistant system 140 may then notify the user of the identified emails or messages proactively (e.g., by a push notification) or reactively (e.g., during an inbox summarization requested by the user).

The above monitoring and notification implementations could be personalized for specific users in a similar manner as described above. The above monitoring and notification implementations could also be implemented in a multi-device and/or multimodal environment. For example, for a user with a smartphone who is wearing augmented reality (AR) glasses, the assistant system 140 may be associated with both devices, and in response to detecting that the user's phone is receiving an incoming phone call from a suspicious phone number, the assistant system 140 may provide a visual indication to the user via the AR glasses that the incoming call may be from an entity not known to the user.

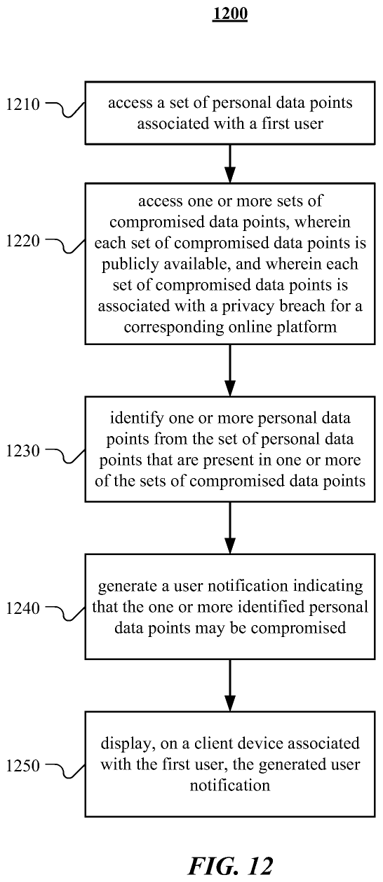

FIG. 12 illustrates an example method 1200 for proactively informing users when their accounts or information has been compromised. The method may begin at step 1210, where the assistant system 140 may access a set of personal data points associated with a first user. At step 1220, the assistant system 140 may access one or more sets of compromised data points, wherein each set of compromised data points is publicly available, and wherein each set of compromised data points is associated with a privacy breach for a corresponding online platform. At step 1230, the assistant system 140 may identify one or more personal data points from the set of personal data points that are present in one or more of the sets of compromised data points. At step 1240, the assistant system 140 may generate a user notification indicating that the one or more identified personal data points may be compromised. At step 1250, the assistant system 140 may display, on a client device associated with the first user, the generated user notification. Particular embodiments may repeat one or more steps of the method of FIG. 12, where appropriate. Although this disclosure describes and illustrates particular steps of the method of FIG. 12 as occurring in a particular order, this disclosure contemplates any suitable steps of the method of FIG. 12 occurring in any suitable order. Moreover, although this disclosure describes and illustrates an example method for proactively informing users when their accounts or information has been compromised including the particular steps of the method of FIG. 12, this disclosure contemplates any suitable method for proactively informing users when their accounts or information has been compromised including any suitable steps, which may include all, some, or none of the steps of the method of FIG. 12, where appropriate. Furthermore, although this disclosure describes and illustrates particular components, devices, or systems carrying out particular steps of the method of FIG. 12, this disclosure contemplates any suitable combination of any suitable components, devices, or systems carrying out any suitable steps of the method of FIG. 12.

### Adding Chit-Chat to Enhance Task-Oriented Dialogs

In particular embodiments, the assistant system 140 may make the interactions between users and the assistant system 140 more engaging and interesting by using a chit-chat bot to supplement responses from the assistant system 140. When receiving a user input, the assistant system 140 may feed the user input and dialog context to two bots including a task bot and a chit-chat bot. The task bot may be the standard assistant xbot that responds to task requests and generates normal task responses. The chit-chat bot may generate personalized chit-chat responses based on the dialog context (e.g., knowledge about the user). Additionally, the chit-chat bot may also consider other information such as user context, multimodal context, or other auxiliary information when generating the chit-chat responses. Each bot may generate one or more output strings. The output strings from each bot may be fed to a composition model including an arranger and a rewriter. The arranger may take the outputs from the bots and decide how they should be arranged (e.g., [task response, chit-chat response] versus [chit-chat response, task response]). The rewriter may take the outputs of the bots and synthesize them and generate a completely new natural language output. To train the compositional model, the assistant system 140 may rely on a dataset collected by an AI and human collaborative approach, in which the AI generates chit-chat candidates and humans rank these candidates. Although this disclosure describes adding chit-chat by particular systems in a particular manner, this disclosure contemplates adding chit-chat by any suitable system in any suitable manner.

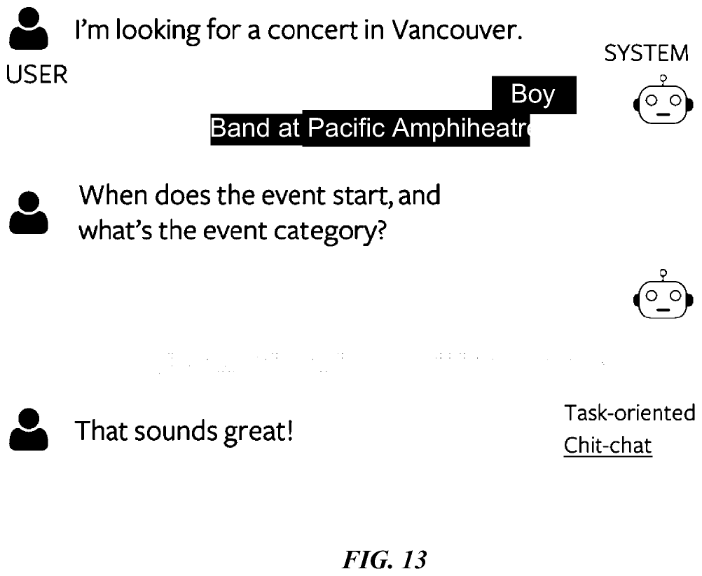

FIG. 13 illustrates an example interaction between a user and the assistant system 140 with chit-chat abilities. The user may say “I'm looking for a concert in Vancouver.” The assistant system 140 may reply “I found an event for the Boy Band at Pacific Amphitheatre.” The user may ask “when does the event start, and what's the event category?” The assistant system 140 may reply “it's a Pop event starting at 6:30 pm.” In addition, the assistant system 140 may generate a chit-chat response as “it's a great way to kick off the summer!” The user may then reply “that sounds great!”

The existing dialogue corpora and models may be designed under two disjoint motives: while task-oriented systems focus on achieving functional goals (e.g., booking hotels), open-domain chat-bots aim at making socially engaging conversations. The embodiments disclosed herein may integrate both types of systems by Adding Chit-Chats to Enhance Task-Oriented dialogues (ACCENTOR), with the goal of making virtual assistant conversations more engaging and interactive. Specifically, the embodiments disclosed herein disclose a flexible approach for generating diverse chit-chat responses to augment task-oriented dialogues with minimal annotation effort. The embodiments disclosed herein then present our new chit-chat annotations to 23.8K dialogues from the popular task-oriented datasets (Schema-Guided Dialogue and MultiWOZ 2.1) and demonstrate their advantage over the originals via human evaluation. Lastly, the embodiments disclosed herein propose three new models for ACCENTOR explicitly trained to predict user goals and to generate contextually relevant chit-chat responses. Automatic and human evaluations show that, compared with the state-of-the-art task-oriented baseline, our models may code-switch between task and chit-chat to be more engaging, interesting, knowledgeable, and humanlike, while maintaining competitive task performance.

TABLE 1
A sample task-oriented dialogue snippet augmented
by a chit-chat (U: user, A: assistant).

| | |
|---|---|
| U: | I'm looking to go to a concert in Vancouver, BC. |
| A: | I found an event for the Boy Band at Pacific Amphitheatre. |
| U: | When does the event start, and what's the event category? |
| A: | It's a Pop event starting at 6:30 pm. It's a great way to |
| | kick off the summer. |
| U: | That sounds great. |
| | . . . |

With modeling innovations, increasing computing power, and a growing number of datasets, recent years have witnessed significant improvements in the performance of task-oriented dialogue systems and chit-chat systems (Adiwardana et al., 2020; Roller et al., 2020; Hosseini-Asl et al., 2020; Peng et al., 2020a). Most works on dialogue systems may focus on a particular type of dialogue system. Works on task-oriented dialogue systems may aim to track user goals with higher accuracy to better achieve functional goals (Rastogi et al., 2020). However, they may not pay explicit attention to user experience, such as making the conversation more engaging, which, on the contrary, is usually the target of the works on chit-chat systems (Li et al., 2019). The embodiments disclosed herein propose to integrate both types of systems by Adding Chit-Chats to Enhance Task-Oriented dialogues (ACCENTOR), aiming to have a virtual assistant capable of not only performing various complex tasks such as checking the weather, booking hotels, and finding restaurants but also involving casual and contextually relevant chit-chats. The embodiments disclosed herein hypothesize that the added chitchats may make the assistant system 140 sound more social, personable, and engaging, without being misleading or inappropriate, compared with the existing task-oriented dialogue systems.

To prove the feasibility of ACCENTOR and gather supervision data for follow-up research, the embodiments disclosed herein propose a data construction approach, which may effectively add suitable chit-chats to the beginning or end of system responses in existing task-oriented dialogue datasets. Specifically, the assistant system 140 may first generate chit-chat candidates for augmentation using off-the-shelf pre-trained language models and open-domain chatbots. Next, the assistant system 140 may automatically filter out candidates that are unlikely of good quality by a filter model. Finally, human annotators may label each of the remaining candidates as good or bad, with justifications. The embodiments disclosed herein augment Schema-Guided Dialogue (SGD) (Rastogi et al., 2020) and MultiWOZ 2.1 (Eric et al., 2020) using the proposed approach (Table 1 shows an example). The embodiments disclosed herein employ ACUTE-Eval (Li et al., 2019) to compare the augmented versions and the originals over four axes: engagingness, interestingness, knowledge, and humanness. Augmented dialogues are consistently more preferred by human judges across the four axes for both datasets.

In addition, the embodiments disclosed herein propose and evaluate three models for ACCENTOR, including an end-to-end model and two code-switcher models built upon off-the-shelf task-oriented and chit-chat systems. Compared with the baseline model trained with the original un-augmented data, our models trained with the augmented version may generate significantly higher-rated responses in terms of human preference while maintaining competitive task performance in goal tracking accuracy and action decision F 1.

The main contributions of the embodiments disclosed herein may be as follows: we propose (1) a data augmentation approach for generating diverse chit-chat supervision data for task-oriented dialogues, leveraging pre-trained generative models and a custom filter model to minimize human annotation effort, (2) new versions of the popular task-oriented datasets, SGD and MultiWOZ 2.1, with the newly added chit-chat annotations to 23.8K dialogues, and (3) three integrated chit-chat and task-oriented neural dialogue models for the above, substantially outperforming the state-of-the-art approach on human evaluation.

In particular embodiments, the following approach may be used to gather supervision data for ACCENTOR. Our approach may need minimal annotation effort to augment suitable and diverse chit-chat add-ons that are not available in existing task-oriented datasets. We primarily report results based on dialogues from the SGD dataset in the embodiments disclosed herein, because it is the largest task-oriented dialogue dataset and generally cleaner compared with most other task-oriented dialogue datasets. However, our approach may be flexible and thus not limited to dialogues from a particular task-oriented dataset.

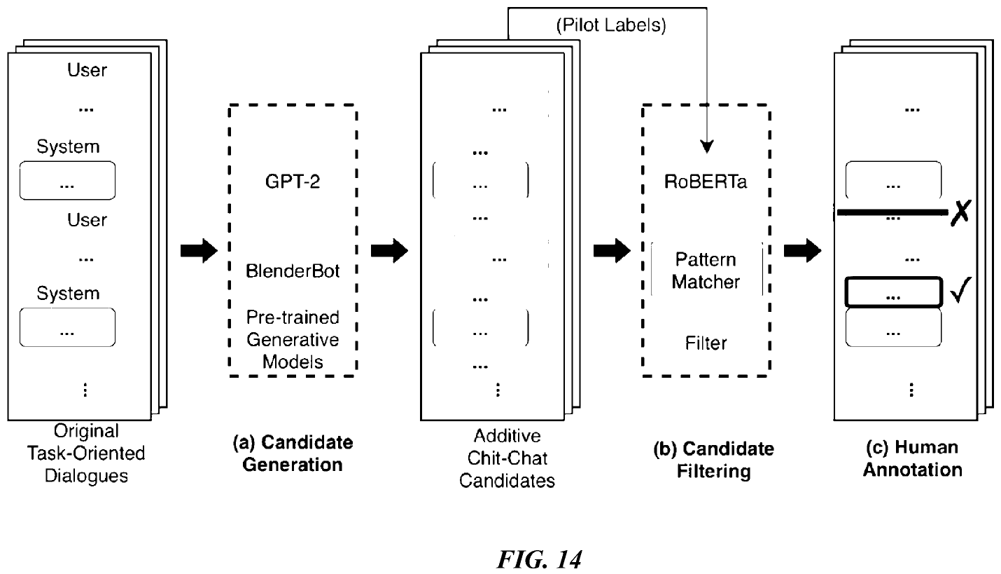

FIG. 14 illustrates an example overview of the data construction. The data construction may comprising: (a) generating diverse free-form chit-chat candidates using the state-of-the-art pre-trained generative models to augment original task-oriented dialogues, and (b) filtering out bad candidates using the custom filter to minimize annotation effort, and (c) annotating contextually relevant chit-chat augmentation with justifications by crowd workers.

Given a task-oriented dialogue D={u₁, s₁, u₂, s₂, . . . , uₙ, sₙ}, where u_{1 . . . n} and s_{1 . . . n} represent user turns and system turns, respectively, we generate chit-chat candidates for augmenting sᵢ in two ways: (i) pass u₁, s₁, . . . , uᵢ, sᵢ to an off-the-shelf pre-trained model (a language model or a chit-chat chatbot) and let the model add tokens to the end of sᵢ; (ii) pass u₁, s₁, . . . , uᵢ to a pre-trained model and let the model generate a turn. We regard the output of (i) and (ii) as a chit-chat candidate to be appended and prepended to sᵢ, respectively. If a chit-chat candidate consists of multiple sentences, we also regard each individual sentence as a chit-chat candidate. We run differently sized GPT-2 (Radford et al., 2019) and BlenderBot (Roller et al., 2020) with various decoding parameters as the pre-trained model and generate an average of 175.5 candidates for each of the dialogue from the SGD dataset.

We examine the quality of the model-generated candidates by performing a pilot annotation ourselves on a small proportion of the candidates. The annotation results show that only about 1/10 of the candidates may be suitable. Therefore, instead of directly sending the candidates to crowd workers for annotation, we build a filter model to automatically filter out candidates that are unlikely of good quality first to reduce potential annotation workload.

The filter may be a hybrid model that consists of a RoBERTa-based binary classifier (Liu et al., 2019) and a rule-based ranker. The classifier may take as input an augmented dialogue, in which we explicitly surround the added chit-chat candidate with a pair of special tokens to help the model locate the candidate. We train the classifier with 1.7K candidates that are labeled as good/bad from the pilot annotation. The rule-based ranker may rank each candidate based on (i) the posterior probability output by the binary classifier, (ii) whether the candidate matches a list of bad patterns (e.g., containing an URL), (iii) the frequency of appearances of the candidate among all generated candidates, (iv) the similarity to the other candidates for the dialogue, and (v) the similarity to the system response being augmented. While (i) and (ii) directly help evaluate the quality of the candidate, (iii), (iv), and (v) additionally may help create more variety (e.g., punishing high-frequency candidates such as “You're welcome”). We keep the top ten candidates for each of the dialogue.

We ask annotators (crowd workers) to label each of the remaining candidates as good or bad. Additionally, to guide the annotation process, improve the potential quality, and facilitate the candidate distribution analysis, we also ask annotators to choose from four justifications that we come up with based on our pilot annotation experience to support their annotations. Annotators can choose one, both, or neither of the following justifications for a bad candidate:
Inappropriate: The candidate does not fit into the context (e.g., repeating, unnatural), or it contradicts with the context or the role of the assistant (Table 2). Most typical bad cases such as improper switching, providing opinions or comments that are incompatible with the context, and misusing verbal routine fall into this category.
Misleading: The candidate provides additional information that is false or cannot be verified immediately. For example, the underlined candidate in the two-turn dialogue “U: I want to book a hotel room in San Diego with a check in on Thursday. A: There are over 10 hotels in San Diego. I would stay at Acme Midtown if I were you.” Should be marked as misleading because “Acme Midtown” is a newly introduced information, which the annotator would have to look up to verify that a hotel by this name exists in San Diego, even though the information may be true.

Annotators can choose one, both, or neither of the following justifications for a good candidate:
Social: The candidate keeps the conversation flowing smoothly by appropriately switching to relevant topics, asking casual follow up questions, or engaging in social pleasantries.
Useful: The candidate enhances the conversation by appropriately offering opinions, commentaries, or pertinent and truthful information. Truthfulness should be established by conversational context or real-world knowledge. To reduce annotation workload, if annotators have to use external resources (e.g., search engines, maps) to verify information, they are instructed to label the candidate as misleading instead.

We instruct annotators to evaluate each candidate independently as if it were the only augmentation for its associated dialogue.

The Fleiss' Kappa among crowd workers is around 0.52. We view the agreement score as reasonable since whether an added chit-chat candidate leads to improved quality of a conversation can be highly subjective in many scenarios. We denote our augmented version of the SGD dataset as ACCENTOR-SGD and summarize the statistics in Table 3. We observe that the four provided justification categories provide adequate coverage of the justifications for most annotations. 41.4% of the candidates are good, showing the effectiveness of candidate filtering.

TABLE 2
The role of the virtual assistant and its appropriate/inappropriate behaviors with examples

| | | | Inappropriate | |
|---|---|---|---|---|
| | Appropriate Behaviors | Examples | Behaviors | Examples |
| Opinions | Express general opinions | “I love | Express strong | “I love you.” |
| | about generic, impersonal, | penguins.” | personal | “The President |
| | or non-sensitive topics. | “There's a lot | opinions, or | is an idiot.” |
| | | of fun stuff to | opinions on | |
| | | do.” | sensitive topics. | |
| Preferences | Express preferences when | “Their latest | Express strong | “I hated it, but |
| | making impersonal, or non- | album wasn't | dispreferences or | you might like it.” |
| | sensitive recommendations. | as good.” | preferences on | “Invite her! I |
| | | “Their food is | personal or | like her better.” |
| | | good.” | sensitive subject | |
| | | “They say it | Behave as | “I can drive you |
| Physical | Use epistemic verbs to | tastes like | though it could | there.” |
| Actions | express uncertainty or | chicken.” | act physically, or | “I haven't |
| | opinions, or refer through | “I hear it's | perform tasks | arrived there yet.” |
| | hearsay to actions that it | beautiful.” | outside of its | |
| | may not perform. | | role. | |
| Experiences | Refer to others' experiences | “That sounds | Pretend to | “We didn't have |
| | or personify experiences it | like a great | experiences that | that when I was a |
| | is capable of (e.g., reading) | trip!” | it is incapable of. | kid.” |
| | | “I enjoyed | | “My roommate |
| | | reading that | | used to eat there a |
| | | novel.” | | lot.” |

Who is the virtual assistant? This digital assistant is more than just a bot that spits out facts. It has access to a wide range of information which can express not only as factual commentaries but also as opinions and preferences. However, it is not a person and should not pretend to have real experiences or be capable of physical actions. It should be personable and person-like, without appearing counterfeit.

TABLE 3
Statistics of annotated chit-chat candidates in ACCENTOR -SGD

| Metric | Value | |
|---|---|---|
| # of candidates | 228,250 | |
| # of unique candidates | 68,406 | |
| vocabulary size | 10,005 | |
| average length (in tokens) | 8.7 | |
| # of good candidates (%) | 94,600 | (41.4) |
| ⋄social | 86,324 | (37.8) |
| ⋄useful | 7,681 | (3.4) |
| ⋄social & useful | 577 | (0.3) |
| ⋄other (good) | 18 | (0.0) |
| # of bad candidates (%) | 133,650 | (58.6) |
| ⋄inappropriate | 127,648 | (55.9) |
| ⋄misleading | 5,800 | (2.5) |
| ⋄inappropriate & misleading | 164 | (0.1) |
| ⋄other (bad) | 38 | (0.0) |

Since oracle information (i.e., oracle belief states and oracle action decisions) may be not available in practical use and the SGD dataset may not have the associated database (i.e., a table of possible entities) released, we focus on exploring the end-to-end setting in which we generate delexicalized task-oriented responses without using oracle information and database search results following Hosseini-Asl et al. (2020). Given dialogue history (i.e., previous turns) as context, the goal of the model for each system turn is to accurately generate belief states (i.e., a list of (domain, slot, value) triplets), action decisions (i.e., a list of (domain, action_type, slot) triplets), and a corresponding system response that is functionally accurate and socially engaging.

SimpleTOD. We re-implement Simple-TOD (Hosseini-Asl et al., 2020) as our baseline model, which is a state-of-the-art model in the end-to-end setting we explore. It is a causal language model that models the joint probability over the concatenation of dialogue history Hₜ, belief states Bₜ, action decisions Aₜ, and a task-oriented response Tₜ for each system turn t. During inference, the model takes as input Hₜ and generates Bₜ, Aₜ, and Tₜ.

SimpleTOD+. We extend SimpleTOD by introducing to the construction of input sequences a special new dialogue action chit-chat and good chit-chat candidates during training. Specifically, let Cₜ⁺ denote the set of good candidates for system turn t. If Cₜ⁺ is empty, we construct the same training sequence as SimpleTOD. Otherwise, for each Cₜ∈Cₜ⁺ that is labeled as a candidate to be prepended (resp. appended) to the turn, we use the concatenation of Hₜ, Bₜ, [chit-chat], Aₜ, Cₜ, and Tₜ (resp. Hₜ, Bₜ, Aₜ, [chit-chat], Tₜ, and Cₜ) as a training sequence.

Arranger. This model may arrange the output of an off-the-shelf task-oriented dialogue model and an off-the-shelf chit-chat model without intervening in the task. It may directly output the belief states and action decisions generated by the task-oriented model without modification. To generate a response for each system turn t, this model may take as input (i) dialogue history Hₜ, (ii) a chit-chat response Cₜ generated by the chit-chat model based on Hₜ, and (iii) a task-oriented response Tₜ generated by the task-oriented dialogue model based on Hₜ. The model may choose one of the followings as the response: Cₜ followed by Tₜ, Tₜ followed by Cₜ, and Tₜ only. Specifically, the model may encode the concatenation of Hₜ and each of these three responses by a RoBERTa encoder (Liu et al., 2019) and pass the resulting representations through a linear plus softmax layer to make the choice. To train the model, we form training instances by regarding each chit-chat candidate for turn t from the training set of ACCENTOR-SGD as Cₜ and the ground-truth task-oriented response as Tₜ and setting the target choice based on the label (i.e., good/bad) and position (i.e., beginning/end of the response) of the candidate.

Rewriter. This model may rewrite the output of an off-the-shelf task-oriented dialogue model and an off-the-shelf chit-chat model. It may directly output the task-oriented model's belief states without modification and generates action decisions and a system response by a causal language model. The causal language model may differ from Simple-TOD+ in that it has two additional components Tₜ and Cₜ added between Hₜ and Bₜ in each training sequence, where we form Tₜ and Cₜ in the same way as we do for Arranger. During inference, it may take as input Hₜ, Tₜ output by the task-oriented dialogue model, Cₜ output by the chit-chat model, and Bₜ output by the task-oriented dialogue model, and generate action decisions and system response. Note that since 25.4% of the annotated system turns in the training set of ACCENTOR-SGD have both good and bad chit-chat candidates, [symbol] ₜ⁺ can be non-empty when Cₜ is a bad candidate, which enables the model to potentially generate a suitable chit-chat augmented response even if the output of the off-the-shelf chit-chat model is not good.

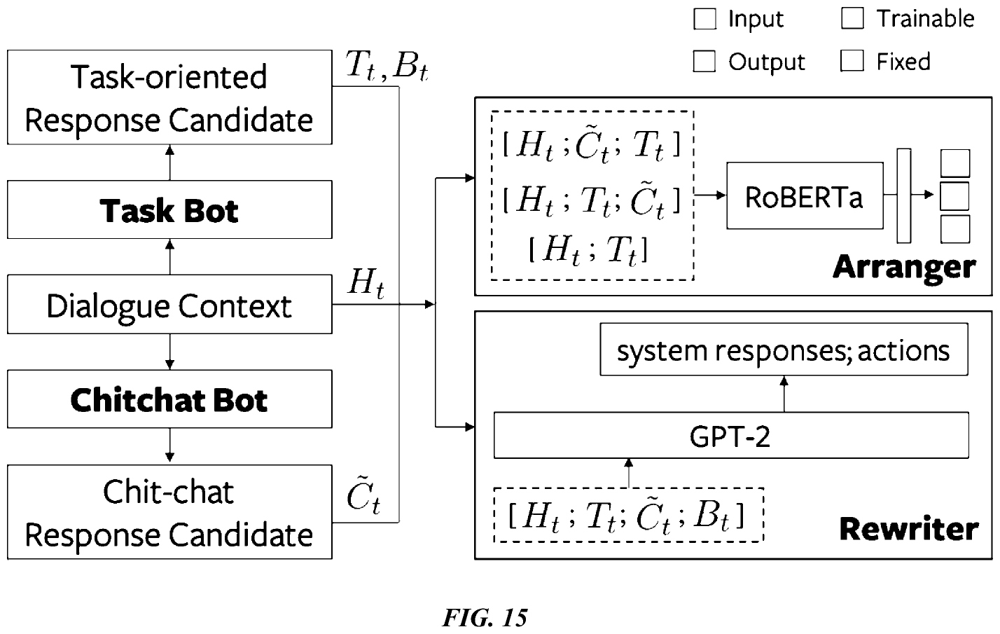

FIG. 15 illustrates an example workflow diagram for generating responses with chit-chat abilities. As indicated in FIG. 15, the dialogue context may be provided to both the task bot and the chit-chat bot. The task bot may generate task-oriented response candidates whereas the chi-chat bot may generate chit-chat response candidates. Additionally, the chit-chat bot may also consider other information such as user context, multimodal context, or other auxiliary information when generating the chit-chat response candidates. The task-oriented response candidates, dialogue context, and chit-chat response candidates may be all fed into a compositional model, which comprises the arranger and the rewriter. The arranger may arrange the sequence of the inputs and the rewriter may generate completely new responses from the inputs using different language models.

For all causal language models, we use the 12-layer GPT-2 (117M parameters) as the pre-trained language model (Radford et al., 2019) and fine-tune for ten epochs. We set the batch size to 36 and the learning rate to 1×10⁻³. We employ the SimpleTOD baseline as the off-the-shelf task-oriented dialogue model in Arranger and Rewriter. We fine-tune a 90M parameter model (Shuster et al., 2020) on each of the good chit-chat candidates with the associated dialogue history as the context from the training set of ACCENTOR-SGD following hyperparameters employed by Roller et al. (2020) and employ the resulting model as the off-the-shelf chit-chat model in Arranger and Rewriter. We use RoBERTa_{BASE} (Liu et al., 2019) as the pre-trained language model for Arranger and fine-tune for three epochs with a learning rate of 2×10⁻⁵ and a batch size of 24.

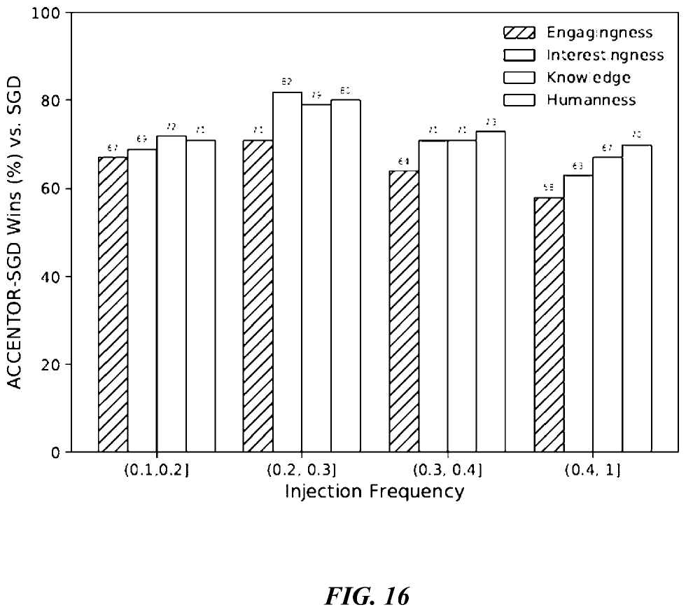

FIG. 16 illustrates example comparisons between SGD and ACCENTOR-SGD with different injection frequencies at the dataset level using ACUTE-Eval.

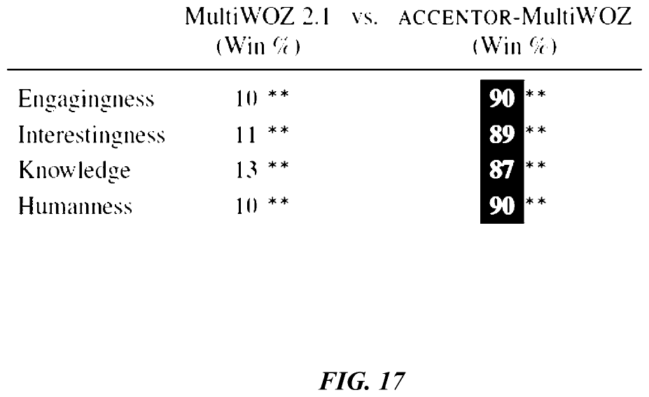

FIG. 17 illustrates example comparisons between MultiWOZ 2.1 and ACCENTOR-MultiWOZ at the dataset level using ACUTE-Eval (**: p-value<0:005).

TABLE 4
Automatic evaluation results on the test set of ACCENTOR-SGD.

| | Joint GA | | Avg GA | | Act Slot F1 | | BLEU-O | | BLEU-A | |
|---|---|---|---|---|---|---|---|---|---|---|
| | All | Seen | All | Seen | All | Seen | All | Seen | All | Seen |
| SimpleTOD | 29.4 | 79.0 | 46.9 | 90.3 | 61.7 | 88.9 | 12.3 | 17.0 | 8.0 | 9.9 |
| SimpleTOD+ | 29.3 | 77.4 | 47.5 | 90.0 | 61.5 | 88.1 | 11.2 | 15.3 | 10.8 | 12.8 |
| Arranger | 29.4 | 79.0 | 46.9 | 90.3 | 61.7 | 88.9 | 9.6 | 13.5 | 12.2 | 14.4 |
| Rewriter | 29.4 | 79.0 | 46.9 | 90.3 | 60.8 | 86.6 | 10.4 | 14.5 | 11.3 | 13.3 |

ACCENTOR-SGD. We first evaluate ACCENTOR at the dataset level, aiming to answer two questions: Q1. Are task-oriented dialogues augmented with good chit-chats more preferred by human judges than the un-augmented? Q2. Does the answer to Q1 depend on how frequently we augment system responses with chit-chats? To answer these questions, we randomly sample 100 dialogues from ACCENTOR-SGD, each having at least 8 turns and enough candidates labeled as good for augmenting over 40% of system responses so that we can compare the same task-oriented dialogue with different chit-chat injection frequencies that fall into each of the following four intervals: (0.1, 0.2), (0.2, 0.3), (0.3, 0.4), and (0.4, 1). Particularly, for the last interval, we augment all system responses that have chit-chat candidates labeled as good, while for the first three intervals, we only augment a randomly selected fraction to fit the interval. We employ ACUTE-Eval (Li et al., 2019) for evaluation, whereby we ask human evaluators to make pairwise comparisons of complete dialogues over four axes below.
Engaging: Who would you prefer to talk to? Which version is more likely to hold your attention and make you want to hear more?
Interesting: Who would you say is more interesting? Which version arouses your curiosity or tells you something new or useful?
Humanlike: Who would you say sounds more human? Which version is more natural and personable?
Knowledgeable: Who would you say is more knowledgeable? Which version seems more well informed and confident in the information?

As shown in FIG. 16, the chit-chat augmented dialogues from ACCENTOR-SGD are more preferred by human judges than the originals over all ACUTE-Eval metrics, regardless of the injection frequency (all p-values<0.05). Among different injection frequency ranges, [0.2, 0.3] is the best. We offer three hypotheses to explain this finding: (i) [0.2, 0.3] best balances being engaging and not too talkative. (ii) There are inevitable annotation errors, and scenarios where whether a candidate is good or bad is subjective. A higher injection frequency means a higher chance of being affected by these factors. (iii) Since candidates are labeled independently, inter-candidate incompatibility may arise (e.g., expressing contradicted preferences), especially when we have a high injection frequency.

ACCENTOR-MultiWOZ. To investigate the flexibility of our data construction approach, we augment about 1K randomly sampled dialogues from another task-oriented dataset, MultiWOZ 2.1 (Eric et al., 2020). Crowd workers label 30.0% of the candidates as good, which is lower compared with ACCENTOR-SGD (41.4% in Table 3). We attribute the difference to (i) the performance downgrade of the filter model since we do not re-train the model for MultiWOZ 2.1, and (ii) a higher chance of a chit-chat augmented response being too verbose to be good since the average number of tokens per system turn in MultiWOZ 2.1 is larger than that of SGD (17.3 vs. 13.1). Nevertheless, the augmented version (denoted as ACCENTOR-MultiWOZ) is significantly more preferred than the original, as shown in FIG. 17, where we randomly sample 100 dialogues from ACCENTOR-MultiWOZ, augment all of their system responses that have chit-chat candidates labeled as good, and compare these augmented dialogues with the corresponding original dialogues.

Automatic Evaluations. We consider joint goal accuracy (Joint GA) and average goal accuracy (Avg GA) for evaluating belief states, act-slot F1 for evaluating action decisions, and two BLEU-4 scores (BLEU-O, BLEU-A) for evaluating system responses, where we use original (resp. augmented) system responses as references for BLEU-0 (resp. BLEU-A). Table 4 summarizes the evaluation results. Since the test set of SGD contains unseen services (i.e., services not seen during training) designed to evaluate the model's generalizability, we report the results on all services (All) as well as seen services only (Seen) following Rastogi et al. (2020). Our proposed models generally achieve a similar task performance level compared with the SimpleTOD baseline. Unsurprisingly, the proposed models achieve lower BLEU-0 and higher BLEU-A.

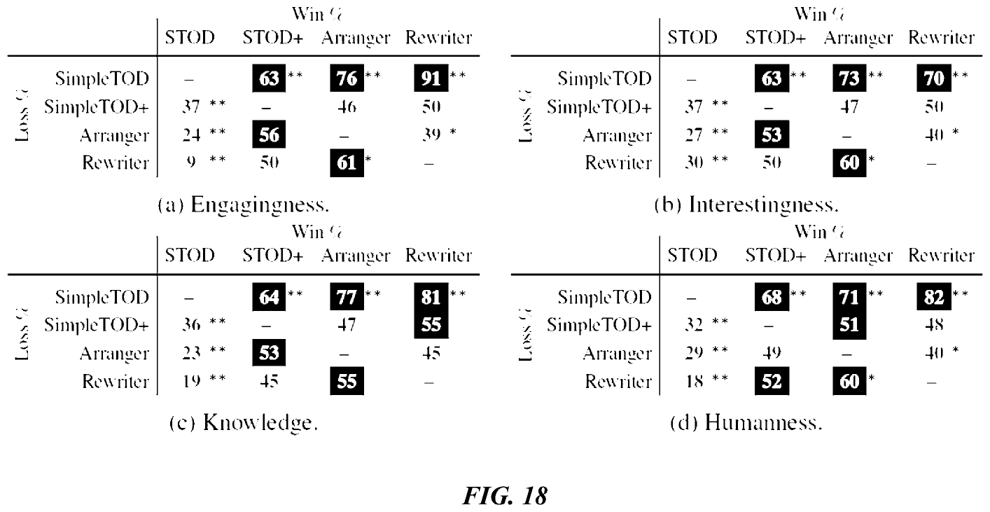

Human Evaluations. We turn to human evaluations for a more comprehensive measure of the response generation performance. We employ the same ACUTE-Eval metrics as we do in data evaluations. We randomly sample 100 dialogues from the test set of ACCENTOR-SGD. For each sampled dialogue D={u₁, s₁, u₂, s₂, . . . , uₙ, sₙ}, we pass u₁, s₁, . . . , uᵢ, to each model [symbol] ∈{SimpleTOD, SimpleTOD+ Arranger, Rewriter} to obtain its system response [symbol] , for the i-th system turn (1≤i≤n). Let [symbol] represent {u₁, [symbol] , . . . , uₙ, [symbol] }. We ask evaluators to compare each pair of [symbol] and [symbol] , where [symbol] ₁, [symbol] ₂∈{SimpleTOD, SimpleTOD+, Arranger, Rewriter} and [symbol] ₁≠ [symbol] ₂. FIG. 18 illustrates example human evaluation results on the test set of ACCENTOR-SGD using ACUTE-Eval (STOD: SimpleTOD, STOD+: SimpleTOD+, *: p-value<0.05, **: p-value<0.005). As shown in FIG. 18, all of the chit-chat augmented models outperform the SimpleTOD baseline over four ACUTE-Eval metrics. Among the chit-chat augmented models, no one shows a clear win over the other two on the quantitative level.

We show a full dialogue example comparing responses generated by different models in Table 5. We observe that compared with SimpleTOD+, both Arranger and Rewriter tend to add chit-chats to the beginning of task-oriented responses. This is perhaps because the underlying off-the-shelf chit-chat model takes only u₁, s₁, . . . , uᵢ as input, making it more likely to generate a suitable chit-chat to start, rather than end the i-th system turn. The responses generated by Arranger and Rewriter are similar because Rewriter may generate responses by copying contents from the responses output by the underlying off-the-shelf models without modification for most of the time (87.0% of dialogues on the test set).

TABLE 5

| | | | |
|---|---|---|---|
| U: | I'm looking | ST: | What type of events do you prefer, maybe [events_category] or [events_category] or |
| | for something | | anything else? Also, what city should I search in? |
| | interesting to | S+: | Sure, I can assist you. So, where are you looking for an activity, and do you have a |
| | do, please | | type of activity you prefer? You could say music, sports, or something like that. |
| | find an | AR: | What type of events do you prefer, maybe [events_category] or [events_category] or |
| | activity for | | anything else? Also, what city should I search in? |
| | me on the 5^{th} | RW: | What type of events do you prefer, maybe [events_category] or [events_category] or |
| | of this month. | | anything else? Also, what city should I search in? |
| U: | I'd like to | ST: | Is there any particular activity you are interested in? |
| | search for an | S+: | What type of activity would you like to take part in? There are a lot of activities to |
| | activity | | be found in the city. |
| | around | AR: | Seattle is a great place to visit. Is there any particular activity you are interested in? |
| | Seattle, WA. | RW: | Seattle is a great place to visit. Is there any particular activity you are interested in? |
| U: | I'd like to do | ST: | I found [events_count] events that you might like. There's a [events_event_name] |
| | something | | activity taking place at [events_event_location]. It's happening [events_date] |
| | Music related, | | starting at [events time]. |
| | | S+: | I discovered [events_count] activities you may enjoy. There is an |
| | | | [events_event_name] activity at [events_event_location] on [events_date], starting |
| | | | at [events time]. |
| | | AR: | I found [events_count] events that you might like. There's a [events_event_name] |
| | | | activity taking place at [events_event_location]. It's happening [events_date] |
| | | | starting at [events time]. |
| | | RW: | It's a great place to see a concert. I found [events_count] events that you might like. |
| | | | There's a [events_event_name] activity taking place at [events_event_location]. It's |
| | | | happening [events_date] starting at [events time]. |
| U: | That seems | ST: | Confirm the following details for me: Booking [events_number_of seats] ticket for |
| | fun, please | | the [events_event_name] show on [events_date] in [events_city_of event]. |
| | book one | S+: | Let me see if I got everything correctly: You'd like [events_number_of seats] ticket |
| | ticket for me | | for the [events_event_name] show in [events_city_of event] on [events date]. |
| | to that event. | AR: | Confirm the following details for me: Booking [events_number_of seats] ticket for |
| | | | the [events_event_name] show on [events_date] in [events_city_of event]. |
| | | RW: | I'm sure you'll enjoy it. Confirm the following details for me: Booking |
| | | | [events_number_of seats] ticket for the [events_event_name] show on |
| | | | [events_date] in [events_city_of event]. |
| U: | Yes, that is | ST: | I have reserved your ticket. The venue is located at [events_address_of location]. |
| | correct. | S+: | Reservation is confirmed. The venue is located at [events_address_of location]. |
| | Please tell me | AR: | I have reserved your ticket. The venue is located at [events_address_of location]. |
| | the venue's | RW: | I have reserved your ticket. The venue is located at [events_address_of location]. |
| | address. | | |
| U: | Okay, please | ST: | Please confirm that you would like to travel to [ridesharing_destination] in a cab for |
| | find me a ride | | [ridesharing_number_of_riders] person and that you would like a shared ride. |
| | to the event. | S+: | How many people will be riding in the cab? |
| | A shared ride | AR: | Please confirm that you would like to travel to [ridesharing_destination] in a cab for |
| | is fine. | | [ridesharing_number_of_riders] person and that you would like a shared ride. |
| | | RW: | Please confirm that you would like to travel to [ridesharing_destination] in a cab for |
| | | | [ridesharing_number_of_riders] person and that you would like a shared ride. |
| U: | Yes that is | ST: | Your ride is booked and on the way. The ride is expected to take |
| | correct. How | | [ridesharing_approximate_ride_duration] minutes. |
| | long will it | S+: | Your ride is booked and on the way. The ride is expected to take |
| | take to get | | [ridesharing_approximate_ride_duration] minutes. |
| | there? | AR: | Your ride is booked and on the way. The ride is expected to take |
| | | | [ridesharing_approximate_ride_duration] minutes. |
| | | RW: | Your ride is booked and on the way. The ride is expected to take |
| | | | [ridesharing_approximate_ride_duration] minutes. |
| U: | What's the | ST: | The cost is [ridesharing_ride_fare]. |
| | cost of the | S+: | The price is [ridesharing_ride_fare]. |
| | ride? | AR: | The cost is [ridesharing_ride_fare]. |
| | | RW: | The cost is [ridesharing_ride_fare]. |
| U: | Thanks, I | ST: | Enjoy your day. |
| | don't need | S+: | Enjoy the rest of your day. If you have any questions, please don't hesitate to |
| | anything else. | | contact me. |
| | | AR: | You are welcome. Enjoy your day. |
| | | RW: | You are welcome. Enjoy your day. |

Sampled responses generated for a complete task-oriented dialogue (U: user, ST: SimpleTOD, S+: SimpleTOD+, AR: Arranger, RW: Rewriter).

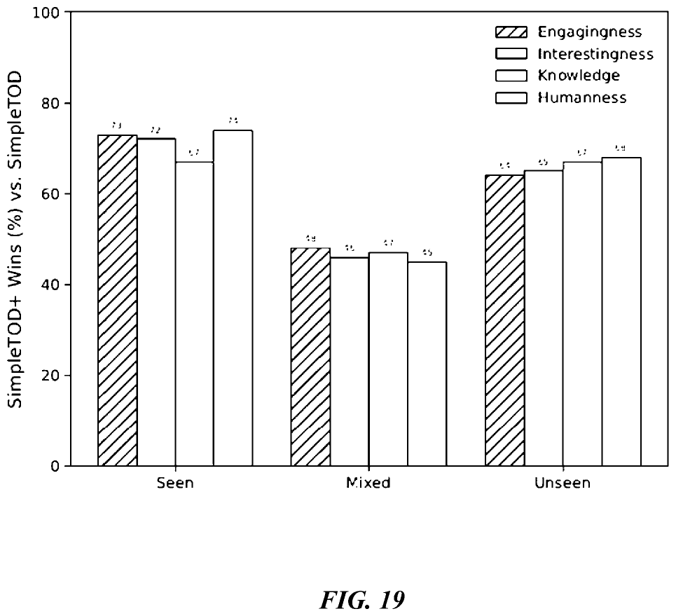

FIG. 19 illustrates example human evaluation results on dialogues that involve seen, unseen, or mixed services using ACUTE-Eval. To investigate the effect of the presence of the service in training data, we further perform human evaluation separately on dialogues that involve only seen services (Seen), only unseen services (Unseen), and both seen and unseen services (Mixed). We randomly sample 100 dialogues in each of the three categories from the test set of ACCEDNTOR-SGD and compare Simple-TOD+ and SimpleTOD on these dialogues. Perhaps surprisingly, we notice that the relative improvement achieved by adding chit-chats is significant for Seen and Unseen (p-values<0.005) but not for Mixed, as shown in FIG. 19.

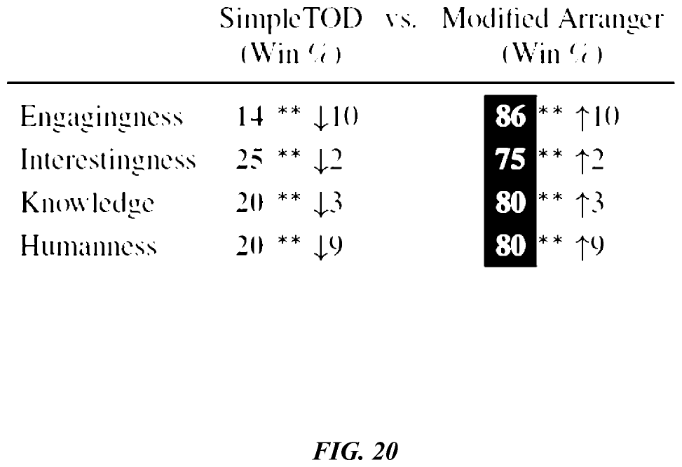

FIG. 20 illustrates example human evaluation results of the modified Arranger with controlled injection frequency (**: p-value<0.005, 114: increased/decreased win % compared with the original Arranger). Considering that the injection frequency affects human evaluations and that all our models may not explicitly control the injection frequency, we experiment with controlling the injection frequency by modifying Arranger to consider including a chit-chat into the current turn only when the injection frequency from the first turn to the current turn is less than 0.3. Compared with the original Arranger, we observe that the modified Arranger achieves a higher win percentage over SimpleTOD, as shown in FIG. 20. We leave further exploration of injection frequency for future work.

TABLE 6

| | Construction | | | |
|---|---|---|---|---|
| Dataset | Method | # Dialogues | Task-Oriented | Chit-Chat |
| DSTC2 (Henderson et al., 2014a) | crowdsourcing | 3,235 | ✓ | χ |
| MultiWOZ 2.1 (Eric et al., 2020) | crowdsourcing | 10,438 | ✓ | χ |
| Schema-Guided Dialogue (Rastogi et al., 2020) | crowdsourcing | 22,825 | ✓ | χ |
| PersonaChat (Zhang et al., 2018) | crowdsourcing | 10,907 | χ | ✓ |
| Wizard of Wikipedia (Dinan et al., 2019) | crowdsourcing | 22,311 | χ | ✓ |
| EmpatheticDialogues (Rashkin et al., 2019) | crowdsourcing | 24,850 | χ | ✓ |
| BlendedSkillTalk (Smith et al., 2020) | crowdsourcing | 6,808 | χ | ✓ |
| Pushshift Reddit (Baumgartner et al., 2020) | crawling & | 651,778,198^{†} | χ | ✓ |
| | scraping | | | |
| ACCENTOR-SGD (this work) | crowdsourcing | 22,825 | ✓ | ✓ |
| ACCENTOR-MultiWOZ (this work) | crowdsourcing | 997 | ✓ | ✓ |

Statistics of dialogue datasets (^{†}regarding each thread (i.e., a post and its comments) as a dialogue).

The embodiments disclosed herein may be related to the following conventional work. Dialogue system research has been consistently supported by the development of new datasets. The Dialog State Tracking Challenge (DSTC) series (Williams et al., 2013; Henderson et al., 2014a,b; Williams et al., 2014; Kim et al., 2016, 2017; Moon et al., 2020) provide common testbeds for task-oriented dialogues. Following DSTC, researchers have created a variety of publicly available task-oriented dialogue datasets (El Asri et al., 2017; Shah et al., 2018; Budzianowski et al., 2018; Rastogi et al., 2020). Another line of work seeks to facilitate open domain chatbot development with large amounts of human-created text data generated in a social context (Baumgartner et al., 2020) and supervision for a variety of desirable general qualities such as being engaging, personable, knowledgeable, and empathetic (Zhang et al., 2018; Dinan et al., 2019; Rashkin et al., 2019; Moon et al., 2019; Smith et al., 2020). The embodiments disclosed herein may bridge the two lines. We compare ACCENTOR-SGD and ACCENTOR-MultiWOZ with relevant and representative dialogue datasets in Table 6.

Note that a very few dialogue corpora may contain explicit annotations for both task-oriented and chit-chat utterances. For example, while Rastogi et al. (2020) and Moon et al. (2020) contain annotations for a few chit-chat dialogue acts, they are limited to light social greetings (e.g., “Thank you!”, “Good bye.”) typically at the end of each dialogue session. Zhao et al. (2017) propose to artificially augment task-oriented dialogues with randomly sampled utterances from a chit-chat corpus, mainly to improve the out-of-domain recovery performance. In contrast, our ACCENTOR may drastically increase the diversity and contextual coverage of chit-chat additions for any task-oriented dialogue corpus (e.g., “It's a great way to kick off the summer!” (after a music event recommendation; Table 1), “I hear it's beautiful.”) via the proposed model-based dialogue generation approach combined with the quality control mechanisms.

Over the past few years, neural models have achieved remarkable success in the development of main components of task-oriented dialogue systems, including understanding user intent, tracking dialogue states, determining system actions, and generating system responses (Henderson et al., 2013; Sun et al., 2014; Wen et al., 2015; Liu and Lane, 2016; Mrkšić et al., 2017; Wen et al., 2017; Nouri and Hosseini-Asl, 2018; Heck et al., 2020; Chen et al., 2020). Recently, connecting separate components and building end-to-end task-oriented neural dialogue systems have attracted increasing interest (Bordes et al., 2017; Peng et al., 2020b). The most recent thread is to unify all components in a single end-to-end neural model by fine-tuning a pre-trained deep language model on multiple tasks (Radford et al., 2019), which leads to state-of-the-art performance (Hosseini-Asl et al., 2020; Peng et al., 2020a). We follow this thread and further enhance the ability to generate appropriate non-task oriented add-ons, on top of the ability to achieve functional goals that existing systems are typically narrowly tailored to. A few work have studied training a dialogue model leveraging multiple chitchat and task-oriented dialogues (Madotto et al., 2019), which allows the model to attend on a relevant task for a given user utterance and respond accordingly, thus increasing the skill coverage of the model. Our proposed models are trained on the newly collected ACCENTOR dataset with the turn-level supervision signals, allowing for contextual and flexible code-switching between chit-chat and functional tasks in a single system turn.

The following list of references correspond to the citations above:
Daniel Adiwardana, Minh-Thang Luong, David R. So, Jamie Hall, Noah Fiedel, Romal Thoppilan, Zi Yang, Apoory Kulshreshtha, Gaurav Nemade, Yifeng Lu, and Quoc V. Le. 2020. Towards a human-like open-domain chatbot. arXiv preprint, cs.CL/2001.09977v3.
Jason Baumgartner, Savvas Zannettou, Brian Keegan, Megan Squire, and Jeremy Blackburn. 2020. The pushshift reddit dataset. In Proceedings of the ICWSM, volume 14, pages 830-839, Atlanta, Ga.
Antoine Bordes, Y-Lan Boureau, and Jason Weston. 2017. Learning end-to-end goal-oriented dialog. In Proceedings of the ICLR, Toulon, France.
Pawel Budzianowski, Tsung-Hsien Wen, Bo-Hsiang Tseng, Iñigo Casanueva, Stefan Ultes, Osman Ramadan, and Milica Gašić. 2018. MultiWOZ—a large-scale multi-domain Wizard-of-Oz dataset for task-oriented dialogue modelling. In Proceedings of the EMNLP, pages 5016-5026, Brussels, Belgium.
Lu Chen, Boer Lv, Chi Wang, Su Zhu, Bowen Tan, and Kai Yu. 2020. Schema-guided multidomain dialogue state tracking with graph attention neural networks. In Proceedings of the AAAI, pages 7521-7528, New York, N.Y.
Emily Dinan, Stephen Roller, Kurt Shuster, Angela Fan, Michael Auli, and Jason Weston. 2019. Wizard of Wikipedia: Knowledge-powered conversational agents. In Proceedings of the ICLR, New Orleans, La.
Layla El Asri, Hannes Schulz, Shikhar Sharma, Jeremie Zumer, Justin Harris, Emery Fine, Rahul Mehrotra, and Kaheer Suleman. 2017. Frames: a corpus for adding memory to goal-oriented dialogue systems. In Proceedings of the SIGDIAL, pages 207-219, Saarbrucken, Germany.
Mihail Eric, Rahul Goel, Shachi Paul, Abhishek Sethi, Sanchit Agarwal, Shuyang Gao, Adarsh Kumar, Anuj Goyal, Peter Ku, and Dilek Hakkani-Tur. 2020. MultiWOZ 2.1: A consolidated multi-domain dialogue dataset with state corrections and state tracking baselines. In Proceedings of the LREC, pages 422-428, Marseille, France.
Michael Heck, Carel van Niekerk, Nurul Lubis, Christian Geishauser, Hsien-Chin Lin, Marco Moresi, and Milica Gašić. 2020. TripPy: A triple copy strategy for value independent neural dialog state tracking. In Proceedings of the SIGDIAL, pages 35-44, Online.
Matthew Henderson, Blaise Thomson, and Jason D. Williams. 2014a. The second dialog state tracking challenge. In Proceedings of the SIGDIAL, pages 263-272, Philadelphia, Pa.
Matthew Henderson, Blaise Thomson, and Jason D Williams. 2014b. The third dialog state tracking challenge. In Proceedings of the SLT, pages 324-329, South Lake Tahoe, Nev.
Matthew Henderson, Blaise Thomson, and Steve Young. 2013. Deep neural network approach for the dialog state tracking challenge. In Proceedings of the SIGDIAL, pages 467-471, Metz, France.
Ehsan Hosseini-Asl, Bryan McCann, Chien-Sheng Wu, Semih Yavuz, and Richard Socher. 2020. A simple language model for task-oriented dialogue. arXiv preprint, cs.CL/2005.00796v3. Seokhwan Kim, Luis Fernando D'Haro, Rafael E Banchs, Jason D Williams, Matthew Henderson, and Koichiro Yoshino. 2016. The fifth dialog state tracking challenge. In Proceedings of the SLT, pages 511-517, San Diego, Calif.
Seokhwan Kim, Luis Fernando D'Haro, Rafael E Banchs, Jason D Williams, and Matthew Henderson. 2017. The fourth dialog state tracking challenge. In Dialogues with Social Robots, pages 435-449.
Margaret Li, Jason Weston, and Stephen Roller. 2019. ACUTE-EVAL: Improved dialogue evaluation with optimized questions and multi-turn comparisons. In NeurIPS workshop on Conversational AI, Vancouver, Canada.
Bing Liu and Ian Lane. 2016. Attention-based recurrent neural network models for joint intent detection and slot filling. In Proceedings of the Interspeech, pages 685-689, San Francisco, Calif.
Yinhan Liu, Myle Ott, Naman Goyal, Jingfei Du, Mandar Joshi, Danqi Chen, Omer Levy, Mike Lewis, Luke Zettlemoyer, and Veselin Stoyanov. 2019. RoBERTa: A robustly optimized bert pretraining approach. arXiv preprint, cs.CL/1907.11692v1.
Andrea Madotto, Zhaojiang Lin, Chien-Sheng Wu, Jamin Shin, and Pascale Fung. 2019. Attention over parameters for dialogue systems. In NeurIPS workshop on Conversational AI, Vancouver, Canada.
Seungwhan Moon, Satwik Kottur, Paul A Crook, Ankita De, Shivani Poddar, Theodore Levin, David Whitney, Daniel Difranco, Ahmad Beirami, Eunjoon Cho, Rajen Subba, and Alborz Geramifard. 2020. Situated and interactive multimodal conversations. arXiv preprint, cs.CL/2006.01460v1.
Seungwhan Moon, Pararth Shah, Anuj Kumar, and Rajen Subba. 2019. OpenDialKG: Explainable conversational reasoning with attention-based walks over knowledge graphs. In Proceedings of the ACL, pages 845-854, Florence, Italy.
Nikola Mrkšić, Diarmuid Ó Séaghdha, Tsung-Hsien Wen, Blaise Thomson, and Steve Young. 2017. Neural belief tracker: Data-driven dialogue state tracking. In Proceedings of the ACL, pages 1777-1788, Vancouver, Canada.
Elnaz Nouri and Ehsan Hosseini-Asl. 2018. Toward scalable neural dialogue state tracking model. In NeurIPS workshop on Conversational AI, Montreal, Canada.
Baolin Peng, Chunyuan Li, Jinchao Li, Shahin Shayandeh, Lars Liden, and Jianfeng Gao. 2020a. SOLOIST: Few-shot task-oriented dialog with a single pre-trained auto-regressive model. arXiv preprint, cs.CL/2005.05298v3.
Baolin Peng, Chenguang Zhu, Chunyuan Li, Xiujun Li, Jinchao Li, Michael Zeng, and Jianfeng Gao. 2020b. Few-shot natural language generation for task-oriented dialog. arXiv preprint, cs.CL/2002.12328v1.
Alec Radford, Jeffrey Wu, Rewon Child, David Luan, Dario Amodei, and Ilya Sutskever. 2019. Language models are unsupervised multitask learners. Preprint, available at https://openai.com/blog/better-language-models/.
Hannah Rashkin, Eric Michael Smith, Margaret Li, and Y-Lan Boureau. 2019. Towards empathetic open-domain conversation models: A new benchmark and dataset. In Proceedings of the ACL, pages 5370-5381, Florence, Italy.
Abhinav Rastogi, Xiaoxue Zang, Srinivas Sunkara, Raghav Gupta, and Pranav Khaitan. 2020. Towards scalable multi-domain conversational agents: The schema-guided dialogue dataset. In Proceedings of the AAAI, pages 8689-8696, New York, N.Y.
Stephen Roller, Emily Dinan, Naman Goyal, Da Ju, Mary Williamson, Yinhan Liu, Jing Xu, Myle Ott, Kurt Shuster, Eric M Smith, et al. 2020. Recipes for building an open-domain chatbot. arXiv preprint, cs.CL/2004.13637v2.
Pararth Shah, Dilek Hakkani-Tür, Gokhan Tür, Abhinav Rastogi, Ankur Bapna, Neha Nayak, and Larry Heck. 2018. Building a conversational agent overnight with dialogue self-play. arXiv preprint, cs.CL/1801.04871v1.
Kurt Shuster, Da Ju, Stephen Roller, Emily Dinan, Y-Lan Boureau, and Jason Weston. 2020. The dialogue dodecathlon: Open-domain knowledge and image grounded conversational agents. In Proceedings of the ACL, pages 2453-2470, Online.
Eric Michael Smith, Mary Williamson, Kurt Shuster, Jason Weston, and Y-Lan Boureau. 2020. Can you put it all together: Evaluating conversational agents' ability to blend skills. In Proceedings of the ACL, pages 2021-2030, Online.
Kai Sun, Lu Chen, Su Zhu, and Kai Yu. 2014. The SJTU system for dialog state tracking challenge 2. In Proceedings of the SIGDIAL, pages 318-326, Philadelphia, Pa.
Tsung-Hsien Wen, Milica Gašić, Nikola Mrkšić, Pei-Hao Su, David Vandyke, and Steve Young. 2015. Semantically conditioned LSTM-based natural language generation for spoken dialogue systems. In Proceedings of the EMNLP, pages 1711-1721, Lisbon, Portugal.
Tsung-Hsien Wen, Yishu Miao, Phil Blunsom, and Steve Young. 2017. Latent intention dialogue models. In Proceedings of the ICML, volume 70, pages 3732-3741, Sydney, Australia.
Jason Williams, Antoine Raux, Deepak Ramachandran, and Alan Black. 2013. The dialog state tracking challenge. In Proceedings of the SIGDIAL, pages 404-413, Metz, France.
Jason D Williams, Matthew Henderson, Antoine Raux, Blaise Thomson, Alan Black, and Deepak Ramachandran. 2014. The dialog state tracking challenge series. AI Magazine, 35(4):121-124.
Saizheng Zhang, Emily Dinan, Jack Urbanek, Arthur Szlam, Douwe Kiela, and Jason Weston. 2018. Personalizing dialogue agents: I have a dog, do you have pets too? In Proceedings of the ACL, pages 2204-2213, Melbourne, Australia.
Tiancheng Zhao, Allen Lu, Kyusong Lee, and Maxine Eskenazi. 2017. Generative encoder-decoder models for task-oriented spoken dialog systems with chatting capability. In Proceedings of the SIGDIAL, pages 27-36, Saarbrucken, Germany.

### Parameterized Interface to Convey Uncertainty of Visual Search

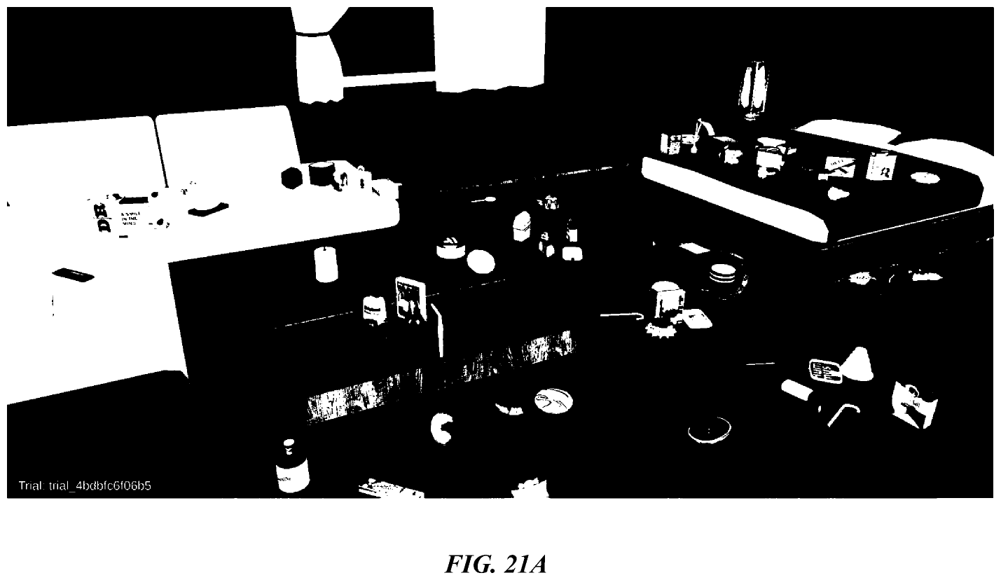

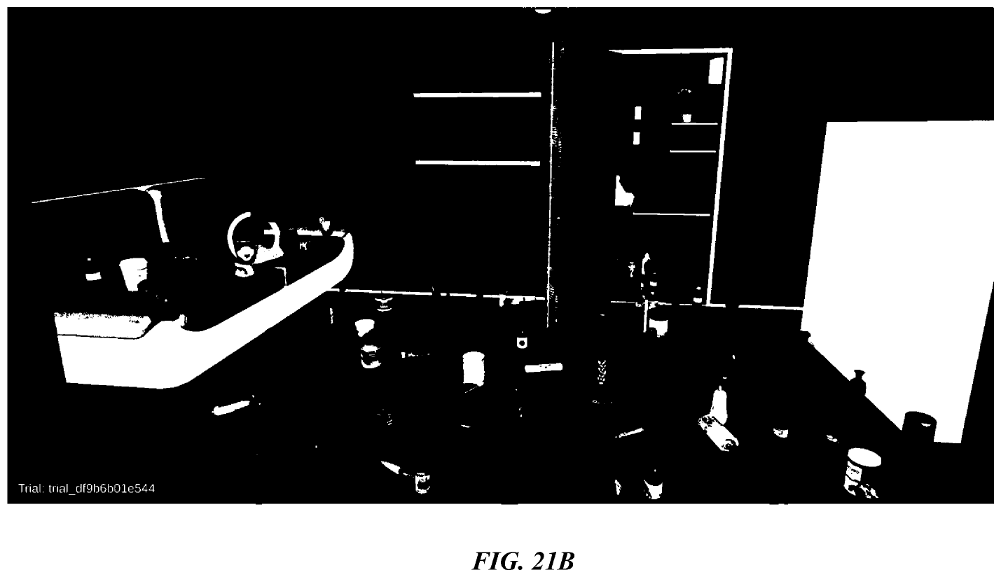

In particular embodiments, an assistant-based tool may provide visual cues to users in visual search (e.g., in augmented reality) by customizing the display of the visual cues. FIGS. 21A-21B illustrate example visual search assistance with visual cues. FIG. 21A illustrates an example visual search assistance with visual cues. As can be seen, two annuli in FIG. 21A may be generated by the assistant system 140 identifying what a user may be looking for. FIG. 21B illustrates another example visual search assistance with visual cues. As can be seen, four annuli in FIG. 21B may be generated by the assistant system 140 identifying what a user may be looking for. In particular embodiments, the assistant system 140 may take advantage of information it captured from multi-modal inputs and computer vision (CV) processing to help with these visual searches. The assistant system 140 may reactively provide visual cues to a user based on the user's request. Alternatively, the assistant system 140 may proactively provide visual cues to the user based on the user's gaze and contextual information without the user's explicit request. These visual cues (e.g., AR arrows, pointers, circles) may help users find these things or navigate them to where these things are. In addition, the display of these visual cues may be customized based on user requests, objects, the system's confidence, etc. The visual search tool may allow designers to customize the display (e.g., opacity or color) of the visual cues in a programmatic way. Specifically, there may be three types of controls provided with the tool, i.e., spatial, temporal, and color/shape. For example, the customization may including controlling the threshold confidence for when the visual cues will appear (e.g., based on the user's gaze tracking), adjusting the number of the visual cues being displayed, adjusting the time of the visual cues being displayed, etc. The tool may be used in different applications. For example, a user wearing AR glasses may ask “Hey assistant, where are my keys?” The assistant system 140 may then show the user an AR arrow pointing behind them. When the user turns around, there is an AR teardrop pointing at the keys. As another example, a user working airport security may say “Hey assistant, show me unpermitted items.” The assistant system 140 may then scan passengers in the line and shows annulus around items they are carrying that may not be allowed, in which the color/opacity of the annulus varies based on its confidence with respect to each item. As yet another example, a user is watching a sports game and the assistant system 140 may proactively direct their gaze to interesting parts of the game by bringing up an AR annulus where the action is happening (e.g., where the ball is).

Interfaces may support visual search tasks. With advances in computer vision, machine learning and with increased presence of virtual and augmented reality, there may be a strong potential to develop visual search assistants that will help users find what they are looking for in their environment. In most of the cases studied, it is assumed that visual search assistants have perfect knowledge of what the user is looking for and an exact knowledge of the location of the target. However, this may not always be the case. Real-world visual search assistants may be imperfect, and their predictions may be uncertain. There is a pressing need to develop visual search interfaces that will efficiently convey this uncertainty to users, in a way that best harmonizes with users' perceptual characteristics. The embodiments disclosed herein propose an algorithm that converts uncertainty through opacity of visual search cues for the assistant system 140. Through two data collections, we optimize visual cues in a realistic visual search task, reducing response time by 12% and reduces false detections by 41% compared to unoptimized cues.

Visual search may bear crucial considerations for user interface research. Visual search may take plenty of various forms: looking for a specific word in a text editor, looking for an option in a drop-down menu or trying to find a product based on thumbnails on an online shop. With virtual reality (VR) and augmented reality (AR), visual search may take forms that resemble real-life searches (e.g., searching for a tool in a virtual world) or take other forms (e.g., searching for relevant point-of-views in a 360 movie). Our living environments and user interfaces (UIs) may be designed to minimize the time and effort it takes to find items we need when we need them. For example, we hang our keys by the door so they are there when we leave the house and we place icons and order menus to match our user expectations. Yet in both cases, we may inevitably end up losing things and getting frustrated with the time it takes to search for the needed item.

To support users performing visual search, system designers have been proposing various visual search assistants. A visual search assistant may be defined as software that helps individuals search for what they are looking for in an environment. In some way, geo-localization applications may be considered visual search assistants. A user types “Piano” in the search bar and the application may highlight the localization of potential targets (e.g., musical instrument stores, music venues, music schools). As another example, a visual search assistant may help augmented-reality users find their car keys by prompting a popup saying: “You left your keys on your work desk”. Such assistants may take many forms. They may work on a textual/verbal basis, as done in the previous example. They may also use a spatial channel, for example, by superimposing to the field of view an arrow pointing in the direction of the keys.

Designing visual search assistants with head-mounted displays may be challenging. Increased immersion sometimes may relay-down visual search as secondary tasks in already complex and loaded environments. In the case of augmented-reality, small field-of-view and limited contrast may reduce attention guiding capabilities. Yet, many techniques have been developed to aid visual search in AR/VR settings. Using AR glasses, a moving arrow may fly from the user's line of sight to the out-of-view object, helping users understand how to rotate their head to find their target. In a slightly different domain of application, a visible frustum may help users understand how to position their head to better view the content of interest.

Despite success, these techniques often assume that the system has perfect knowledge of the target location. In rare cases investigating imperfect predictions, visual cues (i.e., arrows, circles) may be often binary (i.e., all potential targets are highlighted with the same strength, no matter their certainty level). There may be an opportunity to leverage machine-learning models to predict the target end users may be looking for during AR/VR visual searches. Models feeding on context variables, such as eye-tracking data, may make predictions about the visual search target and even provide optimized assistance on how to execute the search. However, those models may be unlikely to perform perfect predictions. As such, predictions may be enhanced by designing visual cues that take into account the degree of uncertainty of the prediction.

Communicating uncertainty may be challenging. Several machine-learning models have multiple probabilistic components which are beyond comprehension of the general public. Even by selecting a meaningful uncertainty metric, there may be no guarantee that communicating it will enhance user's performance during visual search. Communicating uncertainty may also bias users. Making an error on a suggestion that was estimated as very likely may greatly reduce trust of human users, regardless of correctness of the certainty estimation. Given these considerations, it may be essential to properly optimize visual cues based on uncertainty during AR/VR visual searches.

The embodiments disclosed herein investigate how properties of visual cues can be optimized to enhance visual search performance. We first designed a continuous search space to modulate the behavior of cue properties. We then created a realistic visual search task and ran a crowdsourced data collection. Using linear models, we investigated what cue properties yielded best response times. To validate the model, we ran a second data collection using a set of optimized cue properties. Our results suggest that optimization of cue properties reduces search time by 12% and can reduce false detections by 41%.

The embodiments disclosed herein may be related to the following prior work. Since the emergence of graphical user interfaces, visual search has been an important consideration for human-computer interaction researchers. The first family of work may comprise visual search cues. Extensive past work has looked at a variety of visual cues that can aid visual search. Geometric shapes are among the most basic and intuitive guidance methods available. Arrows have often been utilized for navigation assistance and several studies have shown that arrows are also an efficient way to guide visual attention. Many other types of geometric shapes have also been explored for aiding visual search (e.g., dots, crosshairs, circles, rectangles). Such geometric shapes are a familiar cue that is easy to understand. Lighting/shading effects have also been used as visual search cues. For example, the spotlight directs users attention on large displays, by simulating a physical spotlight used in stage lighting. The contents of the spotlight are displayed normally, while the surrounding regions are darkened. This concept has been also explored in pervasive environments, where actual light is dynamically projected onto physical objects to direct a user's attention. Lighting has also been explored as a mechanism to provide in-car navigation assistance. Magnification is a commonly used cue within “detail+overview” techniques, where a user wishes to see both high level overview of content, plus low-level details. Such techniques can be particularly useful for small displays such as mobile devices. Motion can add to the saliency of a visual object, thus helping attract a user's attention. For example, one application provided rotating targets to facilitate visual search. Research in psychology has shown that motion reduces search time and can also be used in conjunction with other cues such as shape. Similar to motion, it has been shown that abrupt visual onset or animations can also aid visual search. Color, like motion, can also increase a target object's saliency. Color is often incorporated in highlighting effects which has been shown to be an effective way to assist visual search. For instance, a recent study has shown that soft highlighting surpasses the performance of rigid bounding boxes in a computer-assisted visual search task. Color can also be used for “attention retargeting” by modulating the color of a scene to intentionally draw a user's attention to a specific area. Research in visual search cues has in part originated in the accessibility literature in an effort to assist people with low vision. For example, some work proposed “coloredeyes” which are animated eyeballs that indicate the direction and distance to the windows cursor. More recently, some work explored five different visual cues to help users identify products of interest in an augmented reality application. Cues included magnification, contrast adjustment, visual guidelines, spotlights, animated flashing, animated rotating, and “sunrays” consisting of multiple guidelines. Overall, a large variety of visual cues have been developed, but there is little clarity on the relative advantages of the variations in presentation modalities, and a lack of understanding of methods to optimize the presentation of visual cues. One piece of prior work that is of relevance investigated the optimization of interface feature design, which could relate to visual cues, to enhance visual search on screen settings (i.e., hotel search on a map), mobile virtual reality as well as in mobile augmented reality settings. They demonstrated that Bayesian optimization can be used to identify good cue properties in these various contexts of visual search. The embodiments disclosed herein use a similar approach to optimize visual cues for visual search in a 3D environment.

Another family of related work may comprise off-screen visual search. Research on assisting visual search for off-screen targets has introduced a number of visual search cues. Off-screen visual search is an important task to consider for mobile devices, where desired content may be outside of the bounds of the display. Early techniques include the City Lights system, which provided small lines on a windows border to indicate the size and direction of off-screen objects. A follow-up work, Halo technique, used arcs to also represent the distance to off-screen targets by modulating the radius of the arcs. In a variant, the Wedge technique visualizes off-screen targets using a triangle, and programmatically avoids overlap, to reduce the clutter of cues that can be present with the Halo technique. As another effort to reduce on-screen clutter, another work renders the visual cues for off-screen targets as ambient LED light surrounding the display, as an alternative of rendering the visual cue on the digital display itself. Numerous studies have compared such variants of off-screen visual search cues. One work compared Halo to two arrow-based techniques that were enhanced to indicate distance (scaled and stretched arrows). They found little difference for simple search tasks, but in complex environments, with many targets, arrow techniques have some performance advantages. A related study compared arrows, Wedge, and an Overview+Detail view, and also found few difference is simple environment, while each technique had its own trade-offs in complex environments. Off-screen visualization approaches have also been studied for tracking moving targets. Specifically, the EdgeRadar technique, which presents small 2D icons on the border of a display, and was found to allow users to track moving objects more accurately than the Halo technique.

Another family of related work may comprise visual search 360° and 3D environments. Visual search has been studied extensively in 3D and immersive 360° environments. The presence of visual search cues becomes more important, as the field of view of such displays is typically larger than traditional displays. Furthermore, in 3D displays, content may be more complex and objects of interests can be occluded. When viewing 360 videos, objects of interest may be out of frame. Users can miss important events if their viewpoint is pointed in the wrong direction. When authoring such videos, content, such as an actor looking in the direction of an object of interest, could be embedded in the video itself, to intrinsically direct the viewers' attention without supplementary visual cues. Such visual cues, referred to as Diegetic, are of less relevance to the embodiments disclosed herein, as we aim to support general visual search which may be absent of a narrative. Alternatively, past literature has looked at supplementary visual cues to direct a user's attention and focus while viewing 360 videos. A variety of cue types have been explored, such as lighting, arrows, and flickering. One work developed several Focus Assistance techniques, including a visual guidance technique consisting of arrows pointing to intended targets that were out of view. The “Outside In” visualization technique utilizes spatial picture-in-picture previews, to guide a user's attention to regions of interest. Another work explored a set of non-diegetic visual guidance methods for 360 video, which included color, magnification and luminance. Another work compared a set of visual cues, including arrows, animated butterflies, and a radar view, and found arrows to be the most generally accepted approach. Substantial work has also been done to support visual search in head mounted displays. In particular, research has looked at the challenges of visual search in both augmented reality and virtual reality environments. As with the 360° videos, most of this work is focused on directing users to content that is currently out of the current field of view. This is particularly important for augmented reality (AR) displays, which typically have limited field of views. Visual cues that have been explored in augmented reality include arrows, AR extensions of the Halo and Edge techniques, animated arrows, radar views, static and animated peripheral cues. The parafrusturm, a geometric frustum rendering AR, is a slightly different, in that it directs a user to a desired view position, which in turn allows the user to obtain a better viewpoint of a region of interest. A similar set of cues have also been explored in virtual reality (VR) research. Techniques include gaze guidance through animated objects, 2D and 3D arrows, object highlighting, VR adaptations of Halo and Wedge, animated peripheral cues, and radar views. In virtual reality, the viewpoint could also be automatically changed by the system, one work directs a user to a region of interest, however our interest is in visual cues that do not actively change a user's viewpoint.

Another family of related work may comprise communicating uncertainty. Our eventual goal is to develop “visual search assistants” that predict what the user may be searching for, and present associated visual cues. Most of the prior work we have reviewed has looked at enabling visual cues for all targets or a predetermined set of targets, independent of what may or may not be currently relevant to the user. Any model that attempts to predict a user's point of interest might not be perfect. As such, we can assume that their predictions will feature uncertainty and be probabilistic rather than discrete. Thus, we seek to investigate the optimization of visual cue properties in presence of such uncertainty. Little past research has looked at adjusting visual search cues based on certainty levels. One exception is a work that explores the use of soft highlighting during a “Human-Machine Cooperative Visual Search”, in which the computer attempts to automatically identify regions of interest. With soft highlighting, the saliency of the highlighted regions is modulated in a graded fashion based on classifier confidence level. The embodiments disclosed herein extend this past research, in an effort to optimize the nature of the visual cues based on such confidence levels. Outside of visual search tasks, extensive work in human computer interaction (HCI) has looked at communication of uncertainty more broadly, especially in the realm of information visualization. Another field where the topic of visualizing uncertainty levels has become prominent is in AI explainability. Within any AI based intelligent user interface, models are generally probabilistics, and thus, it may be important to communicate levels of confidence or uncertainty to the user. For example, one work compared various methods of conveying uncertainty of an intelligent agent to the user. Instead of a visual task, participants had to evaluate if hotel reviews were genuine or deceptive. They've shown that a heatmap method (i.e., highlighting the words of the review that the intelligent agent thought was relevant with an intensity matching its importance) yielded higher correct detection rates than simply highlighting words without conveying importance. As another example, the Accuracy indicator is a visual meter the communicates to the user the percentage accuracy with which the AI-powered system performs. The concepts behind these visualizations of uncertainty will help guide our own research goal of visualizing uncertainty that a region is of interest during visual search. In summary, scientific literature has investigated in detail how individuals perform visual search tasks and have investigated the performance of different types of visual cues. However, there may be very little work done to investigate how to present visual cues in the presence of uncertainty. Furthermore, there may be a lack of research on “visual search assistants”, that can intelligently model a user's intent, identify a user's desired target, and provide the associated search cues.

In particular embodiments, to reduce the search space, the assistant system 140 may choose a specific visual cue style, as comparison between styles has been done previously in the literature. Therefore, annulus shaped cues were used. An annulus is defined as the region bounded by 2 concentric circles (i.e., a ring or donut). Annuli may have the advantage of not occluding the target, as long as the target fits within its inner radius. Annuli may also have the advantage of being fairly simple and easy to control for. Some types of visual cues, such as in-situ 3D guidelines, may have created situations where the screen size of the cues was a function of the object position, therefore making it hard to control for its visual saliency.

Several channels may be considered to convey uncertainty. Size (i.e., radius, border width) of the cue may be considered. However, it may have the drawback of changing the area of interest. Large annuli with thin borders may have had an inside area so wide that other objects might have been included in it. Thick borders may have occluded the target. Since we wanted to leverage cue properties themselves, we also avoided text-based uncertainty, which may also have had the inconvenient of being difficult to read in some search scenes. In the end, it was decided to convey uncertainty through opacity. Since opaque cues may be more likely to draw attention, using opacity may provide a continuous channel to modulate how much we want to draw attention. Opacity may also have the advantage of being a “natural” way of conveying uncertainty.

We first started by mapping a large number of possible cue properties. Cue properties may be defined as parameters that define the physical appearance of a visual cue and its dynamics within a visual search task. From there, we created a demo application to help the team visualize the effect of each cue property as well as their interactions with the other properties. Using this application, it was decided to restrict our investigation to a smaller subset of cue properties. At the end, 8 cue properties were selected. Five of them were related to a custom-made algorithm that converted visual search assistant's uncertainty into actual values of opacity. The three others were related to the temporal behavior of the cues during the visual search task.

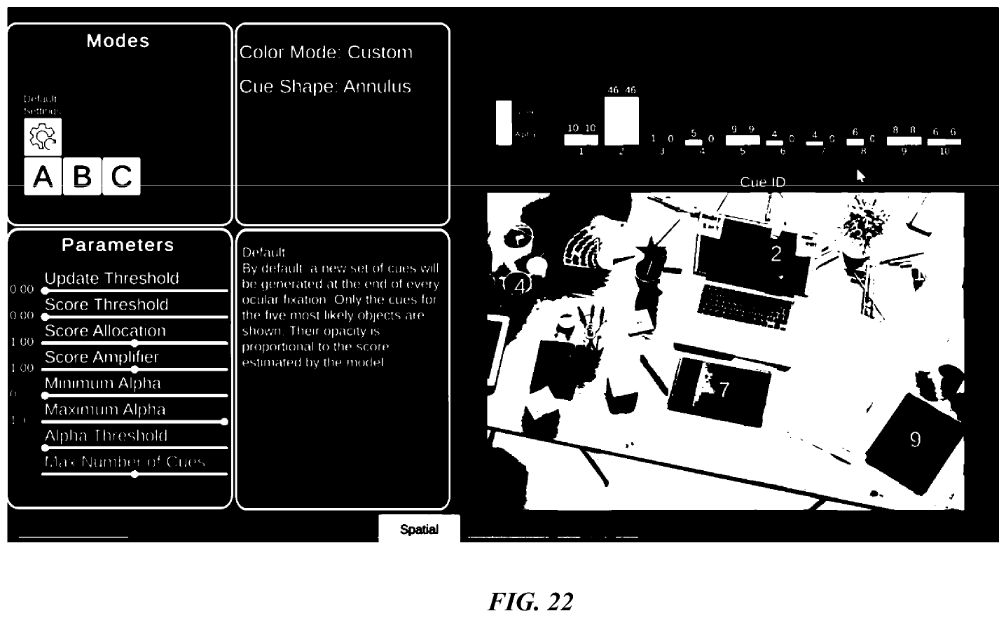

FIG. 22 illustrates an example user interface with visual cues parameterized by spatial properties. As indicated in FIG. 22, there may be a plurality of parameters for the spatial properties that can be tuned to change the display of the visual cues. These parameters may comprise update threshold, score threshold, score allocation, score amplifier, minimum alpha, maximum alpha, alpha threshold, and max number of cues. By default, a new set of cues may be generated at the end of every ocular fixation. Only the cues for the five most likely objects may be shown. Their opacity may be proportional to the score estimated by the model. In FIG. 22, the star may indicate a user's eye gaze whereas the second annulus (cue ID: 2) among the ten annuli may be the one with the highest confidence.

Five cue properties were related to the algorithm that converted visual search uncertainty to values of opacity. This algorithm may expect uncertainty to be formatted as probabilities adding up to 100% (e.g., the visual search target is either a wine bottle, 55%; a sausage, 35%; or a vase, 10%). These probabilities may be then transformed, one after the other, by the following functions.

One of the initial questions that was encountered with the cue design was: “should the most likely cue be more prominent compared to less likely cues?”. To address this in a continuous fashion, the score allocation property was created. This function may reallocate the score (i.e., probabilities) of various options amongst them, by either making the score more equal, or, making the highest score even higher. At a score allocation of 1.0 the output score may be the same as the input (i.e., no transformation is being made). If the score allocation is 0.0, then all scores may be set to be equal to each other (i.e., if there were N probabilities, all probabilities may be now equal to 1/N). If the score allocation is 2.0, then the element that had the highest initial score may have now a score of 1.0, and all other scores may be set to 0.0.

Another question that we faced was: “Should relatively weak probabilities be translated to high opacity values, or should the assistant be very certain before increasing the opacity of cues?”. To answer this, we designed the score amplification function. This function may take as input the output of the score allocation. It may serve to change the linear relation between the probability and the opacity. At a score amplification of 1.0, then the output score may be the same as the input (i.e., no transformation is being made). If the score amplification is 0.0, all scores that are non-zero may be equal to 1.0. At 2.0, all scores that are not 1.0 may be set to 0.0.

Subtle cues may be very light modifications of the image in order to seamlessly draw attention of users. We wanted to investigate, among other probabilities, whether restricting opacities of cues to low levels can be an optimal solution. We were also uncertain of very low values of opacities should be discarded, restricting levels to higher opacities. To cover this, we created two properties: minimum alpha and alpha range. Those properties may determine the lowest and highest values of alpha that a cue can take (i.e. “alpha” referring to the opacity of the cue). This means that a potential target getting probability of 0% may have a cue opacity at minimum alpha. A potential target getting a probability of 100% may then have a cue at maximum alpha level (i.e., minimum+range alpha). The last cue property may be simply the number of cues. The number of cues property may simply determine the amount of visual cues that would appear on the screen.

Visual search assistants may have the ability to update their prediction through time. Assistants may be able to gather more information overtime and underlying machine learning models may improve their accuracy through computation. To account for this, 3 temporal cue properties were designed. The guaranteed time was defined as a period of time during which visual cues are guaranteed to not change on screen. Visual search assistants may update at rates that are much faster than what humans could handle (e.g., one thousand changes per second). Even if those changes may mean better prediction, it is necessary to leave humans enough time to understand the visual cues that are on screen. Doing so may also prevent flickers and fast changes that would be distracting or perceived as absurd. Second, it was surmised that humans might also require time to perform the search by themselves. The free search time was defined as a period of time during which no cues are shown on screen, regardless of the visual search assistant's recommendation. In short, the visual search assistant used in the embodiments disclosed herein may alternate between guaranteed search time and free search time, for durations prescribed by the values of the properties.

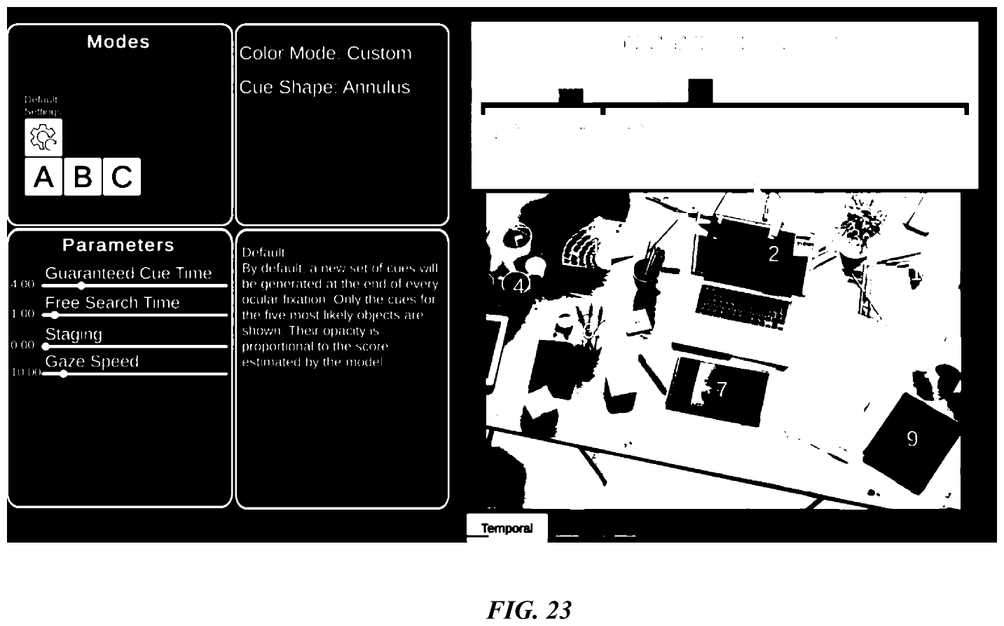

FIG. 23 illustrates an example user interface with visual cues parameterized by temporal properties. As indicated in FIG. 23, there may be a plurality of parameters for the temporal properties that can be tuned to change the display of the visual cues. These parameters may comprise guaranteed cue time, free search time, staging, and gaze speed. By default, a new set of cues may be generated at the end of every ocular fixation. Only the cues for the five most likely objects may be shown. Their opacity may be proportional to the score estimated by the model. The guaranteed cue time may be displayed on the top right while the visual cues vary as time goes.

The stating ratio was selected as the last property. Staging was defined as the process of making cues appear one after the other on screen, starting from the most likely to the least likely cue. The staging ratio was defined as the ratio of the guaranteed cue time at which the last visual cue was set to appear. For example, if the guaranteed search time was 3.0 seconds, the staging ratio was 0.5 and there were 4 cues, then the first cue would appear at 0.0 seconds, the second would appear at 0.5, the third would appear at 1.0 and the fourth cue would appear at 1.5.

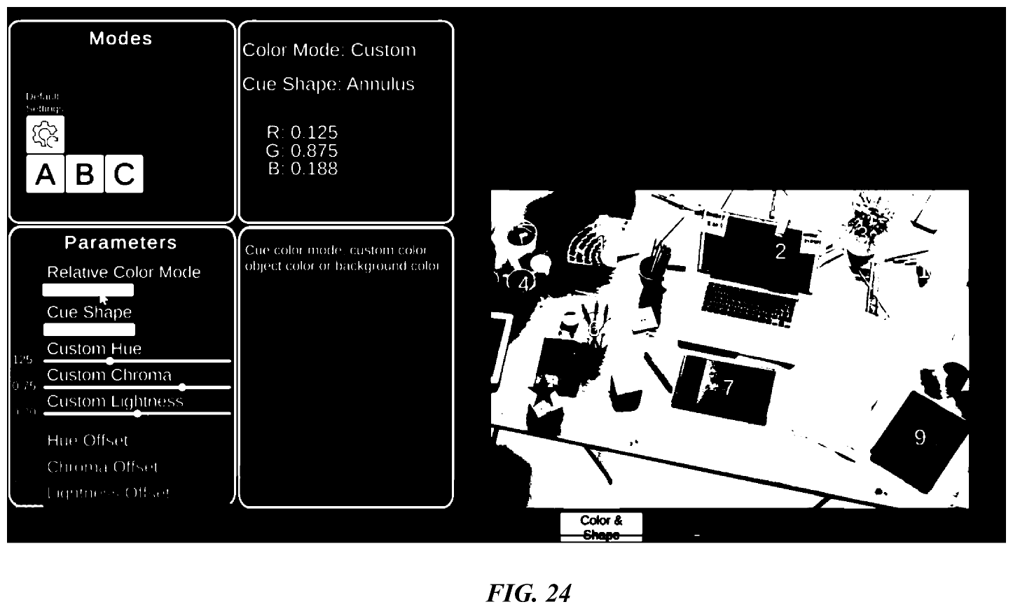

FIG. 24 illustrates an example user interface with visual cues parameterized by color and shape properties. As indicated in FIG. 24, there may be a plurality of parameters for the color and shape properties that can be tuned to change the display of the visual cues. These parameters may comprise relative color mode, cue shape, custom hue, custom chroma, custom lightness, hue offset, chroma offset, and lightness offset. As an example and not by way of limitation, when selecting cue color mode, a user may change custom color, object color or background color.

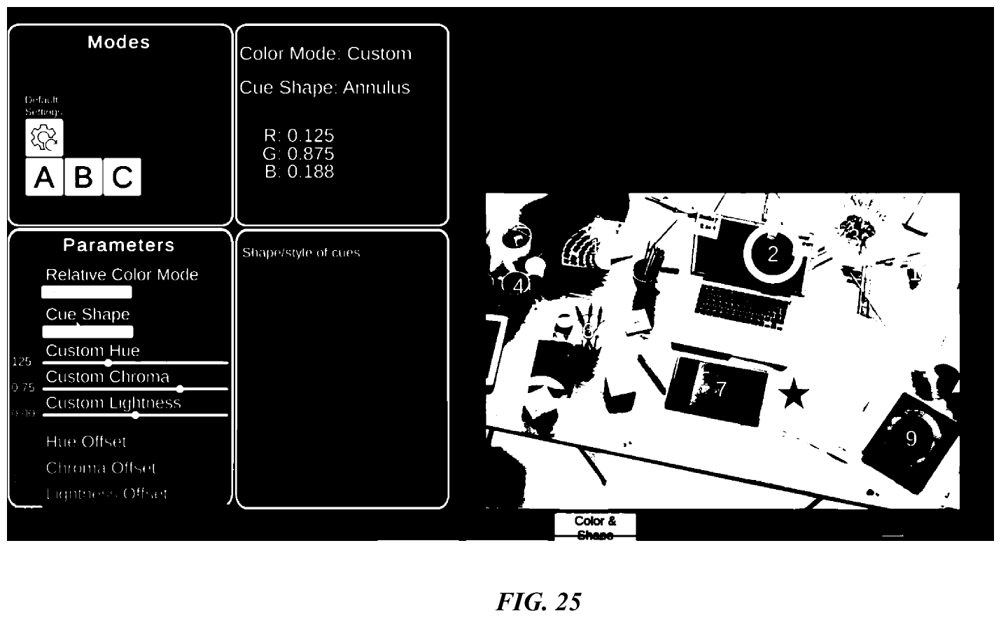

FIG. 25 illustrates an example user interface with multiple visual cues. As indicated in FIG. 25, there may be multiple visual cues with good confidence. The annuli corresponding to these visual cues may comprise the second annulus (cue ID: 2), the third annulus (cue ID: 3), the fifth annulus (cue ID: 5), the ninth annulus (cue ID: 9), and the tenth annulus (cue ID: 10).

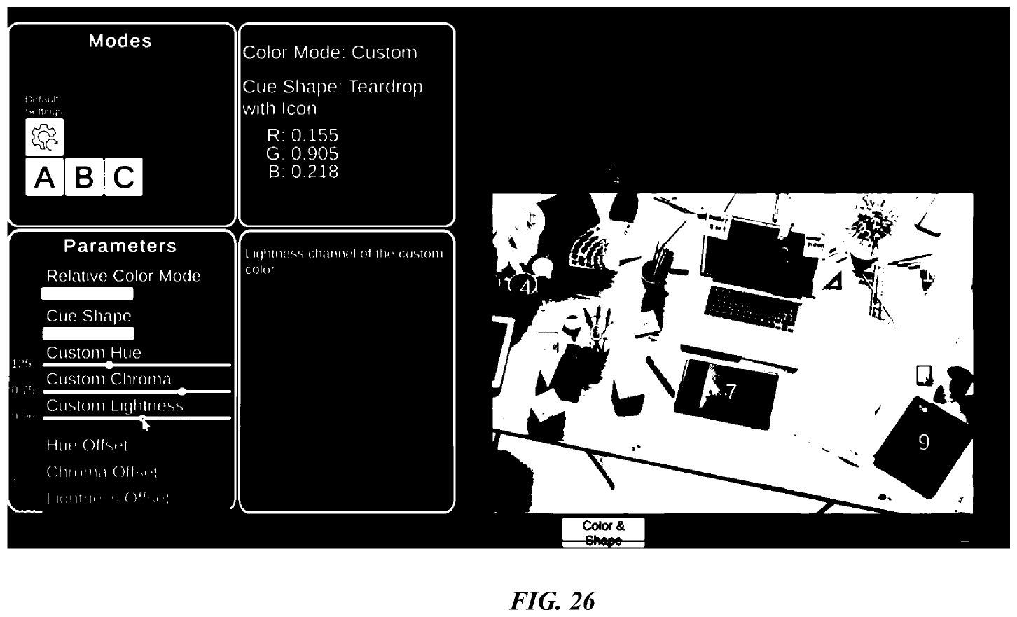

FIG. 26 illustrates an example user interface with visual cues indicating object categories. In FIG. 26, the visual cues are teardrops instead of annuli. In addition, within each teardrop there may be a visualization of an object indicating the category of the object associated with the visual cue. As an example and not by way of limitation, the fourth visual cue (cue ID: 4) may comprise a cup indicating the associated object may be a cup. As another example and not by way of limitation, the fifth visual cue (cue ID: 5) may comprise a sticky note indicating the associated object may be a sticky note.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
receiving, by a first client system associated with a first user, a first user request associated with an assistant xbot, wherein the first user request is a voice input received from the first user during a call between the first user, via the first client system, and one or more second users, via one or more respective second client systems;
determining, by the first client system, that the first user input comprises one or more activation keywords associated with the assistant xbot;
suspending, by the first client system, transmission of audio data to the one or more second client systems; and
activating, by the first client system, the assistant xbot to process one or more second user requests received from the first user.

2. A method comprising, by one or more computing systems:
receiving, from a client system associated with a first user, a first user request associated with one or more messages received by the user on one or more messaging platforms, wherein the first user request is a voice input received from the first user;
receiving, from the client system, an inbox snapshot for a message inbox of each of the one or more messaging platforms;
generating an inbox summary comprising an indication of a total number of unread messages in the message inboxes of the one or more messaging platforms and, for each platform having one or more unread messages, an identification of one or more contacts which each sent an unread message to the user; and
sending, to the client system, the inbox summary as an audio output for the first user.

3. A method comprising, by one or more computing systems:
accessing a set of personal data points associated with a first user;
accessing one or more sets of compromised data points, wherein each set of compromised data points is publicly available, and wherein each set of compromised data points is associated with a privacy breach for a corresponding online platform;
identifying one or more personal data points from the set of personal data points that are present in one or more of the sets of compromised data points;
generating a user notification indicating that the one or more identified personal data points may be compromised; and
displaying, on a client device associated with the first user, the generated user notification.

4. A method comprising, by one or more computing systems:
receiving, from a client system associated with a first user, a user input;
generating, based on a dialog context associated with the user input, one or more task responses by a task bot;
generating, based on the dialog context, one or more chit-chat responses by a chit-chat bot;
generating, based on the task responses and chit-chat responses, a comprehensive response by a compositional model; and
sending, to the client system responsive to the user input, instructions for presenting the comprehensive response.

5. A method comprising, by one or more computing systems:
receiving, from a client system associated with a user, a user input;
determining, based on one or more signals associated with the user input, the user is searching for an object in an environment associated with the user;
generating, one or more visual cues corresponding to one or more objects in the environment, wherein each of the visual cues is associated with a confidence score indicating a probability that the corresponding object is the object the user is looking for; and
sending, to the client system, instructions for overlaying the one or more visual cues on the one or more objects, wherein the one or more visual cues are customized based on their respective confidence scores.
